(19) United States
(12) Patent Application Publication
(10) Pub. No.: US 2016/0006774 A1
(43) Pub. Date: Jan. 7, 2016

(54) DOWNLOADABLE SOFTWARE APPLICATION FOR MANAGING LIFESTYLE RESOURCES

(71) Applicant: Healthy Connections, LLC, New York, NY (US)

(72) Inventors: Ioannis Zapantis, New York, NY (US); Scott Gaines, New York, NY (US); Jonathan Polikowski, Los Angeles, CA (US)

(21) Appl. No.: 14/856,141

(22) Filed: Sep. 16, 2015

Related U.S. Application Data
(63) Continuation of application No. 14/248,548, filed on Apr. 9, 2014.
Application No. 14/248,548 is a continuation of application No. PCT/US2014/000073, filed on Apr. 8, 2014.
(60) Provisional application No. 61/809,772, filed on Apr. 8, 2013.

(51) Int. Cl. H04L 29/06; G06F 3/0484; H04L 12/58; G06F 3/0482

(52) U.S. Cl. CPC H04L 65/403; G06F 3/0482; G06F 3/04842; H04L 51/32; G06Q 50/01

(57) ABSTRACT

Some embodiments provide a lifestyle management system for managing delivery of lifestyle information associated as an aggregation of lifestyle resources. Embodiments of the invention involve systems, methods, computer program products, and the like, for providing lifestyle information through a single interface for a user's mobile device. Some embodiments include a lifestyle management system including relational model for defining social relationships between users with one or more relationship links defining a data relationship and/or information flow between lifestyle resources data stored on a non-transitory computer-readable storage medium. In some embodiments, the interface can provide tools to manage lifestyle resources available to a user of a mobile device such that the user can better manage the user's healthcare and lifestyle needs. The interface can also improve the efficiency of accessing and organizing lifestyle resources by gathering one or more user preferences and measuring the user's engagement with the provided resources.

### CROSS REFERENCE TO RELATED APPLICATIONS

This application is a continuation of U.S. patent application Ser. No. 14/248,548, titled “MANAGING LIFESTYLE RESOURCES SYSTEM AND METHOD” filed on Apr. 9, 2014, which is a continuation of International Application Number PCT/US14/000073, titled “DOWNLOADABLE SOFTWARE APPLICATION FOR MANAGING LIFESTYLE RESOURCES” filed on Apr. 8, 2014, both of which claim priority to U.S. Provisional Application Ser. No. 61/809,772 titled “DOWNLOADABLE SOFTWARE APPLICATION FOR MANAGING LIFESTYLE RESOURCES” filed on Apr. 8, 2013. The disclosures of all of the foregoing applications are incorporated by reference herein in their entirety.

### BACKGROUND

Mobile messaging and social networking platforms have now established a global reach, invariably penetrating almost every aspect of our lives, enabling users to access news events, media, social networks, and internet enabled databases or services. However, although mobile information and networking platforms can allow users to access, create, view, analyze and disseminate information from a variety of sources, the ability of any one individual, group of individuals, or organization, to selectively access, view, and organize information to facilitate strategic lifestyle management is quite limited, especially within a mobile platform. Data management and presentation is invariably challenging because the plurality of data streams (that can include various data types, textural information, graphics and video, audio) typically requires a user to access more than one interface, either serially or in parallel. The average user oftentimes is not equipped to handle the sheer volume and plurality of data types in a small format interface display typically found in today's mobile devices.

The current approach to lifestyle management of employees further compounds the problem of meaningful user engagement of programs aimed at improving or modifying an employee's lifestyle. For example, many health and personal well-being programs are built on a platform that relies on involuntary, forced and/or externally motivated participation. These platforms have been shown to be detrimental to an employee's long-term lifestyle management because these methods are generally not conducive to the learning, self-efficacy, and behavior modification that is associated with voluntary participation.

### SUMMARY

Some embodiments of the invention include a system for managing one or more lifestyle resources including at least one processor configured to couple to at least one server and at least one non-transitory computer-readable storage medium for tangibly storing information related to a user account. The non-transitory computer-readable storage medium includes program logic for building and accessing at least one user profile accessible by the user through a single access point. When executed by the processor, the program logic can cause a lifestyle management system to electronically couple to an internet service interface including a plurality of user accounts. The program logic can also cause a lifestyle management system to use the at least one processor to calculate and display at least one user interface on a computer device of a user that is coupled to the internet service interface. The program logic can also cause a lifestyle management system to provide an option to a user to create at least one board. The board is configured and arranged for storing, accessing, posting and linking of at least one lifestyle related data selected by the user. The posting and linking are configured to enable private posting to the user and public posting to at least one viewing user. The program logic can also cause a lifestyle management system to receive from at least one user one or more preferences or characteristics related to a lifestyle resource content of the lifestyle related data. The program logic can also cause a lifestyle management system to receive lifestyle related data from at least one third party content source. The program logic can also cause a lifestyle management system to use the at least one processor to aggregate and curate the at least one lifestyle related data. The program logic can also cause a lifestyle management system to use the at least one processor to apply criteria to the aggregated and curated lifestyle related data based at least in part on one or more preferences or characteristics provided by the user to select and determine eligibility for viewing by a viewing user at least one lifestyle related content item from the aggregated and curated lifestyle related data. The program logic can also cause a lifestyle management system to use the at least one processor to display the eligible at least one lifestyle content item to the viewing user. The program logic can also cause a lifestyle management system to use the at least one processor to display at least one sharing link on the user interface. The program logic can also cause a lifestyle management system to provide an option to the viewing user to post the at least one lifestyle related content item to the at least one board. The post can include at least one of a private posting to at least one of the user's boards or a public posting to at least one other user holding one of the plurality of user accounts. The program logic can also cause a lifestyle management system to provide an option to the viewing user to share the at least one lifestyle related content item to at least one other viewer. The at least one lifestyle related content item includes a lifestyle related feed derived from the at least one third party content source.

In some embodiments, the at least one lifestyle related resource includes at least one of an internet resource, a healthcare resource, a personal resource, an employer resource and a healthcare related account associated with the user. In some embodiments, the at least one user interface is coupled to a mobile communication device. In some embodiments, the mobile communication device includes at least one of a cellular phone, a smart phone, a computer tablet, a smartwatch, a user-wearable computing device, and a personal digital assistant. In some embodiments, the mobile communication device is configured as the single access point configured to enable a user to select and view personalized lifestyle related content including at least one of employee benefit information, employee healthcare information, personal wellness information and employer human resources information.

In some embodiments, the lifestyle related content delivered to the user is selected based at least in part on an input from a user. In some embodiments, the lifestyle related content delivered to the user is selected based at least in part on an input from the system. In some embodiments, the program logic is configured to cause the at least one processor to perform the operation of preparing and delivering to an administrator at least one analytics report based at least in part on the user's use of the lifestyle related content and the at least one user interface. In some embodiments, the at least one analytics report includes a report relating to at least one of the user's board updating activity, user visits by day and time, user visits by visit duration, most accessed content, top categories, user visits by geo-location, user visits by demographic slice, and user visits by device type. In some embodiments, the program logic is configured to enable the administrator to control access and content provided to other administrators and the user.

Some embodiments of the invention include a computer-implemented method of managing and displaying lifestyle resources to a user with the use of a lifestyle management system including at least one processor coupled to at least one non-transitory computer readable storage medium. The processor is configured to read and store lifestyle related data from at least one of a plurality of lifestyle related resources. The method includes the step of coupling the lifestyle management system to an internet service interface including a plurality of user accounts. The method also includes the step of calculating and displaying at least one user interface on a computer device forming a single access point for a user that is coupled to the internet service interface. The method also includes the step of providing an option to a user to create at least one board. The board is configured and arranged for storing, accessing, posting and linking of at least one lifestyle related data selected by the user. The posting and linking are configured to enable private posting to the user and public posting to at least one viewing user. The method also includes the step of receiving from at least one user one or more preferences or characteristics related to a lifestyle resource content of the lifestyle related data. The method also includes the step of receiving, aggregate and curating at least one lifestyle related data from at least one third party content source. The method also includes the step of applying criteria to the aggregated and curated lifestyle related data based at least in part on one or more preferences or characteristics provided by the user. The method also includes the step of selecting and determining eligibility for viewing by a viewing user at least one lifestyle related content item from the aggregated and curated lifestyle related data. The method also includes the step of displaying the at least one lifestyle related content item to the viewing user. The method also includes the step of displaying at least one sharing link on the user interface. The method also includes the step of providing an option to the viewing user to post the at least one lifestyle related content item to the at least one board. The post can include at least one of a private posting to at least one of the user's boards or a public posting to at least one other user holding one of the plurality of user accounts. The method also includes the step of providing an option to the viewing user to share the at least one lifestyle related content item to at least one other viewer. The at least one lifestyle related content item includes a lifestyle related feed derived from the at least one third party content source.

In some embodiments, the at least one lifestyle related resource includes at least one of an internet resource, a healthcare resource, a personal resource, an employer resource and a healthcare related account associated with the user. In some embodiments, the computer device comprises a mobile communication device. In some embodiments, the mobile communication device includes at least one of a cellular phone, a smart phone, a computer tablet, a smartwatch, a user-wearable computing device, and a personal digital assistant. In some embodiments, the mobile communication device is configured to enable a user to select and view through the single access point personalized lifestyle related content comprising at least one of employee benefit information, employee healthcare information, personal wellness information and employer human resources information.

In some embodiments, the lifestyle related content delivered to the user is selected based at least in part on an input from a user. In some embodiments, the lifestyle related content delivered to the user is selected based at least in part on an input from the lifestyle management system. In some embodiments, the program logic is configured to cause the at least one processor to perform the operation of preparing and delivering to an administrator at least one analytics report based at least in part on the user's use of the lifestyle related content and the at least one user interface. In some embodiments, the at least one analytics report includes a report relating to at least one of the user's board updating activity, user visits by day and time, user visits by visit duration, most accessed content, top categories, user visits by geo-location, user visits by demographic slice, and user visits by device type. In some embodiments, the program logic is configured to enable the administrator to control access and content provided to other administrators and the user.

### DESCRIPTION OF THE DRAWINGS

FIG. 1A depicts a lifestyle management system engine architecture according to one embodiment of the invention.

FIG. 1B depicts a database relationship model of the lifestyle management system engine architecture according to one embodiment of the invention.

FIG. 1C depicts a lifestyle management system functioning as a single entry portal providing access to a plurality of lifestyle related content according to one embodiment of the invention.

FIG. 2A is a diagram illustrating an example of a computing system which may be used in implementing embodiments of the invention.

FIG. 2B illustrates a system architecture suitable for providing operability to a lifestyle management system in accordance with at least one embodiment of the invention.

FIG. 3 illustrates a home page display including a dashboard and a plurality of possible display windows in accordance with at least one embodiment of the invention.

FIG. 4A illustrates an account sign-in display page according to one embodiment of the invention.

FIG. 4B illustrates an account registration display page according to one embodiment of the invention.

FIG. 5 illustrates an account profile display page according to one embodiment of the invention.

FIG. 6 shows one example of an explore content display page according to one embodiment of the invention.

FIG. 7 shows one example of a content selection display page according to one embodiment of the invention.

FIG. 8 shows an example of a select board or category display page according to one embodiment of the invention.

FIGS. 9A-E illustrate detail views of board display pages according to one embodiment of the invention.

FIG. 10A-10F illustrate one example of board creation according to at least one embodiment of the invention.

FIG. 11 shows one example of a tools function display according to one embodiment of the invention.

FIGS. 12A-12B shows one example of a content selection page according to one embodiment of the invention.

FIGS. 13-15 show illustrations of a profile menu according to one embodiment of the invention.

FIG. 16 shows a search function display page according to one embodiment of the invention.

FIG. 17 show an alert function display page according to one embodiment of the invention.

FIG. 18 shows one example of a footer tray display page according to one embodiment of the invention.

FIG. 19 shows an explore home screen display page according to one embodiment of the invention.

FIG. 20 shows a status update display page according to one embodiment of the invention.

FIG. 21 shows a status updated page according to one embodiment of the invention.

FIG. 22 shows one example of a recent articles display page according to one embodiment of the invention.

FIG. 23 shows one example of a trending content display page according to one embodiment of the invention.

FIG. 24 illustrates a change activity menu display page according to one embodiment of the invention.

FIG. 25A illustrates an example of a social wall status update item display page according to one embodiment of the invention.

FIG. 25B illustrates an example of a shared article notification item display page according to one embodiment of the invention.

FIG. 25C illustrates an example of a favorite article notification display page according to one embodiment of the invention.

FIG. 25D illustrates an example of a full article view display page according to one embodiment of the invention.

FIG. 26 shows an example of a select favorite board display page according to one embodiment of the invention.

FIG. 27 shows an example of an article team sharing display page according to one embodiment of the invention.

FIG. 28 shows an example of a “Your Boards” view of a favorite boards display page according to one embodiment of the invention.

FIG. 29 shows one example of an “all boards” view display page according to one embodiment of the invention.

FIG. 30 shows an example of a single board view of favorite content items display page according to one embodiment of the invention.

FIG. 31 illustrates a switch board menu display page according to one embodiment of the invention.

FIG. 32 illustrates a team creation display page according to one embodiment of the invention.

FIG. 33 illustrates a suggested topics list display page according to one embodiment of the invention.

FIG. 34 illustrates a favorites view display page according to one embodiment of the invention.

FIGS. 35A-35B illustrate group detail view display pages including a plurality of potential window displays according to one embodiment of the invention.

FIG. 36A illustrates a group detail view display page including a plurality of potential window displays according to one embodiment of the invention.

FIG. 36B illustrates a group content detail view display page including a plurality of potential window displays according to one embodiment of the invention.

FIGS. 37A-37B illustrate group digest view display pages including a plurality of potential window displays according to one embodiment of the invention.

FIG. 38 shows one example of a team view display page according to one embodiment of the invention.

FIG. 39 shows an example of a teams view display page according to one embodiment of the invention.

FIG. 40 shows one example of a team admin view display page according to one embodiment of the invention.

FIG. 41 shows one example of a new team contacts creation display page according to one embodiment of the invention.

FIG. 42 shows an example of a generic contact selection display page according to one embodiment of the invention.

FIG. 43 shows a team name selection display page according to one embodiment of the invention.

FIG. 44 shows an update team list display page according to one embodiment of the invention.

FIG. 45 shows one example of a goals and challenges display page according to one embodiment of the invention.

FIG. 46 shows one example of a goals and challenges display page according to one embodiment of the invention.

FIG. 47 shows one example of a goal detail progress display page according to one embodiment of the invention.

FIGS. 48-49 illustrate examples of goal detail team share display pages according to one embodiment of the invention.

FIG. 50 illustrates an example of a challenge detail view display page according to one embodiment of the invention.

FIG. 51 illustrates an example of a goal selection display page according to one embodiment of the invention.

FIGS. 52-57 show examples of goal configuration display pages according to one embodiment of the invention.

FIG. 58 shows an example of an events view display page according to one embodiment of the invention.

FIG. 59 shows an example of an events invitation display page according to one embodiment of the invention.

FIG. 60 shows one example of an event detail display page according to one embodiment of the invention.

FIG. 61 illustrates an example of an edit existing event display page according to one embodiment of the invention.

FIG. 62 illustrates an example of a share event view display page according to one embodiment of the invention.

FIG. 63 shows one example of an individual reminder view display page according to one embodiment of the invention.

FIG. 64 shows one example of a create reminders view display page according to one embodiment of the invention.

FIG. 65 shows one example of a resources home screen display page according to one embodiment of the invention.

FIG. 66 depicts a resources section display page according to one embodiment of the invention.

FIG. 67 shows one example of a single resource topic view display page according to one embodiment of the invention.

FIG. 68 shows an example of a trending content display page according to one embodiment of the invention.

FIG. 69 shows one example of a resource content item display page according to one embodiment of the invention.

FIG. 70 depicts an example of a board or category change menu display page according to one embodiment of the invention.

FIG. 71 depicts an example of a change topic display page according to one embodiment of the invention.

FIGS. 72-77 show examples of benefits view display pages according to one embodiment of the invention.

FIGS. 78-80 illustrate administrator display pages for creating and publishing content according to one embodiment of the invention.

FIGS. 81-83 illustrate administrator display pages including analytics reports according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of the invention.

Aspects of the present disclosure involve systems, methods, computer program products, and the like, for providing a software interface for a user's mobile device. The interface provides one or more tools to aid in personal health and lifestyle management by managing one or more lifestyle resources available to a user of the mobile device. Using a single lifestyle portal or interface, the systems and methods can provide health and personal well-being engagement access through a personal mobile device that can accompany the user in the home and at work. In one example, the interface provides a link to one or more social influence networks accessible through the interface to discuss and manage the user's health. In another example, the interface provides links to one or more health-related accounts associated with the user, such as the user's health insurance, doctor information and general health related websites frequented by the user. In general, the software program and interface allows the user to better manage the user's health-related questions and concerns by aggregating and allowing or providing personalized access to several lifestyle management resources. Further, in some embodiments, the present disclosure involves systems, methods and computer program products that can provide employee analytics from an objective 3rd party portal. In this way, the portal can offer unbiased, non-governed reporting on both descriptive culture of the employee population, as well as authentic reporting on the use of all employer benefits, personal well-being programs, and other such offerings. In some embodiments, this can help an employer manage a return on investment for their employee benefits and personal well-being programs by reaching a mobile audience. Moreover, the systems and methods described herein can provide a single entry point (from a mobile, tablet or desktop computing device and/or display) to the internet, and can operate as an interface to a single entry management platform that can consolidate all benefits, personal well-being programs, lifestyle and entertainment programs, and offerings in general, including human resources announcements and reminders to the user. Furthermore, using a combination of lifestyle board or category and content, and user defined boards, groups, goals with reminders, announcements, and team feedback and interaction, the systems and methods as described herein can provide a single entry point (i.e., access) for the user in daily life, offering a user a voluntary engagement experience to help the user manage one or more aspects of the lifestyle, and can consolidate relevant information for each user's lifestyle issues and interests.

The systems and methods described herein can provide an enjoyable user experience to fit the needs and interests of each user, and can adapt and change based on input and outputs and user engagement. The systems and methods described herein also can encourage users to explore and interact with other like-minded users to improve the user experience and engagement. The systems and methods can curate and aggregate lifestyle related information for users, and can be user-customized to provide a more personalized interaction and a more targeted source of information for a user. For example, in some embodiments, lifestyle related information can be curated by an editor to provide more focused and relevant content to a user. For example, this will consist of an expert's input in a given life category or topic, and can be termed an editor picks for “Best Resources Currently Available Online”. This can also include which content is trending highest with users, and can include viewable comments on each from users. Moreover, in order to provide consistency for the user, this resource will be represented in the “Form” of one or more boards, and “Categories” will be replaced (for topic organizational purposes) with a general “search” functionality for the User to easily explore the resources available using a keyword lookup function. Using manual curation and automated recommendation via analytics and trending content, specific recommendations can be delivered to the user. Moreover, the user can personalize content delivery and analyze that data via manual and automated recommendations, as well as passive personalization or information that can be accessed by the user. In this way, content is aggregated and curated either manually via a recommendations engine or editor board picks. Further, an administrator can have the ability to manually write content directly through an administrator tool and promote the information through one or more feeds.

Further, the systems and methods described herein can enable users to set up social influence networks, and include their meaningful social support groups (i.e. not just workmates). This can include those that provide influential and/or meaningful relationships who can affect employee health, wellbeing, motivation and productivity by offering encouragement, happiness, stress reduction, and positive reinforcement and accountability that's required for someone to achieve long term behavior change, including for example family, friends, doctors, trainers, coaches, spiritual advisors, or other important influencers who are concerned with the users health. Communications including comments and conversations within the systems and methods can include an architecture that is substantially open-ended and inclusive of anything and everything that a user links to their health, well-being, and lifestyle. This can allow the user to engage with the items under the health umbrella that they are authentically interested and engaged in on a daily basis. Further, the systems and methods described herein provides a portal for a “CEO of the home” to access and manage all matters related to the health, lifestyle and financial security, and can enable the CEO to control and/or better influence the “Entire Claim Dollar”.

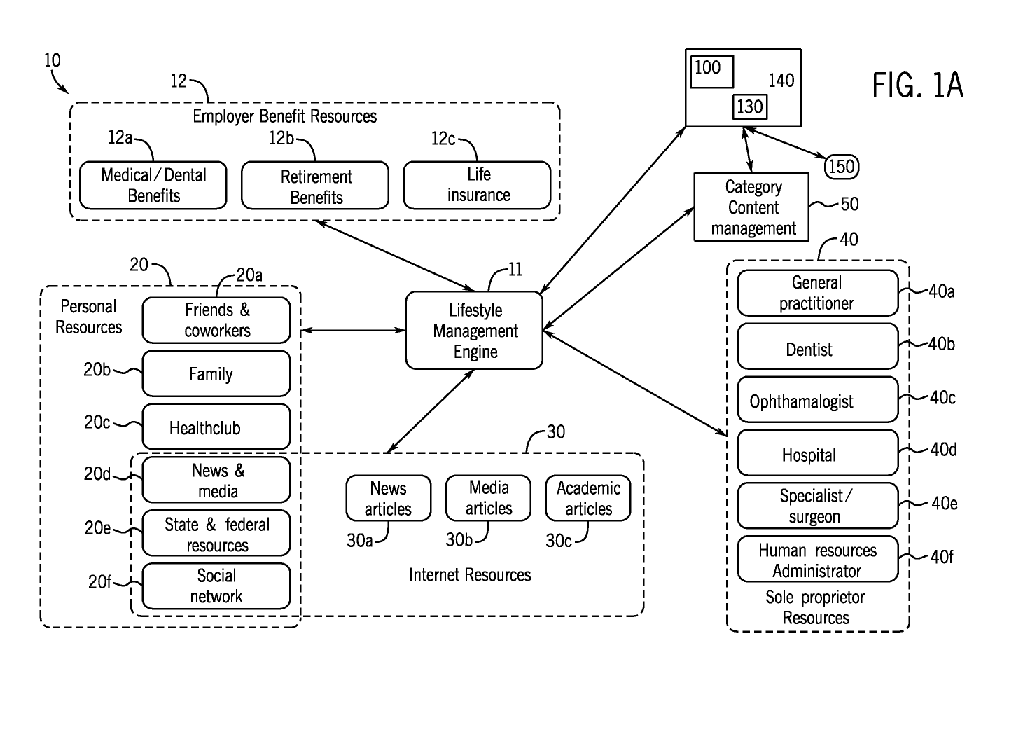

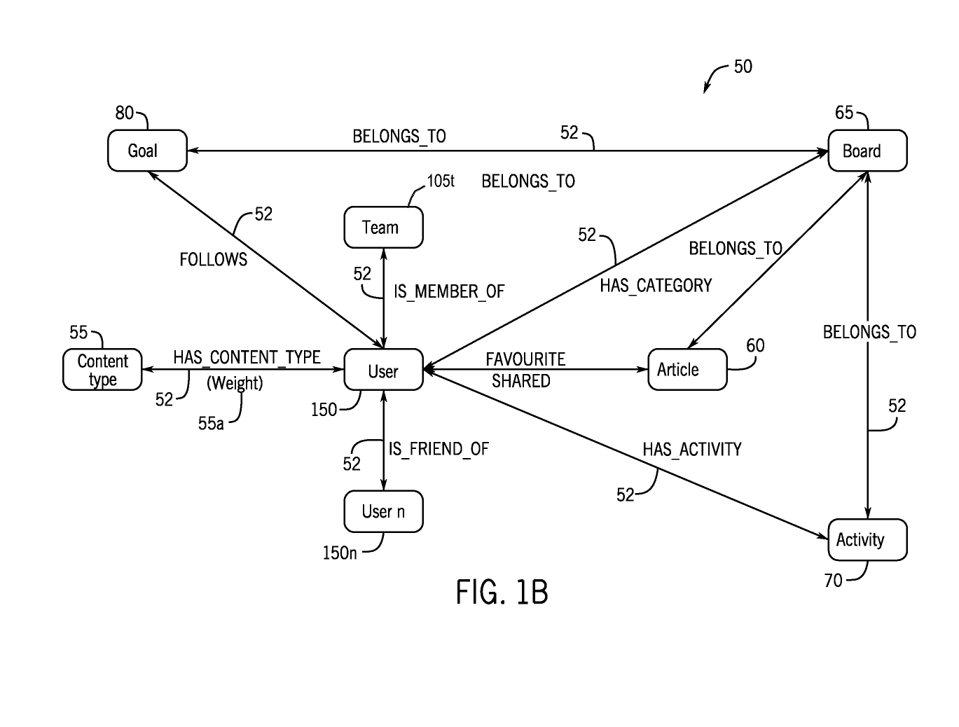

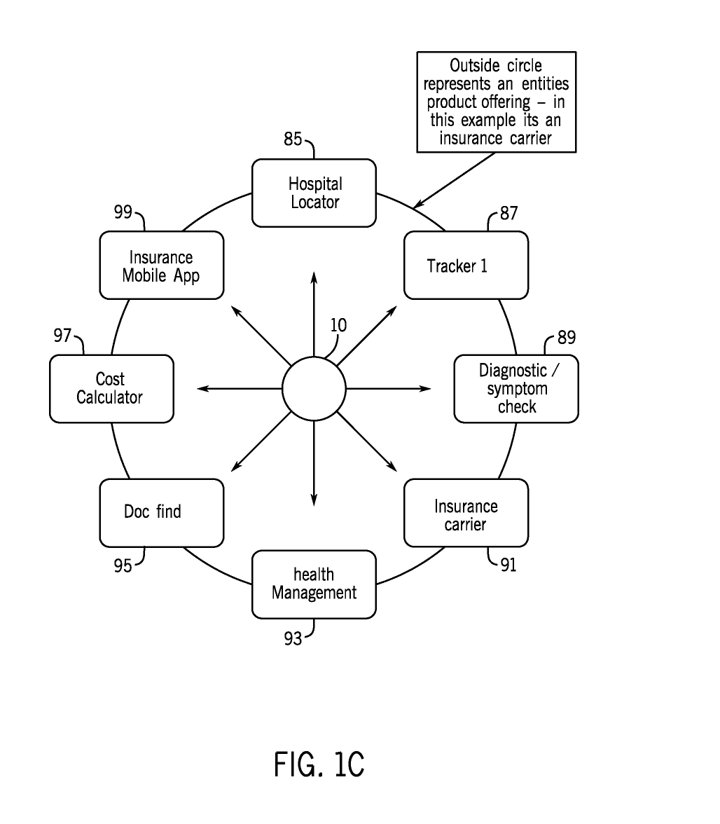

Some embodiments of the invention include a lifestyle management system 10 comprising at least one computer implemented methods within one or more user networks capable of providing and receiving lifestyle related information. For example, the systems and methods described herein, and illustrated in FIG. 1A, depict and describe at least one embodiment of a lifestyle management system 10 comprising a lifestyle management engine 11 coupled to a plurality of lifestyle related information resources. In some embodiments, the lifestyle management engine 11 can include a plurality of software system modules comprising various computer programs for receiving, curating and aggregating, and distributing lifestyle related content to at least one user 150.

In some embodiments, the lifestyle related information can comprise a plurality of types, content and sources. For example, in some embodiments, the lifestyle related information can comprise employer benefit resources 12. In some embodiments, one or more employer benefits related to and/or that may impact an employee's lifestyle can be coupled and accessed by the lifestyle management system 10. For instance, in some embodiments, lifestyle content can include health and personal well-being informational content related to medical and dental benefits 12a. In some embodiments, financial and family security information can be access and coupled to the lifestyle management system 10, including for example retirement benefits 12b, and life insurance benefits 12c. In some further embodiments, the employer benefit resources 12 can include minimum wage payments, overtime payments, social security disability insurance, unemployment benefits, workers compensation, automobile and residence insurance, medical insurance, a health advocacy programs, health savings accounts, dental insurance, vision insurance, pet insurance, flexible spending accounts, life insurance, an employee assistance program, transit programs, paid holidays, leave of absence, retirement plans, tuition assistance, tuition exchange, an on-site credit union, faculty and/or staff meal plans, paid time off, health club discounts, fringe benefits, disability benefits (including long term and short term), family and medical leave act, child care programs, wellness programs, educational programs, motivational programs, study programs, financial compensation, consolidated omnibus budget reconciliation act coverage, family and medical leave act coverage, and flexible spending accounts.

In some further embodiments, the lifestyle related information can comprise a plurality of personal resources 20. For example, in some embodiments, the lifestyle related information can comprise lifestyle related information provided by friends and coworkers 20a, or by family members 20b. In some embodiments, the lifestyle management system 10 can be coupled to one or more health clubs 20c of which the user 150 is a member. For example, in some embodiments, lifestyle related information can be received from trainers, coaches, or spiritual advisors who may be affiliated with a health club and/or who may be a friend or other advisor to the user 150. In some embodiments, the user's personal resources 20 can include a hospital, a general practitioner, a pediatrician, an ophthalmologist, a specialty surgeon, an obstetrics and gynecology physician, and ear, nose and throat doctor, a dentist, an orthodontist, an acupuncturist, a physical trainer, a chiropractor, a massage therapist, a life coach, a counselor, a psychologist, a psychiatrist, a nutritionist a rehabilitation therapist, a home health care practitioner, a landscaper, a computer repair specialist, a caterer, a house cleaning service, a dry cleaner and/or launderer, a restaurateur and/or diner, a bookkeeper, an accountant, an attorney, a tax attorney, a financial consultant, an employee benefits broker and/or consultant, an insurance representative, a tutor, a virtual assistant, a cosmetologist, a tailor or a spiritual advisor.

In some further embodiments, the lifestyle management system 10 can be coupled to and access one or more sources of information provided by the user 150, including news and media sources 20d, state and federal sources 20e, and lifestyle related content from one or more of the user's social networks 20f. In some embodiments, the lifestyle management system 10 can be coupled to and receive lifestyle related information and content from at least one internet resource. The lifestyle related information can include articles that could comprise news media, academic health information, relationship information leisure information, sports information, parenting information or entertainment information. For example, in some embodiments, any one of the news and media sources 20d, state and federal sources 20e, the user's social networks 20f can comprise an internet resource 30. In some embodiments, the social networks 20f can include public social networks that can be accessed by the user 150 and/or the lifestyle management system 10. In some further embodiments, the lifestyle related content can include information from the user's private social network created, maintained, and managed by the systems and methods described herein. As described earlier, by default, all inputs by a user 150 including created content is set to private as default (i.e., it is not accessible or viewable by other users 150). Subsequently, any information entered by the user 150 can be progressively disclosed (made public to another user 150) through sharing control updates provided by the user 150 authoring the private content. In some further embodiments, the lifestyle related content can include information from another user's private social network created, maintained, and managed by the systems and methods described herein and made public by the user. In some embodiments for example, the lifestyle management system 10 can receive, curate and aggregate one or more lifestyle related news articles 30a, one or more lifestyle related media articles 30b, and/or one or more lifestyle related academic articles 30c. In some embodiments, the lifestyle related information may reside in one or more boards of a user 150, at least a portion of which can be made public (i.e., shared) by the user 150 to another user 150. Furthermore, the lifestyle management system 10 can facilitate this sharing of lifestyle related information by enabling users 150 to reach out to other users 150 to share and exchange lifestyle related information that may reside in their own personal private network comprising lifestyle related information and content that can be aggregated, maintained and managed by the lifestyle management system 10.

In some embodiments, the lifestyle management system 10 can receive, curate, and aggregate information and content from at least one sole proprietor resource 40. For example, in some embodiments, the lifestyle management system 10 can be coupled to and receive lifestyle related information from a user's doctor 40a, dentist 40b, or ophthalmologist 40c. In some further embodiments, the lifestyle management system 10 can receive, curate and aggregate information and content from a hospital 40a, a medical specialist or surgeon 40e, or a human resources administrator 40f. In some embodiments, any one of the resources 12, 20, 40 can comprise an internet resource, and in some other embodiments, the internet resource 30 can comprise any one or combination of resources 12, 20, 30, 40.

In some embodiments, one or more functions, content, and processes of the lifestyle management system 10 can comprise lifestyle related information from a plurality of sources (including any one or combination of the resources 12, 20, 30, 40) coupled to and accessible by a user 150 as defined within at least one relationship model 50. The model 50 can define social relationships between users 150, and can define one or more actions within the lifestyle management system 10. For example, FIG. 1B depicts just one example of a database relationship model 50 linked to the lifestyle management system engine 11 of the lifestyle management system 10 that can at least in part can define the relationship between lifestyle content and a user 150 as he/she interacts with the lifestyle management system 10. Some embodiments include representative permutations and modifications that can be made by the systems and methods as described therein guided at least in part by the model 50, although the systems and methods described therein are not intended to be limited to those disclosed in the model 50. In fact, variations of the model 50 can be used to guide social relationships between users 150, and can define one or more actions within the lifestyle management system 10.

In some embodiments, the database relationship model 50 can comprise one or more relationship links 52 defining a data relationship and/or information flow between any portion of the database relationship model 50. For example, in some embodiments, a user 150 can be coupled to one or more other users (defined as 150n), and can be a member of at least one team 150t. In some embodiments, a user 150 can be linked to at least one content type 55 that in some embodiments can include a content weight 55a. For example, in some embodiments, at least one content type 55 can receive a weighing (a content weight 55a) that can serve to raise the level of importance and/or relevance from another content type 55 that may not be weighted, or may receive a lesser weighting. In some embodiments, the user 150 can be coupled to and/or can follow at least one lifestyle related goal 80 that can belong to and/or can be defined by at least one board or category 65. Further, in some embodiments, the user 150 can assign a favorite status and/or share at least one article 60 that can belong to or can be defined by the at least one board or category 65. Furthermore, in some embodiments, the user 150 can be linked to and/or can participate in at least one activity 70 that belongs to and/or is defined by the at least one board or category 65.

In some embodiments, any data representing any one of the content type 55, article 60, board or category 65, activity 70, and goal 80 comprising the model 50 or variations of the model 50, and accessed by one or more computer-implement systems and methods of the lifestyle management system 10, can be stored on computer-readable storage media 130 (see for example FIG. 1A). Further, any data related to any one user 150, 150n, and any one team 150t and any relationship between the any one user 150, 150n, and any one team 150t and any one of the content type 55, article 60, board or category 65, activity 70, and goal 80 comprising the model 50 and accessed by one or more computer-implement systems and methods of the lifestyle management system 10, can be stored on computer-readable storage media 130.

The systems and methods capable of providing a single entry point to lifestyle related information can be illustrated in FIG. 1C, which depicts one example of a lifestyle management system 10 functioning as a single entry portal for another entity (e.g., such as a partner provider) providing access to a plurality of lifestyle related content to at least one user 150. As shown, in some embodiments, the lifestyle management system 10 can include a hospital locator 85 providing at least one option to allow a user 150 to search and location a hospital or other healthcare related facility. In some embodiments, the lifestyle management system 10 can provide a fitness or health tracker 87. For example, in some embodiments, the lifestyle management system 10 can track a user's health using information provided by the user 150 and/or by using tracking data received from at least one health monitoring device. In some instances, this can include the ability to measure and or track a user's overall movement and exercise, and/or a user's to diet, and/or a user's sleep patterns, and/or blood pressure results, and/or calories burnt by the user 150. In some further embodiments, the lifestyle management system 10 can function to provide a user 150 with a medical diagnostic. For example, in some embodiments, lifestyle management system 10 can include a health symptom check, and can provide at least one diagnostic based at least in part on one or more symptoms provided by the user 150. In some further embodiments, the lifestyle management system 10 can function to provide information related to at least one insurance carrier or provider 91. In this way, a user 150 can utilize the lifestyle management system 10 to search and review at least one insurance policy. Further, the lifestyle management system 10 can also provide a user 150 with a mobile insurance application 99, enabling a user 150 to access at least one insurance carrier and/or at least one insurance account and/or policy. In some embodiments, the user 150 can use the lifestyle management system 10 to provide health management 93. For example, the user 150 can use one or more of the systems and methods described herein to management his/her health, and/or his/her medical condition. Some embodiments of the invention provide a user 150 the ability to search and identify a doctor or other purveyor of medical assistance and/or advice using a “doc find” function 95. Some embodiments of the invention include a cost calculator 97. For example, in some embodiments, the user 150 can utilize the systems and methods provided by the lifestyle management system 10 to assess and calculate current or future healthcare related expenses.

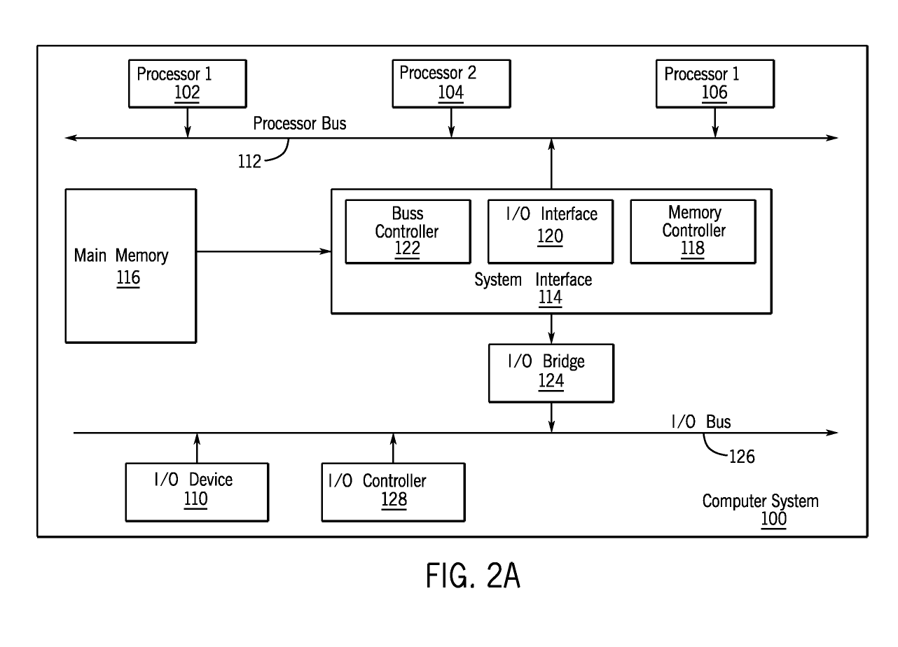

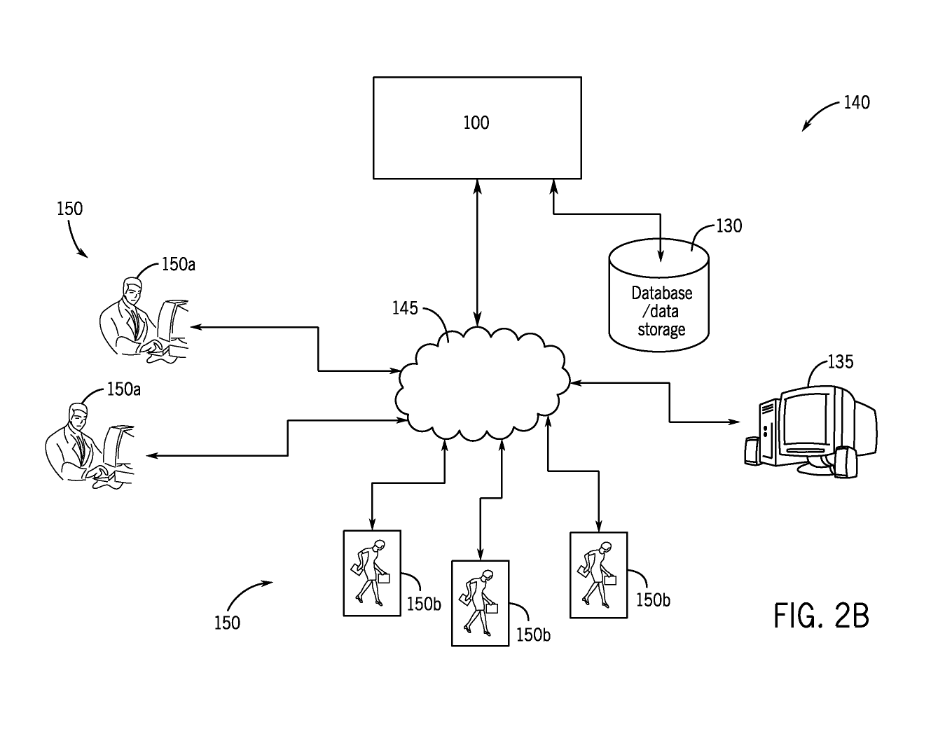

In some embodiments of the invention, one or more computing systems can be used to implement at least one embodiment of the lifestyle management system 10 that can comprise at least one computer implemented systems and methods to provide an interface to a user 150 for accessing one or more of the healthcare related resources discussed herein. For example, FIG. 2A is a block diagram illustrating an example of a computing device or computer system 100 (see also FIG. 1A) which can be used in implementing the embodiments of the computer implemented systems and methods disclosed herein. For example, the computing system 100 of FIG. 2A can be used to implement the computer implemented systems and methods that provides the interface to a user 150 of the computing system 100 for accessing one or more of the healthcare related resources discussed herein. In some embodiments, the computer system (system 100) includes one or more processors 102, 104, 106. Processors 102, 104, 106 can include one or more internal levels of cache (not shown) and a bus controller or bus interface unit to direct interaction with the processor bus 112. Processor bus 112, also known as the host bus or the front side bus, can be used to couple the processors 102, 104, 106 with the system interface 114. System interface 114 can be connected to the processor bus 112 to interface other components of the system 100 with the processor bus 112. For example, the system interface 114 can include a memory controller 118 for interfacing a main memory 116 with the processor bus 112. The main memory 116 typically includes one or more memory cards and a control circuit (not shown). The system interface 114 can also include an input/output (I/O) interface 120 and a bus controller 122 to interface one or more I/O bridges or I/O devices with the processor bus 112. One or more I/O controllers and/or I/O devices 124 can be connected with the I/O bus 126, such as I/O controller 128 and I/O device 110, as illustrated.

In some embodiments, the I/O device 110 can also include an input device (not shown), such as an alphanumeric input device, including physical or virtual alphanumeric and other keys for communicating information and/or command selections to the processors 102, 104, 106. Another type of user input device includes cursor control, such as a mouse, a trackball, or cursor direction keys for communicating direction information and command selections to the processors 102, 104, 106 and for controlling cursor movement on the display device.

Some embodiments of the invention include a system 100 can include a dynamic storage device, referred to as main memory 116, or a random access memory (RAM) or other computer-readable devices coupled to the processor bus 112 for storing information and instructions to be executed by the processors 102, 104, 106. Main memory 116 also can be used for storing temporary variables or other intermediate information during execution of instructions by the processors 102, 104, 106. System 100 can include a read only memory (ROM) and/or other static storage device coupled to the processor bus 112 for storing static information and instructions for the processors 102, 104, 106. The system set forth in FIG. 2A is but one possible example of a computer system that can employ or be configured in accordance with aspects of the present disclosure.

According to one embodiment, the above techniques can be performed by computer system 100 in response to processors 102, 104, 106 executing one or more sequences of one or more instructions contained in main memory 116. These instructions can be read into main memory 116 from another machine-readable medium, such as a storage device 130. Execution of the sequences of instructions contained in main memory 116 can cause processors 102, 104, 106 to perform the process steps described herein. In alternative embodiments, circuitry can be used in place of or in combination with the software instructions. Thus, embodiments of the present disclosure can include both hardware and software components, and can employ various computer-implemented operations involving data stored in computer systems (such as computer system 100).

In some embodiments, the computer system 100, operating with a system architecture 140 discussed below can include at least one non-transitory computer readable medium. In some embodiments, the invention can also be embodied as computer readable code on a non-transitory computer readable medium. For example, the above-described computer-implement systems and methods of the lifestyle management system 10 can be stored on computer-readable storage media 130. The computer readable medium 130 can be any data storage device that can store data, which can thereafter be read by a computer system 100. Examples of the computer readable medium 130 can include hard drives, network attached storage (NAS), read-only memory, random-access memory, FLASH based memory, CD-ROMs, CD-Rs, CD-RWs, DVDs, magnetic tapes, other optical and non-optical data storage devices, or any other physical or material medium which can be used to tangibly store the desired information or data or instructions and which can be accessed by a computer or processor. The operations embodied in the computer-implemented methods can include those requiring physical manipulation of physical quantities. Usually, though not necessarily, these quantities take the form of electrical, electromagnetic, or magnetic signals, optical or magneto-optical form capable of being stored, transferred, combined, compared and otherwise manipulated. A machine readable medium includes any mechanism for storing or transmitting information in a form (e.g., software, processing application) readable by a machine (e.g., a computer such as computer system 100). Such media can take the form of, but is not limited to, non-volatile media and volatile media. Non-volatile media includes optical or magnetic disks. Volatile media includes dynamic memory, such as main memory 116. Common forms of machine-readable medium can include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions.

Some embodiments of the invention include the computer system 100 processing one or more instructions of the lifestyle management system 10 comprising the computer implemented methods within one or more user networks. Further, in some embodiments, the computer system 100 processing one or more instructions of the lifestyle management system 10 can use a database relationship model 50 linked to the lifestyle management system engine 11 as described earlier. For example, FIG. 2B illustrates a system architecture 140 suitable for providing operability to the lifestyle management system 10 in accordance with at least one embodiment of the invention. As shown, the computer readable medium 130 can also be coupled to a computer network via the network interface 145 so that non-transitory computer readable code can be stored and executed by the computer system 100 in a distributed fashion. For example, in some embodiments, one or more components of the system architecture 140 can be tethered to send and/or receive data through a network 145. In some embodiments, one or more components of the network 145 can include one or more resources for data storage, including any other form of computer readable media beyond the medium 130 for storing information and including any form of computer readable media for communicating information from one electronic device to another electronic device. In some embodiments, one or more components of the system architecture 140 can be physically or wirelessly tethered to send or receive data through an internet (e.g., a wireless internet), that can include a local area network (“LAN”) and/or a wide area networks (“WAN”), direct connections (e.g., through a universal serial bus port). The data can be sent to or received by other computer systems, and/or other forms of computer-readable media 130, or any combination thereof. Also, various other forms of computer-readable media 130 can transmit or carry instructions to the computer system 100, including a router, private or public network, or other transmission device or channel, both wired and wireless. In some embodiments, one or more software modules can be configured to send to and receive data from a database (e.g., from a computer readable medium 130) and data can be received by the software modules from at least one other source. In some embodiments, the system architecture 140 can be configured to output data to a user 150 via at least one digital display (e.g., to a computer or mobile device comprising a digital display that can be viewed and operated by one or more users 150). In some embodiments, one or more components of the network 145 can include a number of client devices which can be personal computers including for example desktop computers or laptop computers (e.g., shown as users 150a), and/or to one or more mobile or portable devices, such as digital assistants, personal digital assistants, cellular phones, mobile phones, smart phones, pagers, digital tablets, internet appliances, and other processor-based mobile devices (e.g., shown as users 150b). In some embodiments, the system architecture 140 can be configured to receive instructions or output data to a user 150 comprising a system or platform administrator 135. For example, in some embodiments, the system administrator 135 can monitor, add, modify, or update at least one operating feature or function of the system architecture 140. Further, in some embodiments, the system administrator 135 can monitor, add, modify, or update at least one operating feature or function of the lifestyle management system 10 by using the system architecture 140. In some embodiments, the computer readable medium 130 can comprise a cloud-based system operated over at least one cloud-based network. For example, in some embodiments, the computer readable medium 130 can be distributed over a cloud drive service provided by Amazon.com®. Amazon.com® is a registered trademark of Amazon.com Inc.

Any of the operations performed by the lifestyle management system 10 described herein that form part of the invention are useful machine operations. Some embodiments of the invention also relate to a device or an apparatus for performing these operations. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general purpose computer selectively activated or configured by one or more computer programs stored in the computer memory, cache, or obtained over a network. When data are obtained over a network, the data can be processed by other computers on the network, e.g. a cloud of computing resources.

Some embodiments of the invention can include a user registration process. For example, a user 150 who wishes to use the lifestyle management system 10 can proceed execute a download of a lifestyle management system application (i.e., at least one software module capable of communicating with the computer implemented lifestyle management system 10) from an application store associated with the user's computer device (e.g., a mobile device 152). In some embodiments, one or more components of a system architecture 140 can be configured to execute at least one lifestyle management system application, and can include a number of client devices including, but not limited to, desktop computers, laptop computers, digital assistants, personal digital assistants, cellular phones, mobile phones, smart phones, pagers, digital tablets, internet appliances, and other processor-based devices. In some embodiments, the user's computer device can include an Apple iOS client application coupled to the lifestyle management system 10. In some further embodiments, the user's computer device can comprise an Android® client application coupled to the lifestyle management system 10. In some embodiments, at least a portion of the lifestyle management system 10 can include an iOS® client application and/or an Android-based client application. iOS® is a registered trademark of Cisco in the United States and other countries. Android® is a registered trademark of Google, Inc. of Mountain View, Calif.

In some embodiments, once the user 150 has downloaded the application, they can register for the lifestyle management system 10. In some embodiments, registration can be accomplished by an action of the user 150 sending an email to register with a registration application portion of the lifestyle management system 10. In some other embodiments, the user 150 can proceed to register with a third-party social media system. For example, in some embodiments, a user 150 can register using Facebook® credentials. In other embodiments, a user 150 can register using Twitter® credentials. “Facebook” is a registered trademark of Facebook, Inc., and “Twitter” is a registered trademark of Twitter, Inc. In some embodiments, the user 150 can also be provided with an option to be connected through LinkedIn®. LinkedIn® is a registered trademark of LinkedIn Corporation. In some embodiments, a user 150 will have the ability to link their lifestyle information from any number of social media platforms such as Facebook®, Twitter®, Google+®, LinkedIn®, Instagram® and others.

In some embodiments, once the user 150 chooses his/her method of registration and enters the appropriate credentials, the lifestyle management system 10 will make the appropriate decisions to ensure that it obtains the correct information to populate a new user lifestyle management system account. After the account has been created, the user 150 will be prompted to review and agree to contract terms and conditions for the service. The user 150 can be presented with an option to agree to contract terms and conditions for the service. In some embodiments, registration will not be complete unless the user 150 agrees to the contract terms and conditions. In some embodiments, once the user 150 has properly installed the application on their mobile device or other client device, agreed contract terms and conditions for the service, and has been approved as a registered user of the service, the user 150 can be directed to the initial welcome screen.

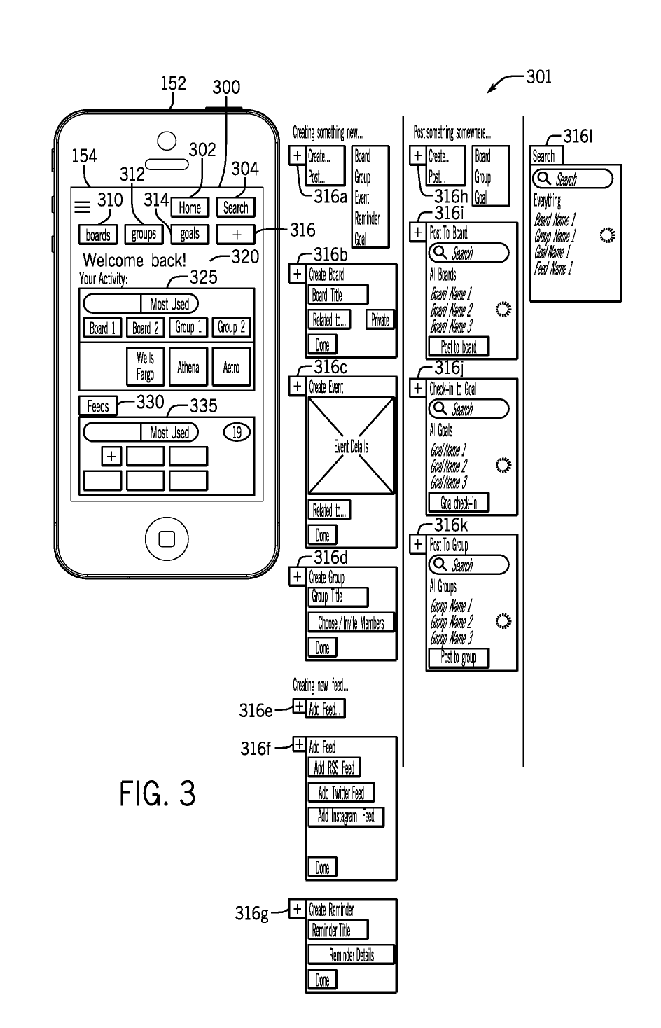

In some embodiments, the lifestyle management system 10 can allow the user 150 to interact with one or more features of the system 10 using a home screen display that can comprise a dashboard type view. In some embodiments, the computer system 100 processing one or more instructions of the lifestyle management system 10 can use a database relationship model 50 linked to the lifestyle management system engine 11 as described earlier to define how various lifestyle related content is distributed to one or more users 150 of the lifestyle management system 10. FIG. 3 for example illustrates a home page display including a dashboard 300 and a plurality of alternate display windows 301 in accordance with at least one embodiment of the invention. In some embodiments, the dashboard 300 can be displayed by a user display 154 within at least one mobile device 152 that can be viewed by one or more users 150 such as a mobile user 150b. In some other embodiments, the dashboard 300 can be displayed to other users 150 including for example fixed users 150a (i.e., those that are interacting with the lifestyle management system 10 using a computer terminal or other substantially non-mobile display). In some embodiments, any one or combination of lifestyle related resources (e.g., including resources 12, 20, 30, and 40 at least) can be accessed and/or displayed through the dashboard display 300. In this manner, the lifestyle management system 10 can provide a user 150 with a single interface or portal to a plurality of lifestyle content received from a plurality of resources.

In some embodiments, the lifestyle management system 10 can process and display the dashboard 300 that can comprise one or more function actionable icons including a boards icon 310 to enable a user 150 to access one or more boards, and a groups icon 312 to enable a user 150 to access one or more groups. In some embodiments, the dashboard display 300 or variations as discussed below can include at least one title 320. In some embodiments, the title 320 can comprise an introduction to a user 150 of the lifestyle management system 10. In some other embodiments, the title 320 can describe or introduce one or more functions or features of the content of the display page 300. Further, the dashboard 300 can include a goals icon 314 to enable a user 150 to access one or more goals. The dashboard can also include one or more control icons including a home icon 302, and at least one search icon 304. In some embodiments, the displayed contents of the dashboard 300 can be updated, modified, or otherwise switched to display alternate windows using the “+” icon 316. For example, in some embodiments, by accessing the icon 316, a user 150 can control the dashboard 300 to display any one of the alternate display windows 301 including at least any one of the display function windows create post 316a, create board 316b, create event 316c, create group 316d, create feed 316e, add feed 316f, create reminder 316g, create post 316h, post to board 316i, check-in to goal 316j, post to a group 316k, and search 316l windows. In some embodiments, the dashboard 300 can include one or more windows for accessing, reviewing, updating, and posting information. For example, in some embodiments, the dashboard 300 can include a primary window 325 and a secondary window 335 that can be used to access, review, update, and/or post information to one or boards or categories 65. Further, some embodiments of the invention include a feeds link 330, that in some embodiments, can be used to link to one or more resources, one or more posts, or more or more user and/or team information streams.

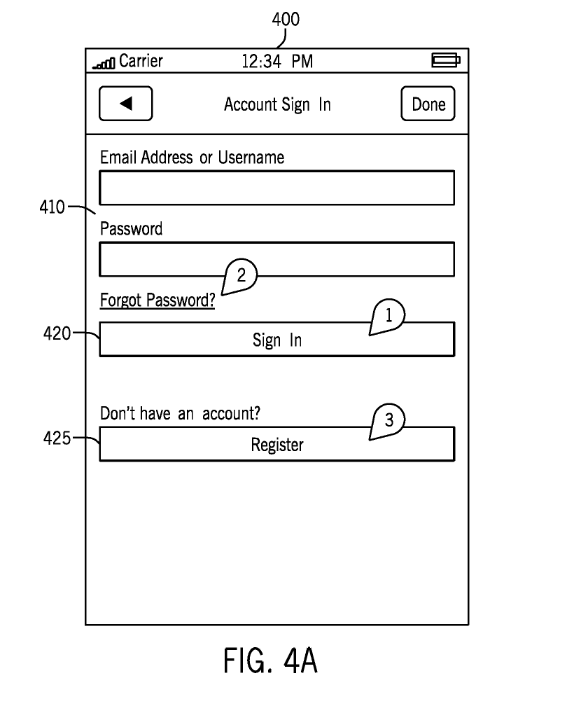

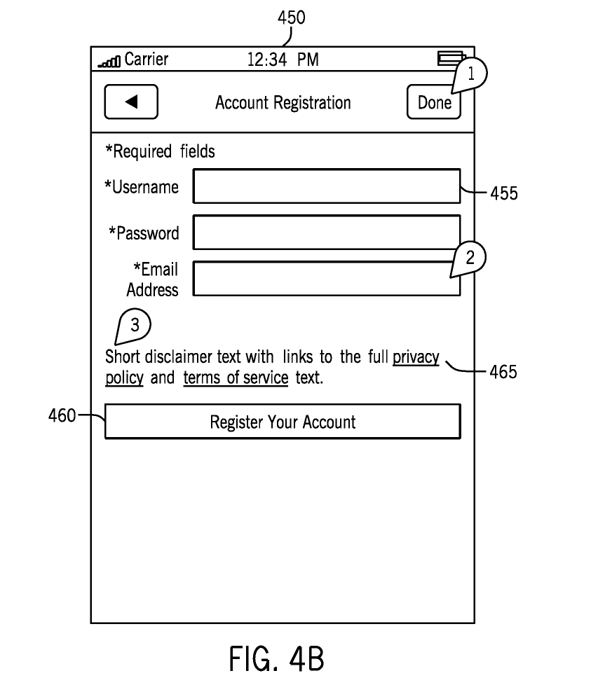

In some embodiments, in order for a prospective user 150 to access one or more features of the lifestyle management system 10, the lifestyle management system 10 can display at least one sign-in page to enable a user 150 to access the system 10. Some embodiments can include an initial welcome display including an option register (taking a user 150 to an account registration screen) or sign-in (taking a user 150 to an account sign-in screen). FIG. 4A for example illustrates an account sign-in display page 400 according to one embodiment of the invention. The display page 400 can be used as a login page when lifestyle management system 10 account validation is required and/or for users 150 who have reset their lifestyle management system 10 account application settings, and who wish to re-associate their account information. As depicted, in some embodiments, to access the system, the user 150 can provide a username and password through entry field 410, and can sign-in using the access button 420. During instances of a successful login process, the lifestyle management system 10 can direct the user to one or more home screens, such as the aforementioned dashboard 300. In instances where there is a sign-in error (e.g., where an invalid sign-in can be caused by an invalid email address or where the email is in the wrong format), the lifestyle management system 10 can display a sign-in assistance information). Some errors can occur if the user 150 has not provided the correct password, and in this instance, the lifestyle management system 10 can send a password to the user's email account of record. In instances where a user 150 is new and has not previously created an account within the lifestyle management system 10, the user 150 can proceed to register using the register access button 425. For example, FIG. 4B illustrates an account registration display page 450 according to one embodiment of the invention. Using the display page 450, a first-time user 150 can register to enable the lifestyle management system 10 to create a new user account. In this instance, personal information can be provided in one or more fields 455, and the user 150 can access one or more privacy policy and terms of service documents through access links 465. The user 150 can then launch an account using the account register button 460. In the event of a user 150 forgetting their password, the user 150 can be directed to a login assistance display page (not show). This can allow the lifestyle management system 10 to reset their account password. Further, old passwords can be replaced with a randomly generated password that is sent to an email address associated with and/or provided by the user 150. In this instance, the email account needs to be the same account that was used for the initial registration. If the email address is unavailable, then the user 150 can be directed to create a new account. In some embodiments, upon successful registration, the lifestyle management system 10 can display a registration complete page (not shown). In this instance, the user 150 can be directed to an account setup process.

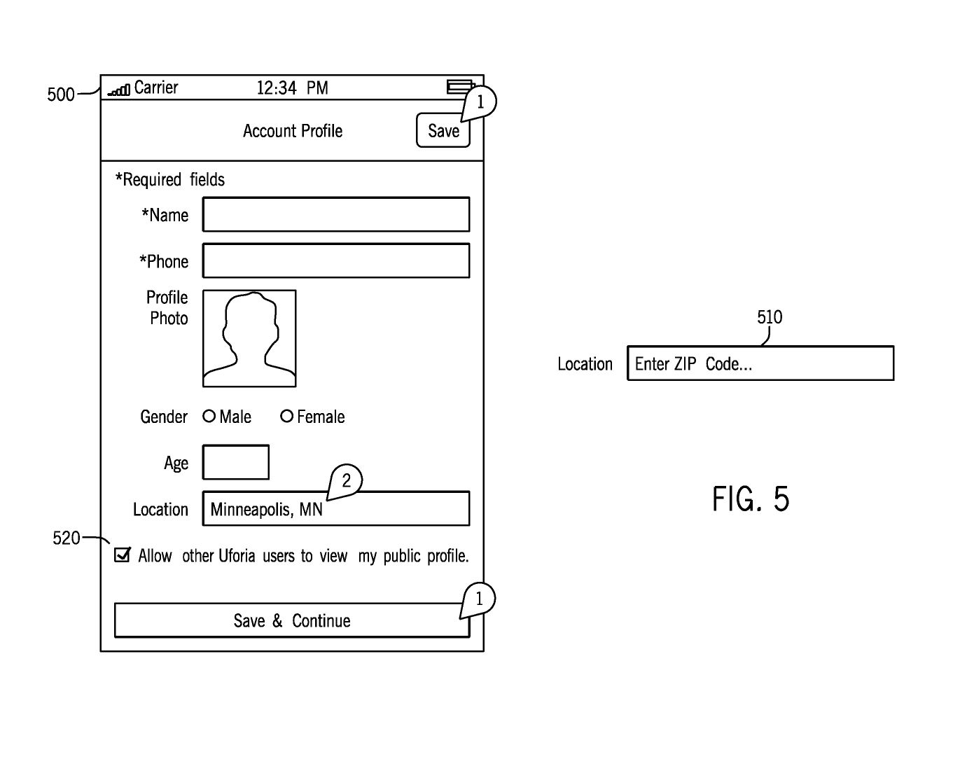

In some embodiments, the lifestyle management system 10 can also direct the user 150 to provide additional personal information that can form at least a partial portion of an account profile of the user 150. For example, FIG. 5 illustrates an account profile display page 500 according to one embodiment of the invention. In some embodiments, the user 150 can provide personal location information 510 by providing a location zip code). Alternatively, or in combination, the location of the user 150 can be tracked by a GPS-enabled device (e.g., by a mobile device 152 that can be used by a mobile user 150b). Further, in some embodiments, the lifestyle management system 10 can enable the user to control the privacy of the user's profile information using a privacy toggle 520. As described earlier, by default, all inputs by a user 150 including created content is set to private as default, and any information entered by the user 150 can be progressively disclosed through sharing control updates provided by the user 150 authoring the private content. Some embodiments of the lifestyle management system 10 can enable a user 150 to navigate, review and update various portions of the user's profile. For example, in some embodiments, account information can be modified and updated. The profile information can comprise the user's first and last name, town and state, and a link to the user's public profile. Other profile information can include the user's username, email address, telephone number, gender, age, and current location. Further, some actionable features can include password change, and account deletion. In some embodiments, the user 150 can also be provided with an option to display a public profile view of one or more portions of the user's profile, and social commenting on any non-public profile (i.e., not public to any viewing user 150) can be prevented. Further, a user 150 can choose to follow or unfollow any user 150 including a user 150 profile.

In some embodiments, the lifestyle management system 10 can enable a user 150 to modify one or more settings of the lifestyle management system 10. For example, in some embodiments, a user 150 can apply one or more settings to one or more content boards or categories, content types, content tone, notification settings (e.g., manual, on application start, or within a set time limit), reminder settings (e.g., an lifestyle management system 10 default notification, a text message, an email, or no action), feedback settings, privacy policy settings, and terms of service settings. For example, in some embodiments, various types of lifestyle related content boards or categories can be turned on or turned off depending on the user's level of interest.

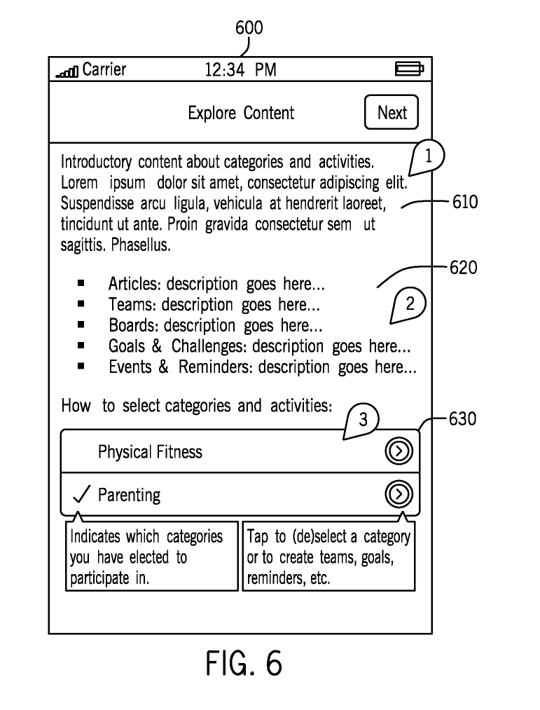

In some embodiments, one or more functions of the lifestyle management system 10 can be provided to the user 150. This can include a description of the content and processes used by the lifestyle management system 10, including for example a review and/or description of the lifestyle management system 10 and the database relationship model 50. For example, FIG. 6 shows one example of an explore content display page 600 according to one embodiment of the invention. In some embodiments of the invention, the display page 600 can be used by the lifestyle management system 10 to provide an introduction section 610, and to provide one or more content descriptions 620. The user 150 can access different narratives by selection of the boards or categories and activities menus 630. In this instance, the user 150 can select any board or category or activity with the content of the lifestyle management system 10 to review a description and summary display within the display page 600.

In some embodiments of the invention, once a user 150 creates an account, the lifestyle management system 10 can provide at least one display page including a tutorial (not shown). For example, in some embodiments, a first time experience for a user 150 interacting with the lifestyle management system 10 can include viewing a displayed tutorial box overlaid on the display that can orientate new users 150 to one or more functionalities of the lifestyle management system 10. Further, in some embodiments, the lifestyle management system 10 can display a visual experience that can assist the user 150 in gaining familiarity with one or more functional aspects of the lifestyle management system 10. This feature can be shown each time the user 150 starts using the lifestyle management system 10, or can be optionally turned-off within the user's profile.

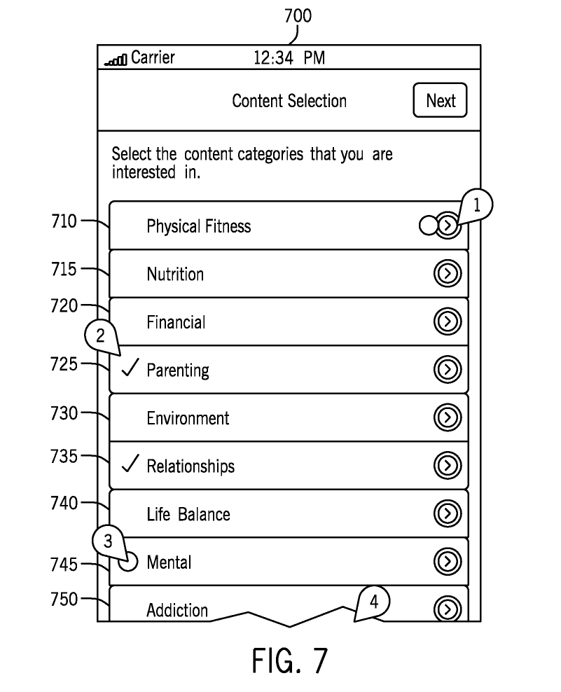

In some embodiments of the invention, once a user 150 creates an account, the user 150 can be prompted to select one or more boards or categories that a user 150 can associate with his or her lifestyle. In some embodiments, by default, all boards or categories are selected by the lifestyle management system 10. However a user 150 can select one or more boards or categories using the content selection display page 700 (shown in FIG. 7). For example, the lifestyle management system 10 can include a plurality of content boards or categories comprising for example a physical fitness board or category 710, a nutrition board or category 715, a financial board or category 720, a parenting board or category 725, an environment board or category 730, a relationship board or category 735, a life balance board or category 740, a mental board or category 745, and an addiction board or category 750, amongst others. In some embodiments a user 150 can select any one or more of the boards or categories 710, 715, 720, 725, 730, 735, 740, 745, 750 based on the user's lifestyle perspective. Once a user 150 selects a board or category, the selected board or category can include a visual representation that the board or category has been selected by the user 150. For example, as shown in FIG. 7, the exemplary display page 700 shows an environment board or category 730 (un-ticked), and a relationship board or category 735 and a parenting board or category 725 including at least one graphical tick mark.

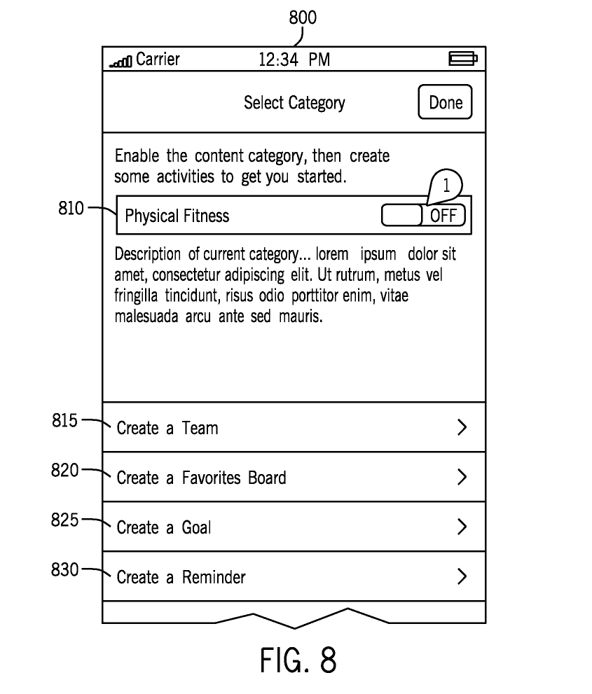

In some embodiments, the user 150 can begin to start using the lifestyle management system 10 to manage at least one aspect of the user's lifestyle. For example, the user 150 can select a board or category (such as any one or more of the boards or categories 710, 715, 720, 725, 730, 735, 740, 745, 750) from which the user 150 can assign at least one activity option. For example, FIG. 8 shows an example of a select board or category display page 800 according to one embodiment of the invention. In this example, a physical fitness board or category can be selected using a toggle 810 (to select from an “off” to an “on” position). The user 150 can then access at least one create activity option associated with a selected board or category. For example, a create team activity 815, a create favorites board 820, a create goal 825, and/or a create reminder 830 can be selected by the user 150 as an activity to be associated with the currently toggled board or category.

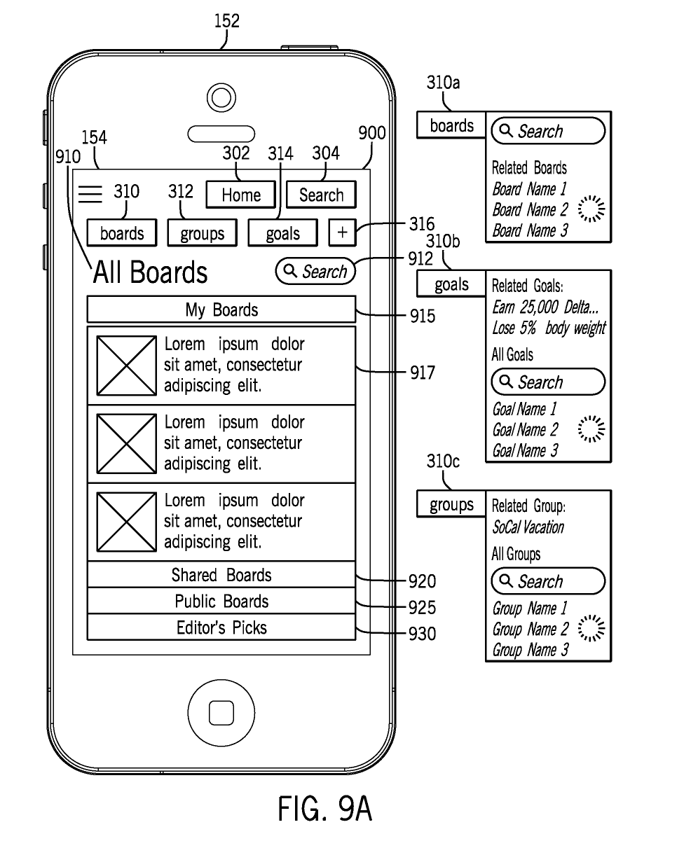

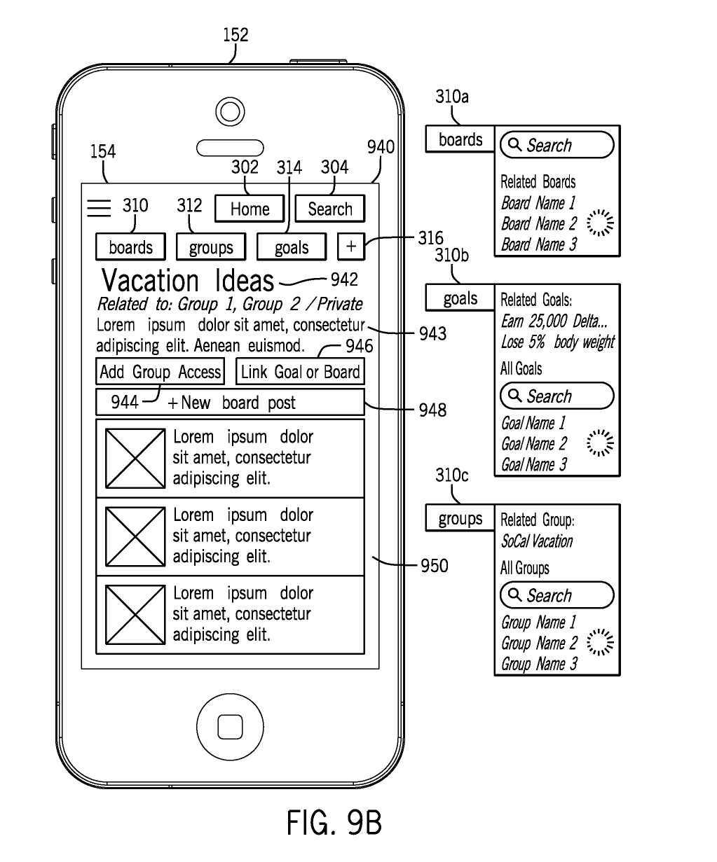

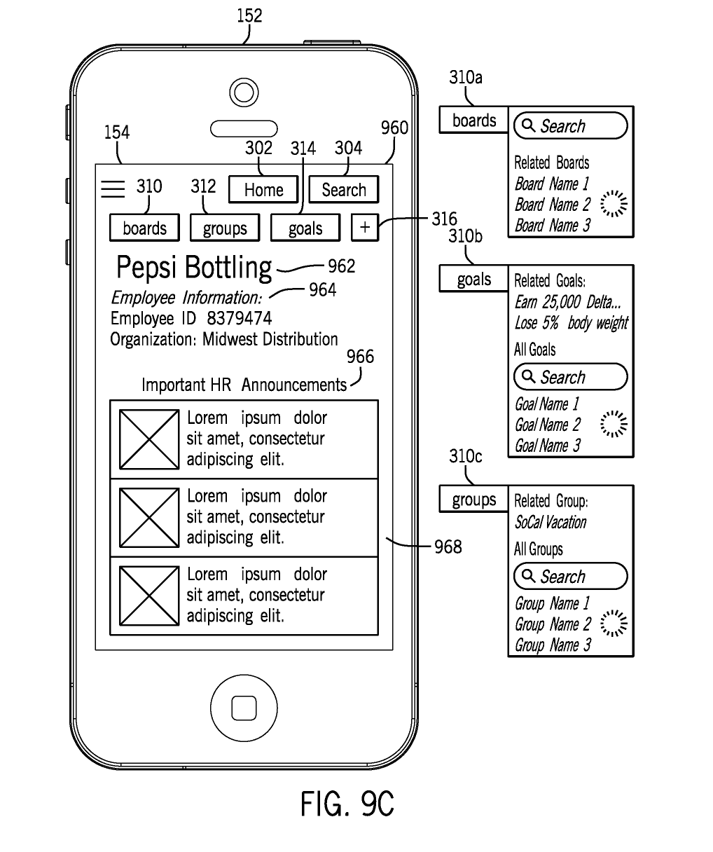

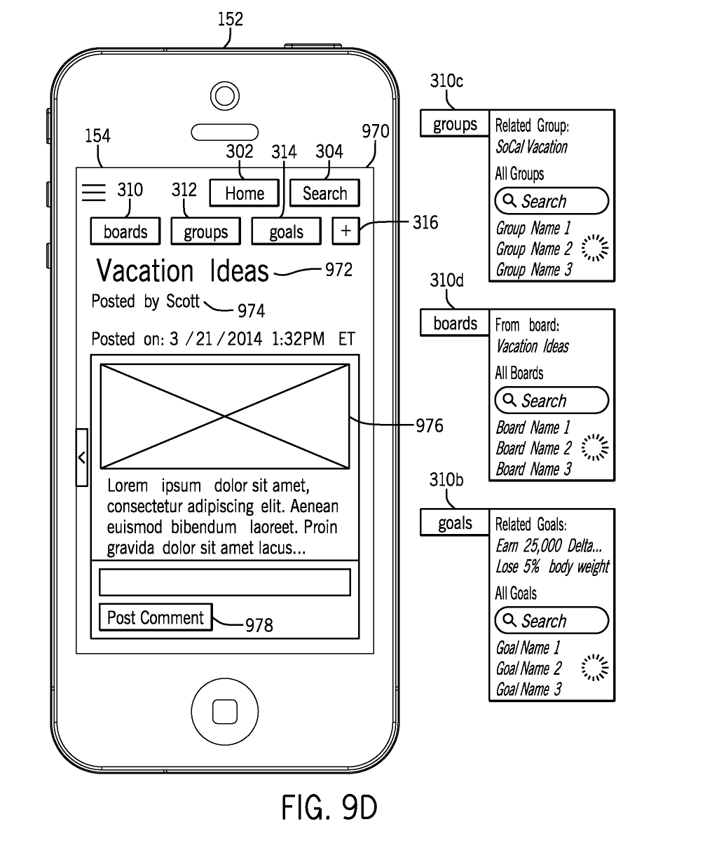

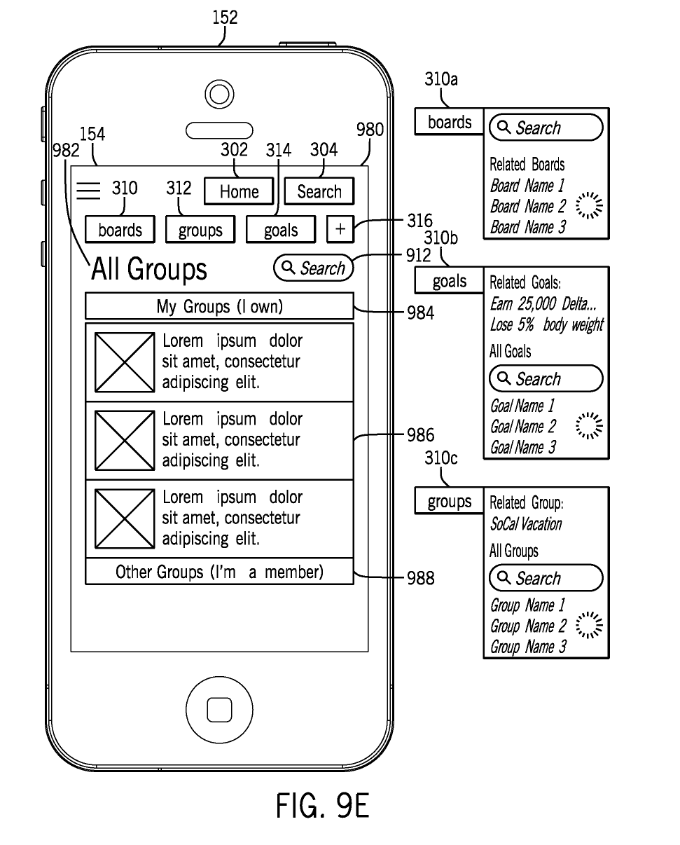

Some embodiments of the invention can provide options for a user 150 to create one or more boards that can be associated with and/or populated with at least one lifestyle related board or category and activity. For example, FIGS. 9A-E illustrate detail view display pages 900, 940, 960, 970, 980 according to some embodiments of the invention. In some embodiments, the lifestyle management system 10 can process and display the display page 900 that can comprise one or more function actionable icons including a boards icon 310 to enable a user 150 to access one or more boards, and a groups icon 312 to enable a user 150 to access one or more groups. Further, the display page 900 can include a goals icon 314 to enable a user 150 to access one or more goals. The display page 900 can include one or more control icons include a home icon 302, and at least one search icon 304. Further, the displayed contents of the display page 900 can be updated, modified, or otherwise switched to display alternate windows using the “+” icon 316. For example, the boards window 310a can be displayed within the display page 900, or alternatively or in addition to, the goals window 310b can be displayed within the display page 900. Further, in some embodiments, the groups window 310c can be displayed within the display page 900. In some embodiments of the invention, the display page 900 can include an “all boards” display 910, and boards can be searched by a user 150 using the search function 912. In some embodiments, the display 900 can also include a list of the user's boards (my boards 915), and can list at least one board 917. Further, the display page 900 can provide access to other board information including one or more other boards or categories that can also be displayed by a user 150. In some embodiments, this can include a shared boards (icon 920), a public boards (icon 925), and an editor's pick board (icon 930).

In some embodiments, the lifestyle management system 10 can display a board detail that includes a leisure related lifestyle board or category or activity. For example, FIG. 9B depicts a display page 940 that features a vacations ideas display 942. The display 942 can include relationship information 943 (e.g., showing the vacations ideas display 942 that is related to one or more groups). In some embodiments, group access to the information related to the vacations ideas display 942 can be added by a user 150 using the function icon 944. Moreover, in some embodiments, a user 150 can link a goal or board to the vacations ideas display 942 using the function icon 946. In some further embodiments, the function icon 948 can enable a user 150 to perform a new board post, and one or more posts associated can be viewed in the window 950 as selected by the user 150.

In some further embodiments, the lifestyle management system 10 can display a board detail that includes employee information and human resources information. For example, FIG. 9C illustrates one example of a board display page 960 associated with an employer display 962 and employee display 964. As shown, in some embodiments, one or more human resources announcements 966 can be displayed within a window 968.

In some other embodiments, the lifestyle management system 10 can display a board detail that includes leisure related ideas. For example, FIG. 9D shows a board display 970 comprising a vacation ideas display 972. In some instances, a window 310d can enable a user 150 to search for vacation ideas across one or more boards. In some embodiments, vacation ideas display 972 can display vacation information within a window 976 that is associated with any user 150 with a “posted by user” identification 974. Further, in some embodiments, following a review of one or more posts within the vacation ideas display 972, a user 150 can post a comment 978.

In some other embodiments, the lifestyle management system 10 can provide a board detail view to a user 150 that comprises an all groups display page 980. For example, as shown in FIG. 9E, the all groups display 982 can include a “my groups” selection icon 984 for displaying information related to all groups within the window 986. Further, in some embodiments, a user 150 can select further groups using the access icon 988.

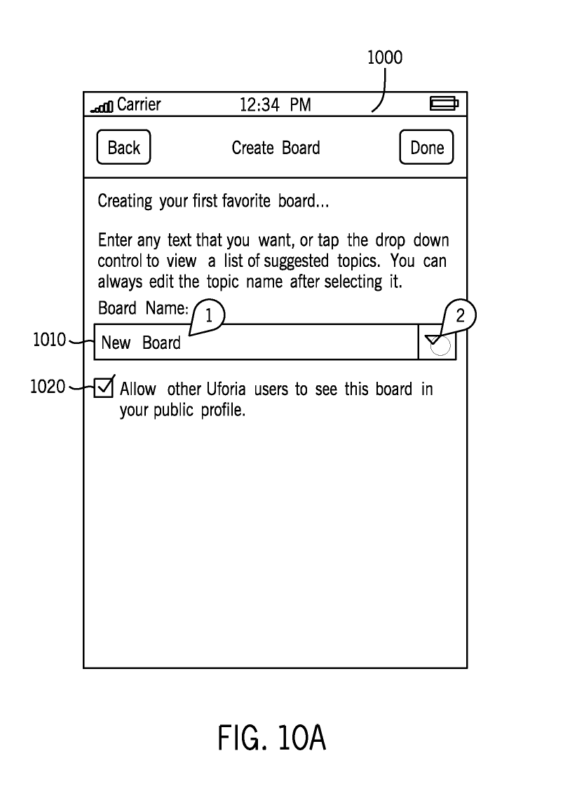

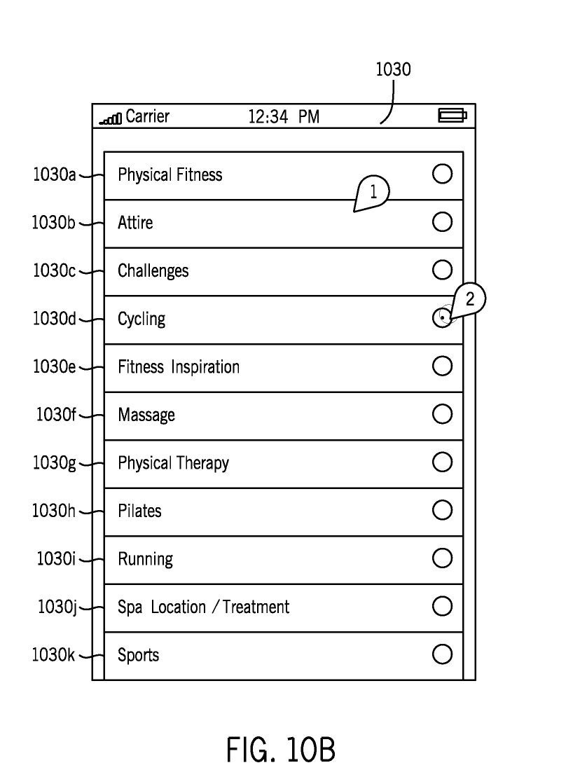

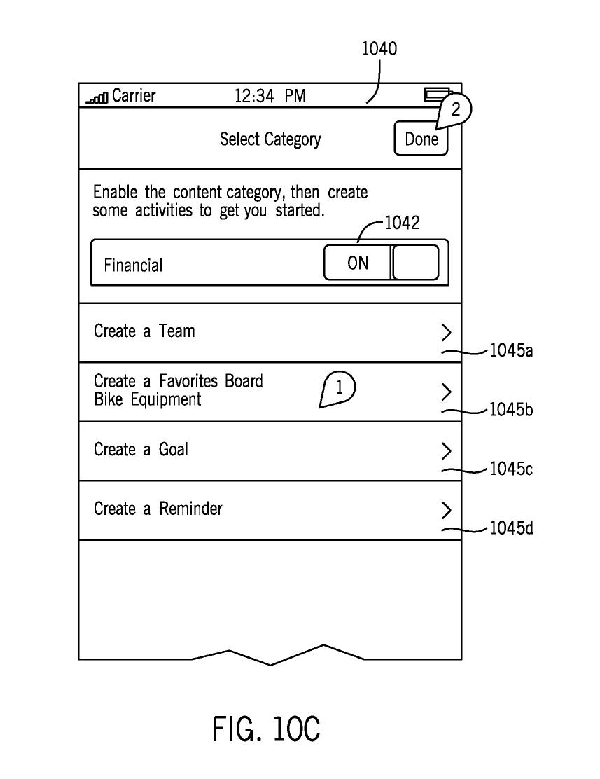

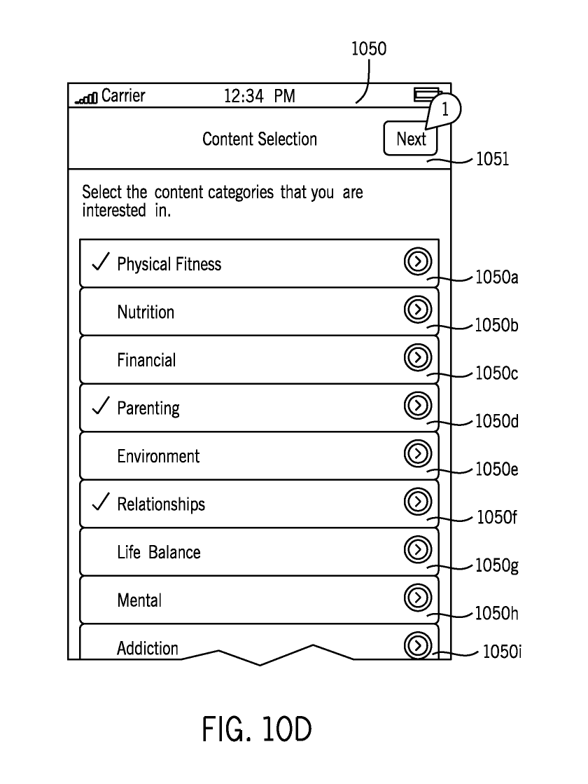

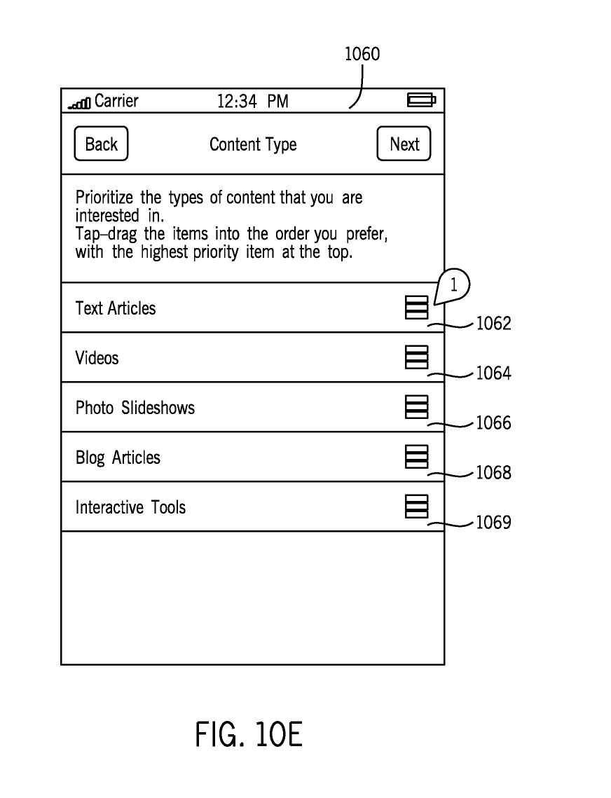

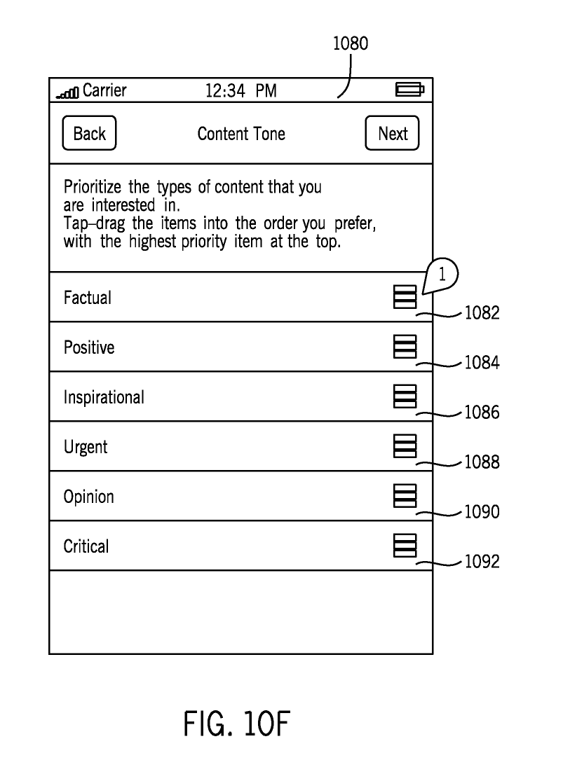

FIG. 10A-10F illustrate examples of board creation within display pages 1000, 1030, 1040, 1050, 1060, 1080 according to some embodiments of the invention. As depicted in FIG. 10A, in some embodiments of the invention, the lifestyle management system 10 can include a create board display page 1000 from which a user 150 can select a new board name from menu 1010. In some embodiments, a pre-set board name can be selected, however the user 150 can also provide an alternate name by tapping the menu 1010 field, and entering a custom board name. Further, in some embodiments, the user 150 can assign a privacy level by selecting toggle 1020 instructing the lifestyle management system 10 to hide or show the selected board to other users 150 of the lifestyle management system 10. As shown in the display page 1030 in FIG. 10B, in some embodiments, the lifestyle management system 10 can enable a user 150 to create a favorites board by selecting one or more lifestyle boards or categories. In some embodiments, the lifestyle boards or categories can be selected from a list comprising at least physical fitness 1030a, attire 1030b, challenges 1030c, cycling 1030d, fitness inspiration 1030e, massage 1030f, physical therapy 1030g, pilates 1030h, running 1030i, spa location/treatment 1030j, and sports 1030k. Further, in some embodiments, additional content can be added during the board or category selection. As shown in display page 1040 of FIG. 10C, once a content board or category has been turned on (for example in this instance the financial board or category 1042), a user 150 can proceed to create some activities. In this example, a user 150 can select one or more creation activities including create a team 1045a, create a favorites board 1045b, create a goal 1045c, and create a reminder 1045d. Further, as shown in the display page 1050 of FIG. 10D, a user 150 can then proceed to select one or more content boards or categories including physical fitness 1050a, nutrition 1050b, financial 1050c, parenting 1050d, environment 1050e, relationships 1050f, life balance 1050g, mental 1050h, and addiction 1050i. Once the user 150 has selected their desired content boards or categories, the user 150 can switch to the next account setup display using the “next” action icon 1051.

In some embodiments, the user 150 can instruct the lifestyle management system 10 to apply one or more filters to any selected content. For example, as shown in the display page 1060, content type can be prioritized by the lifestyle management system 10 following user 150 selection of one or more content types. In this example, the content types can be text articles 1062, videos 1064, photo slideshows 1066, blog articles 1068, interactive tools 1069, or combinations thereof. In some embodiments, the content types including at least text articles 1062, videos 1064, photo slideshows 1066, blog articles 1068, and interactive tools 1069 can be prioritized by arranging the order (e.g., by selecting, dragging, and dropping) of any one of the tone types text articles 1062, videos 1064, photo slideshows 1066, blog articles 1068, and interactive tools 1069.

Furthermore, in some embodiments, the tone of any content can be adjusted by the lifestyle management system 10 under direction by the user 150. As illustrated in the display page 1080 of FIG. 10F, in some embodiments, the user 150 can modify the tone of the content (including for example the tone of at least any one of the content boards or categories including physical fitness 1050a, nutrition 1050b, financial 1050c, parenting 1050d, environment 1050e, relationships 1050f, life balance 1050g, mental 1050h, and addiction 1050i) by selecting the tone type from a group of tone types. In some embodiments, the tone types can comprise at least factual 1082, positive 1084, inspirational 1086, urgent 1088, opinion 1090 and critical 1092. In some embodiments, the tone types 1082, 1084, 1086, 1088, 1090 and 1092 can include a drag handle that a user 150 can move to indicate their level of interest (not shown). In some embodiments, the tone types including at least factual 1082, positive 1084, inspirational 1086, urgent 1088, opinion 1090 and critical 1092 can be prioritized by arranging the order (e.g., by selecting, dragging, and dropping) so as to order any one of the tone types 1082, 1084, 1086, 1088, 1090, 1092.

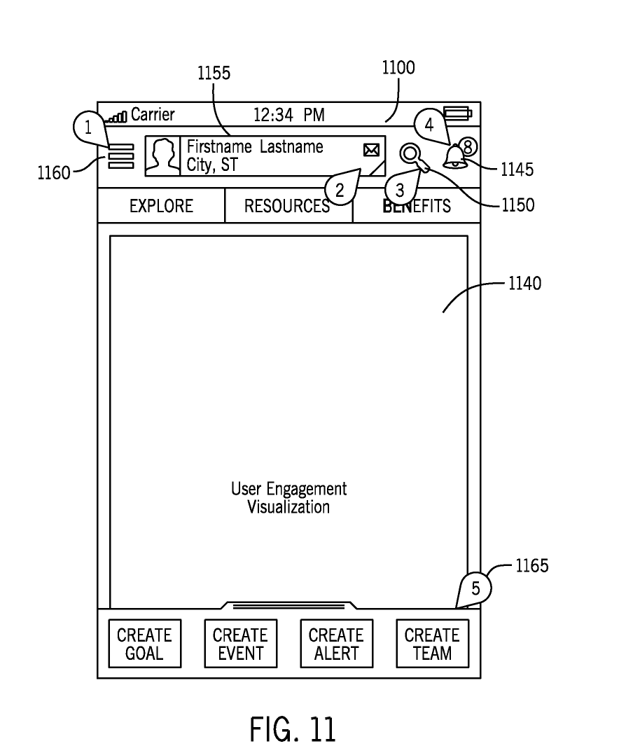

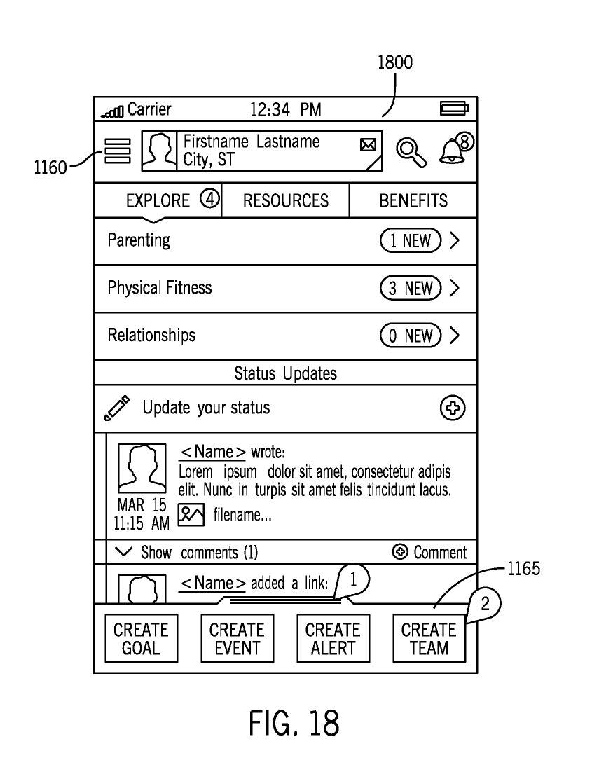

In some embodiments, the lifestyle management system 10 can include a set of global tools presented within one or more display pages at any point in their use of the lifestyle management system 10. FIG. 11 shows one example of a tools function display page 1100 according to one embodiment of the invention which shows an icon 1160 for allowing a user 150 to access one or more links to all common areas of the application. Further, the display page 1100 includes the user profile block 1155 that can include a drop-down menu with options to send messages and update status. The search icon 1150 can be used by the user 150 to open a search screen. The alerts icon 1145 can enable a user 150 to see newly triggered alerts. In some embodiments, the footer tray 1165 comprises one or more create functions access icons. This is also shown in FIG. 18 which shows one example of a footer tray display page 1800 according to one embodiment of the invention. In this example, the footer tray 1165 is shown displayed as a persistent (i.e. substantially permanent) display within the display page 1800. In some embodiments, footer tray 1165 can be displayed across all display screens presented by the lifestyle management system 10 (i.e. the footer tray 1165 is shown substantially permanently while other portions of the display page can change to reveal other content and features).

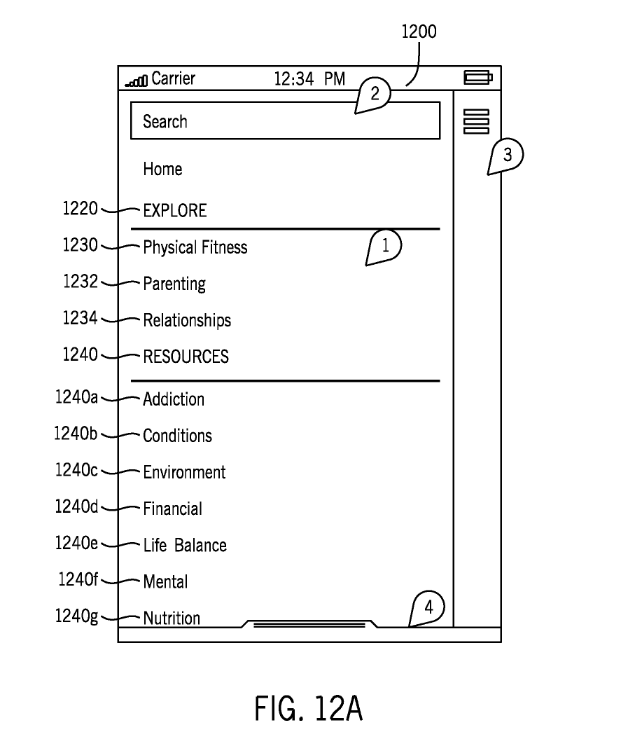

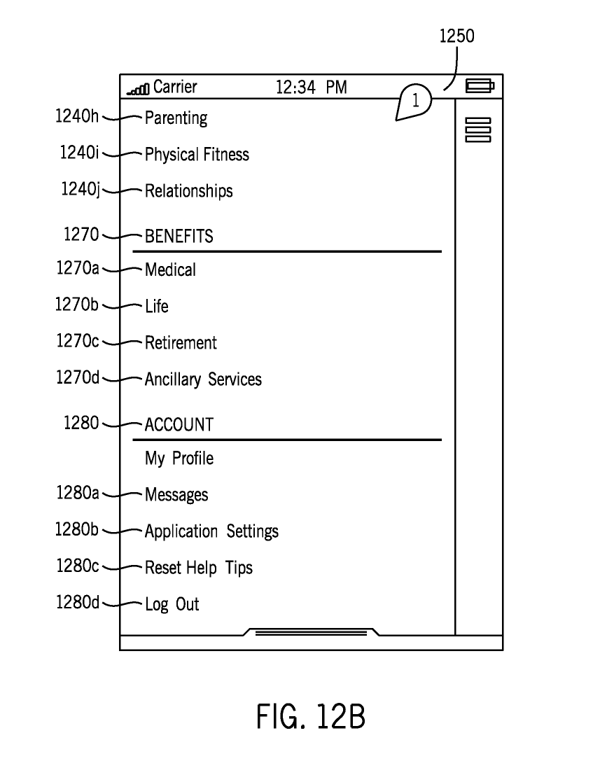

In some embodiments, a user 150 can select the aforementioned icon 1160 to display one or more links to common lifestyle content areas of the lifestyle management system 10. For example, FIGS. 12A-12B show one example of content selection display pages 1200, 1250 according to one embodiment of the invention. As shown, lifestyle content areas can be presented under various sections including explore section 1220, resources section 1240, benefits section 1270. For example, as shown, the explore section 1220 can include physical fitness 1230, parenting 1232, and relationships 1234. In some embodiments, the resources section 1240 can include content selections of addiction 1240a, conditions 1240b, environment 1240c, financial 1240d, life balance 1240e, mental 1240f, nutrition 1240g, parenting 1240h, physical fitness 1240i and relationships 1240j. Further, as shown in FIG. 12B, the benefits section 1270 can include medical 1270a, life 1270b, retirement 1270c, and ancillary services 1270d sections. Further, the display page 1250 can also include an account section 1280 to allow a user 150 to access various account related features including access links comprising messages 1280a, application settings 1280b, reset help tips 1280c, and a log-out link 1280d.

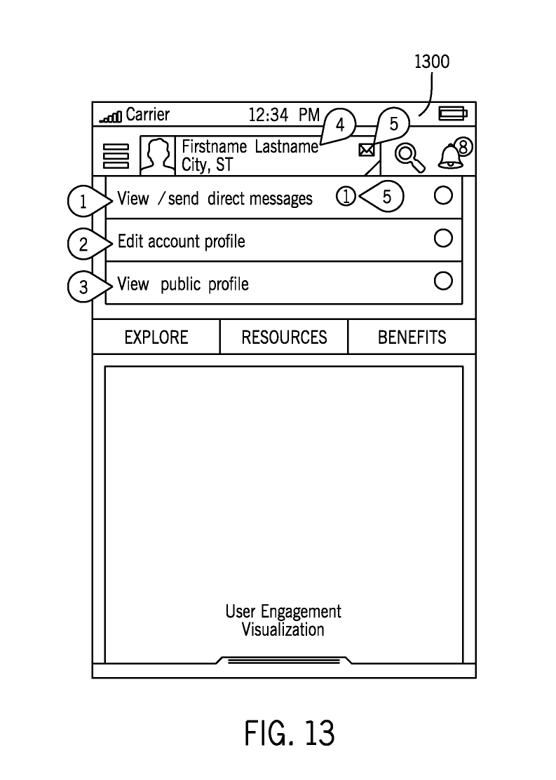

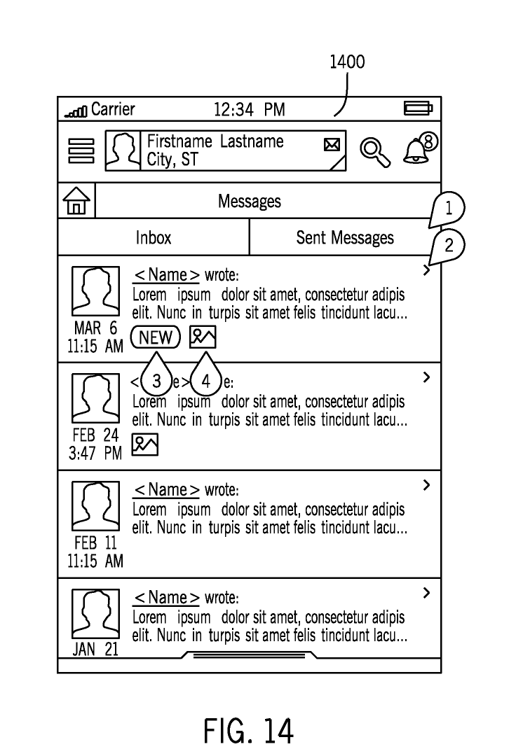

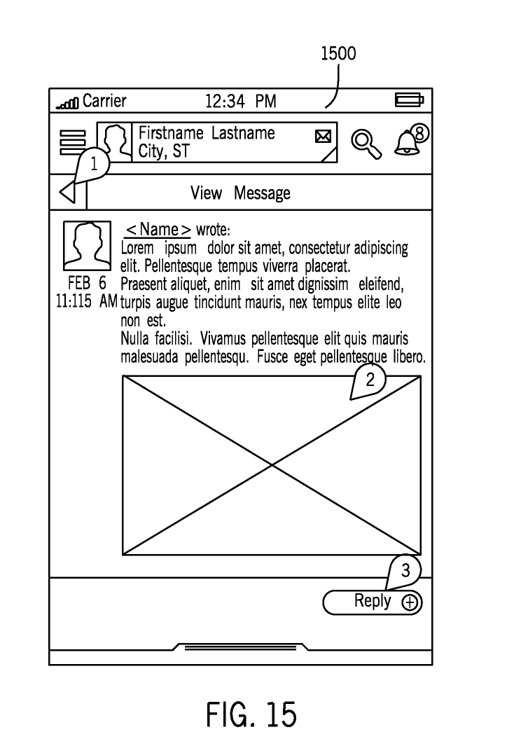

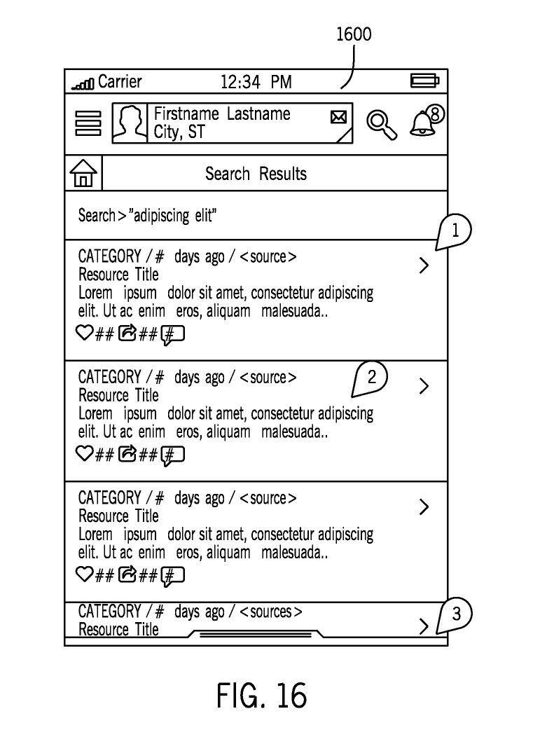

Some embodiments of the invention are provided for integrated messaging options. In some embodiments, the user 150 can access the various user profile and messaging options of the lifestyle management system 10 using at least one of the profile menu display pages 1300, 1400, 1500 of FIGS. 13-15, respectively. In some embodiments, the various user profile and messaging options shown in the profile menu display pages 1300, 1400, 1500 can include options to view messages that the user 150 has sent or received, or can allow switching between received and sent messages, and/or can be used to send a new message to one or more users 150. In some embodiments, a user 150 can mark a message private. The profile menu display pages 1300, 1400, 1500 can include options to include attachments with one or more messages, including attachment of media including images and video (such as a photo or video from a mobile device 152). Moreover, a search function can enable a user 150 to search for any content and board or category within the lifestyle management system 10. For example, FIG. 16 shows a search function display page 1600 according to one embodiment of the invention that can serve as an interface for a user 150 to perform the search of content and board or category. In some embodiments, the lifestyle management system 10 can display a graphically rendered keyboard to facilitate a search entry, and can enable more than one search term to be entered and displayed.

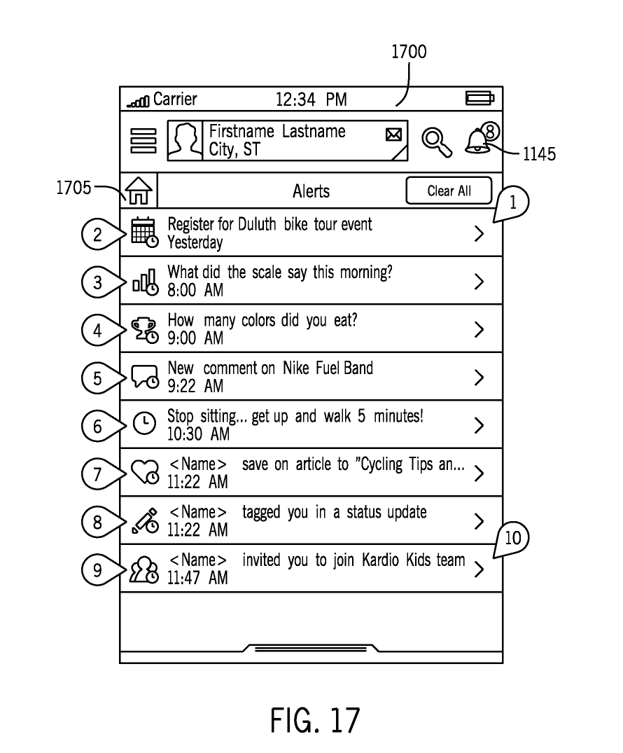

In some embodiments, various reminders and alerts can be set up by the user 150. In some embodiments, the lifestyle management system 10 can trigger an alert and/or reminder for activities across one or more, or substantially all of the lifestyle boards or categories of the lifestyle management system 10. For example, FIG. 17 shows an alert function display page 1700 according to one embodiment of the invention. In this example, current alerts are displayed in an alert message window 1705 in a list format within the display page 1700, and any one of the alerts can be accessed for further detail if a user 150 selects the alert (e.g. by tapping on the screen within the alert displayed). As described earlier, the alerts icon 1145 can enable a user 150 to see newly triggered alerts.

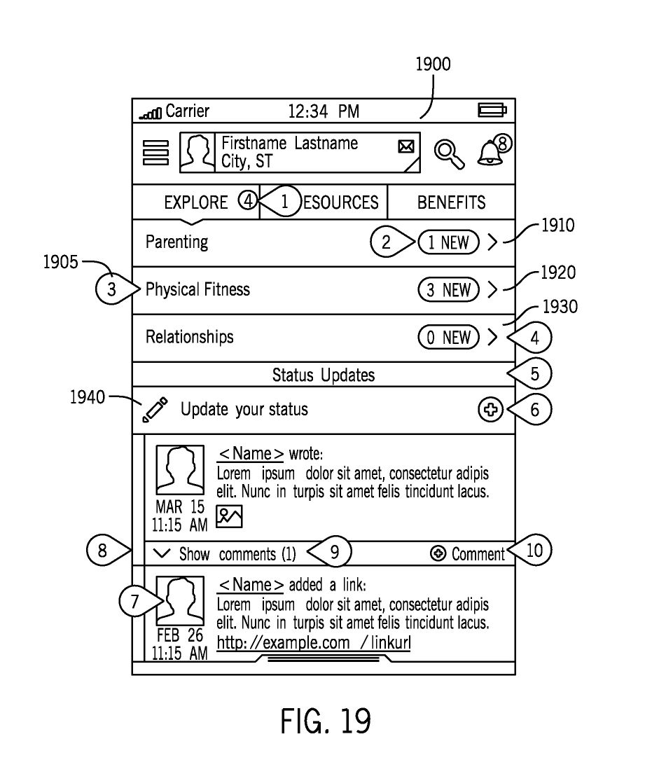

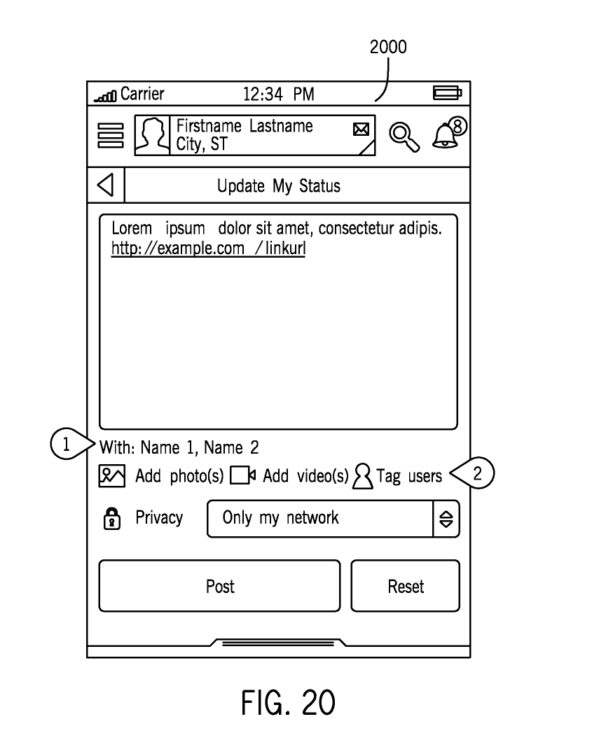

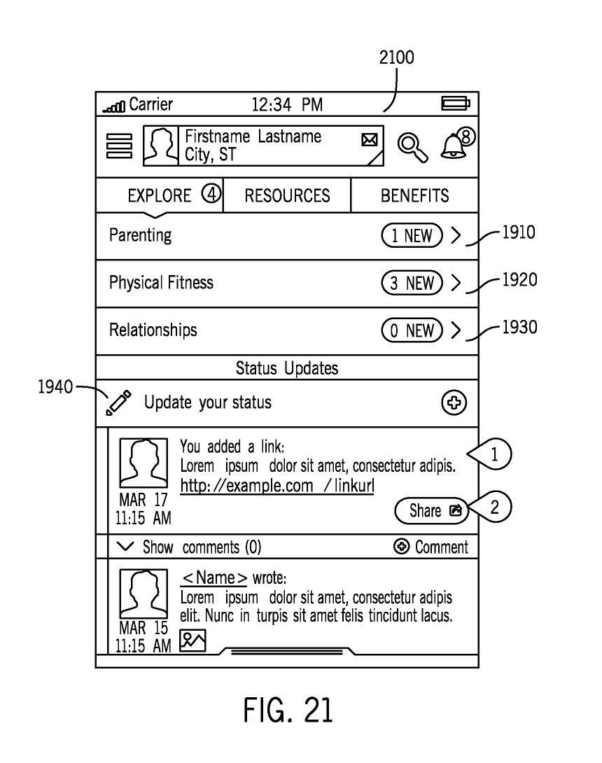

In some embodiments, the lifestyle management system 10 can present various types of home screens in addition to or in place of the dashboard 300 described earlier. In some embodiments, the lifestyle management system 10 can be adapted to present lifestyle management related content in one or more home screen styles selected by the lifestyle management system 10, a system administrator 135, and/or the user 150. For example, FIG. 19 shows an explore home screen display page 1900 that can function to provide a user 150 with a primary interface to view current content streams for their ongoing activities. In some embodiments, the one or more call-out information boxes can be displayed to introduce the user 150 to one or more aspects of the explore home screen display page 1900. This example illustrates various ways in which lifestyle content can be displayed by the lifestyle management system 10 and accessed by a user 150 through a primary interface. In this instance, the display page 1900 shows one example of an explore view from which a user 150 can view content streams for various lifestyle boards or categories 1905 chosen by the user 150. As illustrated, unread items 1910, 1920 assigned to lifestyle boards or categories 1905 can be accessed by a user 150, and any lifestyle boards or categories (e.g., boards or categories 1930) can be accessed by a user 150 to view current activity streams of articles, favorites, teams, goals and challenges and reminders associated with this board or category. Further, in some embodiments, the explore home screen display page 1900 can include a link 1940 to provide a curated aggregate feed of status updates by the user 150, and through the status update display page 2000 (shown in FIG. 20), an updated status can be provided to the lifestyle management system 10 (e.g., FIG. 21 shows a status updated display page 2100 according to one embodiment of the invention).

In some embodiments, the lifestyle management system 10 can enable a user 150 to provide a status update and post one or more comments. Status updates can include a posted time and date and can be arranged in one or more threads. A user 150 can be provided with an option to view or hide a comment, and display comments in reverse chronological order (with most recent comments appearing at the top of a comment list). Status and comments can also be shown visually grouped together. Further, in some embodiments, the lifestyle management system 10 can provide an option to enable a user 150 to receive an alert notification when new comments are added to any status update provided by a user 150. In some embodiments, the lifestyle management system 10 can display a new comment in a highlighted color (different from other older comments), which in some embodiments can revert to a color used to display older comments after a specific time period. In some further embodiments, status updates can include photo and/or video attachments, and users 150 can tag other users 150 in their network. Further, depending on the privacy setting of the user 150, the user's status and comment posts can appear in any explore content stream, in specific team activity streams, or on a user's public profile.

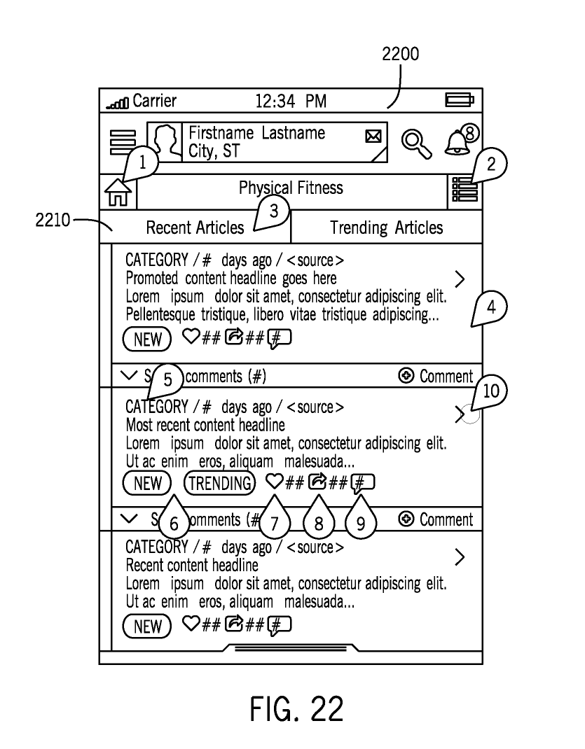

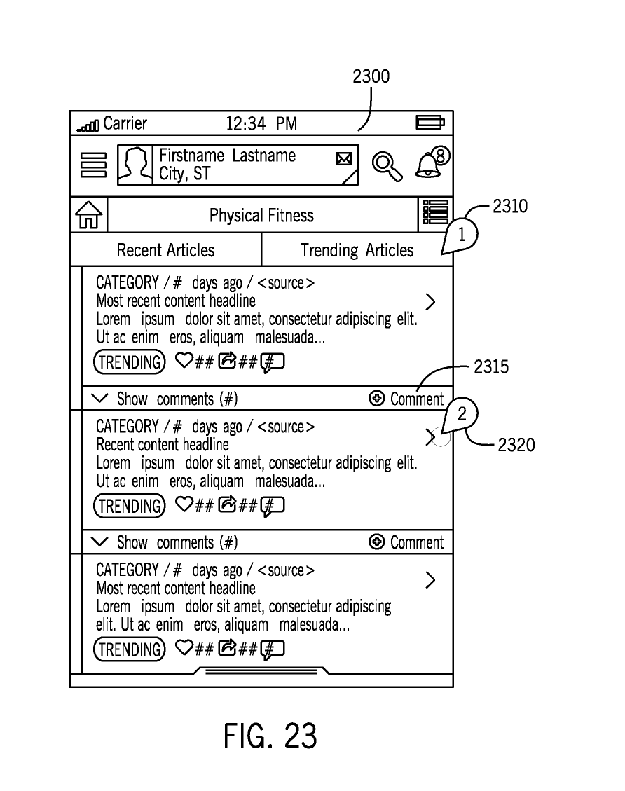

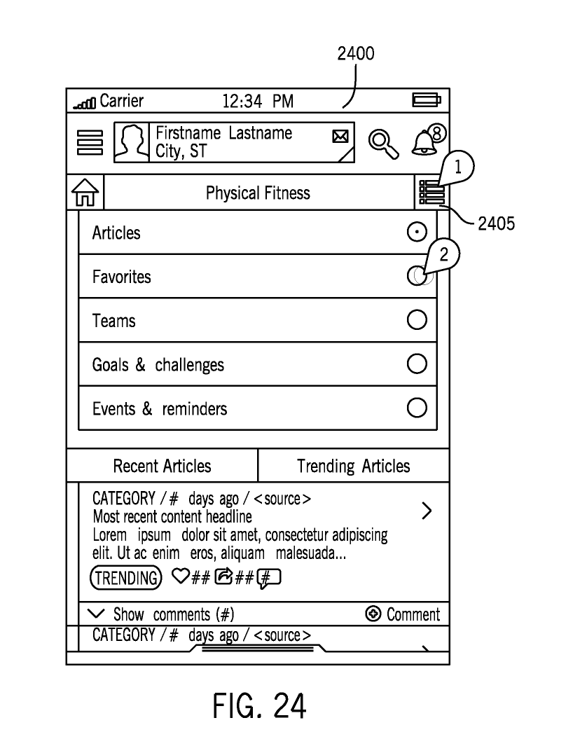

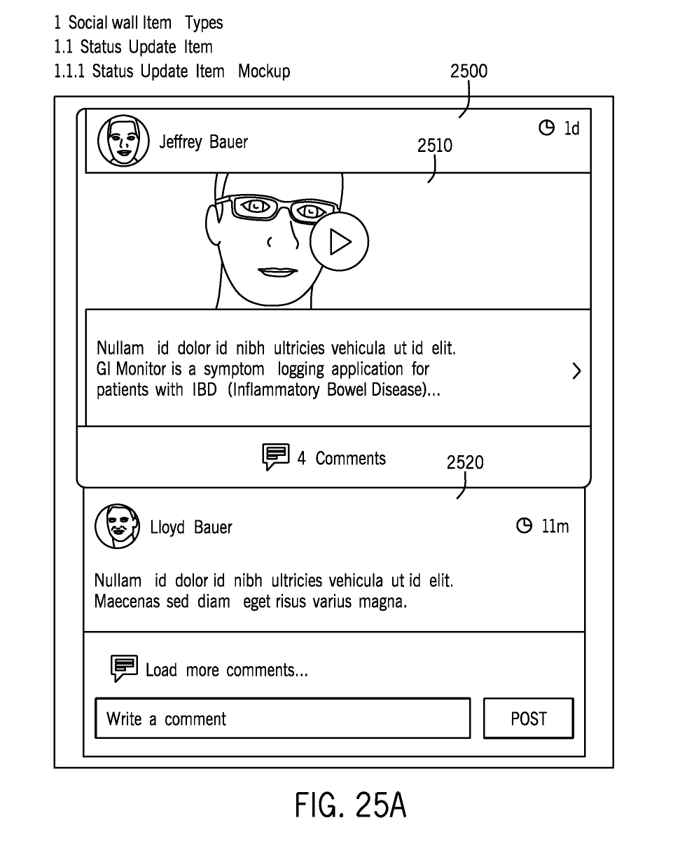

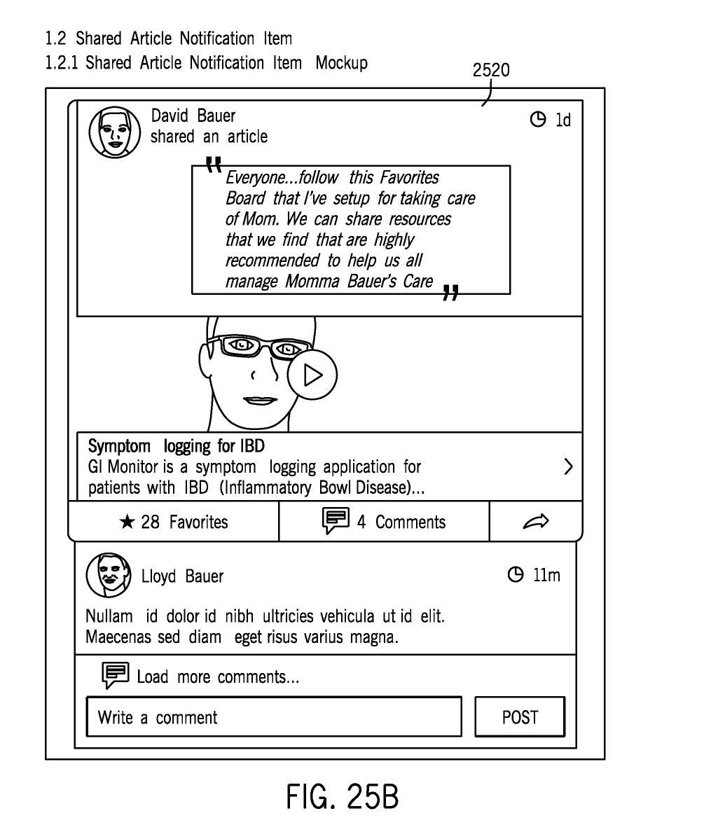

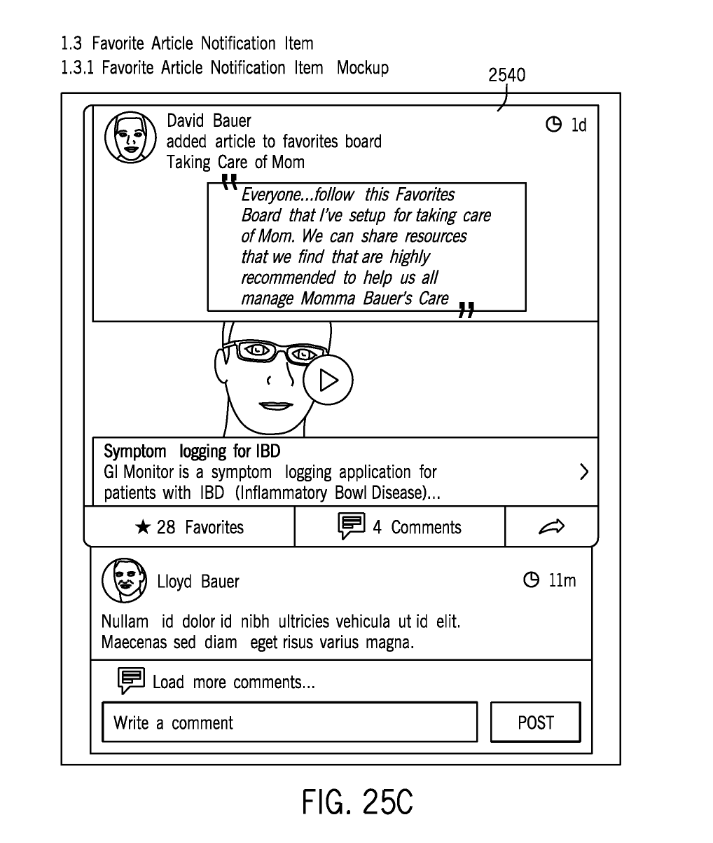

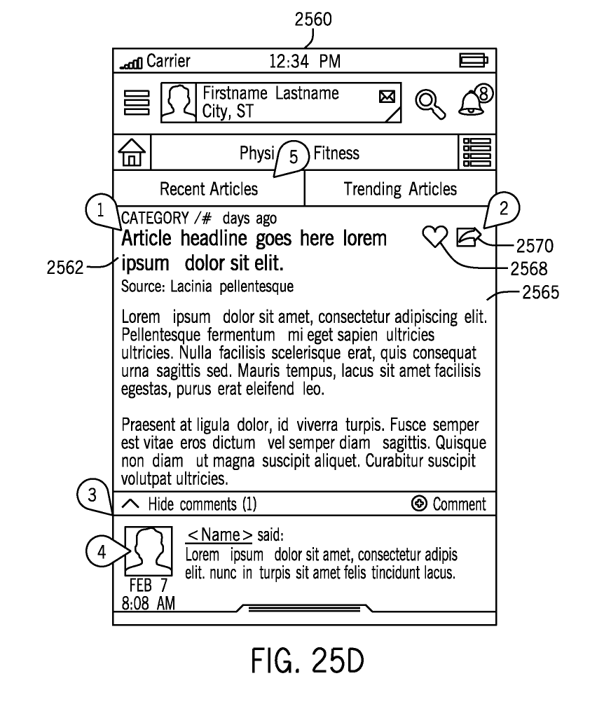

Some embodiments of the lifestyle management system 10 can provide one or more users 150 the option to view, create, post and comment on one or more lifestyle related articles (including for example, any article in any format including text, graphics, video, voice, or combinations thereof). For example, FIG. 22 shows one example of a recent articles display page 2200 showing a recent articles list 2210, and FIG. 23 shows one example of a trending content display page 2300 showing a trending articles list 2310. Further, in some embodiments, the lifestyle management system 10 can enable a user to interact with one or more other users 150 of the lifestyle management system 10 posting a comment related to one or more posted articles. For example, by accessing a comment icon 2315, a user 150 can comment on a specific article. Further, in addition to the article summary list provided by the recent articles list 2210, and the trending articles list 2310, any article can be expanded to access more content (including the full content of the article) by accessing the expand icon 2320. FIG. 25D for example illustrates an example of a full article view display page 2560 according to one embodiment of the invention. Further, in some embodiments, as depicted in FIG. 24 illustrating a change activity menu display page 2400, a user 150 can switch the activity source at any time to display articles related to the current content board or category by accessing the change view icon 2405.

Some embodiments of the lifestyle management system 10 can create a social wall comprising at least one user 150 status update. In some embodiments, a user 150 can post a lifestyle related status update destined for review by at least one other user 150. For example, in some embodiments, the user 150 can post a health or medical technology related status update for review and comment by another user 150. FIG. 25A for example illustrates a social wall status update item display page 2500 according to one embodiment of the invention. In this instance, a posted article (in this instance comprising a video and text article) can appear in the region 2510 of the display page 2500, and one or more comments can be displayed in the region 2520 of the display. Further, any user 150 posting an article can include a comment associated with the post (shown for example in the region 2520 of the display page 2520 shown in FIG. 25B which illustrates an example of a shared article notification item). In some embodiments, any comments posted and displayed can be positioned in any section of the display page with an article.

In some embodiments, the user 150 can assign the article as a favorite, as illustrated in FIG. 25C which illustrates an example of a favorite article notification display page 2540 according to one embodiment of the invention. Moreover, in some embodiments, any article marked favorite by a user 150 can be marked as a favorite icon. For example, as shown in the display page 2560 in FIG. 25D, the article window 2565 can include a favorite icon 2568 (e.g., comprising a heart-shaped symbol) that is displayed adjacent the article 2562. Further, the lifestyle management system 10 can provide an option for a user 150 to share any article with any other user 150. In some embodiments, a user 150 can use the share icon 2570 to share an article (e.g., article 2562) with another user 150. In some embodiments, a user 150 can share an article selectively with a team (i.e., a group of users 150) or with an individual (i.e., one specific user 150). In this instance, the lifestyle management system 10 can display one or more contacts from which the user 150 can select to share an article. The user 150 can select a single individual with which to share the article, or can select more than one individual of a team with which to share the article. The lifestyle management system 10 can also display a message alerting a user 150 that an article has been shared successfully.

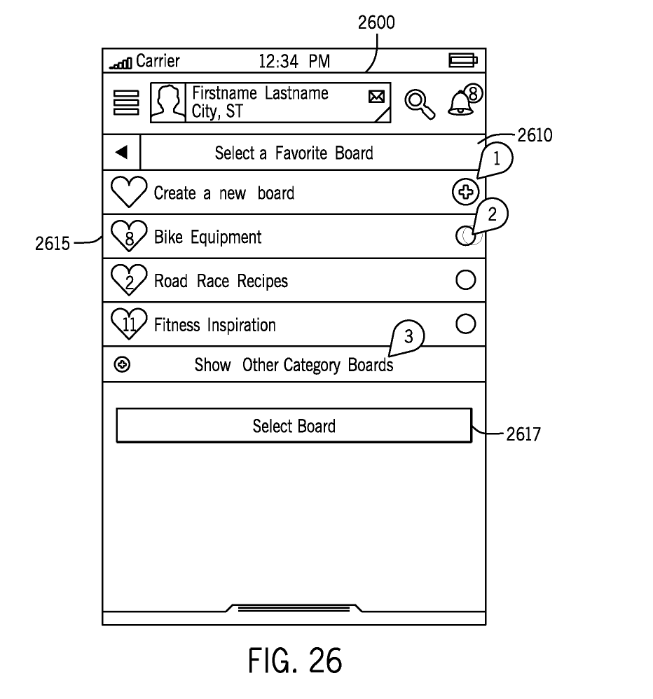

In some embodiments, a board can be selected to save a favorite article. For example, FIG. 26 shows one example of a select favorite board display page 2600 according to one embodiment of the invention. In this instance, a select favorites board access menu 2610 can enable a user 150 to select a board 2615 (e.g., using the select board button 2617) to which a favorite lifestyle related article can be saved. After an article has been saved, the lifestyle management system 10 can display a confirmation message, and any favorite icon (e.g., favorite icon 2568) can be graphically altered (e.g., changed from an un-shaded symbol to a shaded symbol) to represent an updated status of the article.

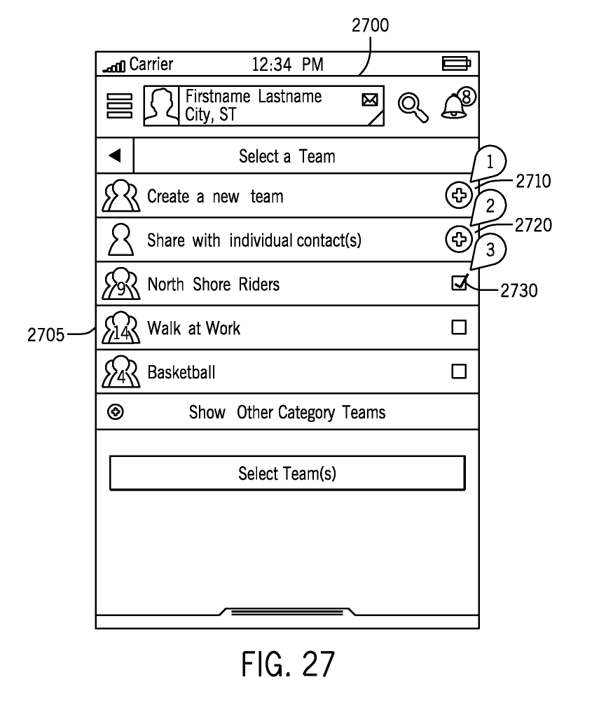

In some embodiments of the invention, the lifestyle management system 10 can enable a user 150 to create at least one team or group for sharing and communicating lifestyle information. Using this feature, a user 150 can select a team or group with which to share one or more articles and/or communications related to a lifestyle board or category. For example, FIG. 27 shows an example of an article team sharing display page 2700 according to one embodiment of the invention. In this example, a user 150 can create a new team or group of contacts using the access icon 2710, and can be provided with an option to share at least one article with individual contacts rather than an entire team or group using the access icon 2720. Further, a user 150 can select one or more teams by using a toggle 2730, within one or more teams 2705.

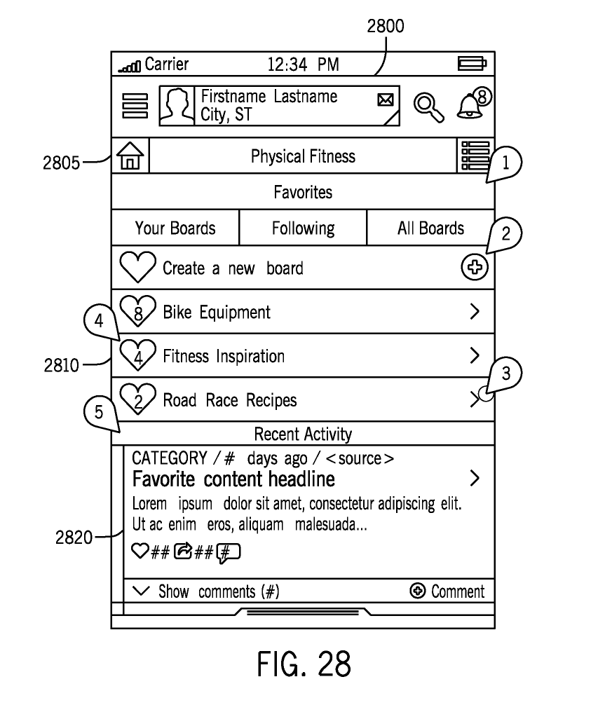

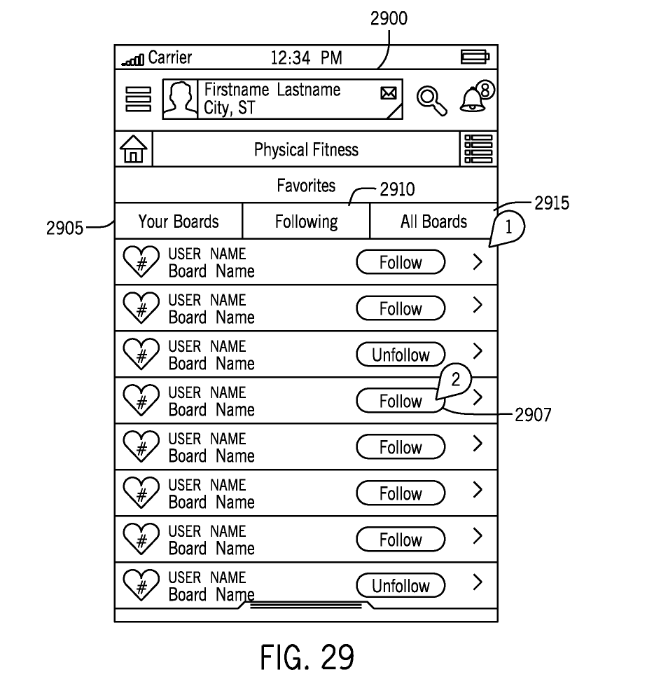

Some embodiments of the invention enable a user 150 to view one or more favorite boards. For example, FIG. 28 shows an example of a “Your Boards” view of a favorite boards display page 2800 according to one embodiment of the invention. This example illustrates a list of favorite boards 2810 for a current board or category 2805, and provides a window 2820 that can include a consolidate stream of the user's most recent favorite content items from all boards in the current board or category 2805. In some embodiments, the user 150 can follow one or more boards associated with any other followed users 150. Further, in some embodiments, the user 150 can review a list of all public boards created by users 150 associated with a current board or category (such as board or category 2805). For example, FIG. 29 shows one example of an “all boards” view display page 2900 which shows boards listed by a boards selection 2915 (all boards), with options to review favorite boards (selection 2910) and your boards (selection 2905), and follow and unfollow using one or more follow buttons 2907.

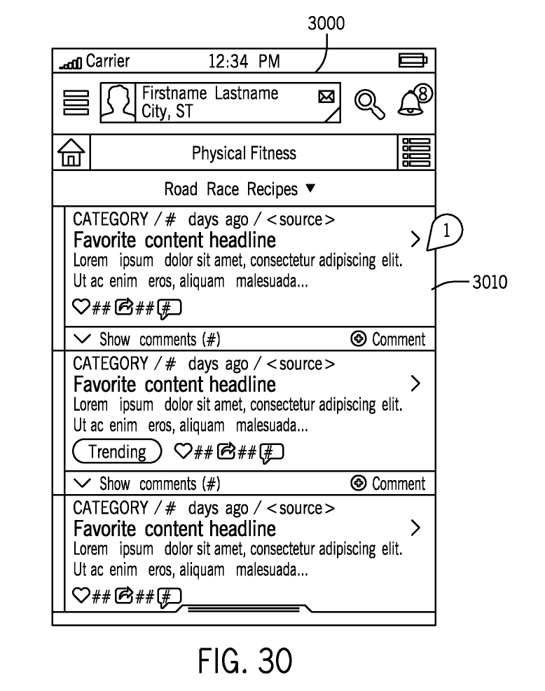

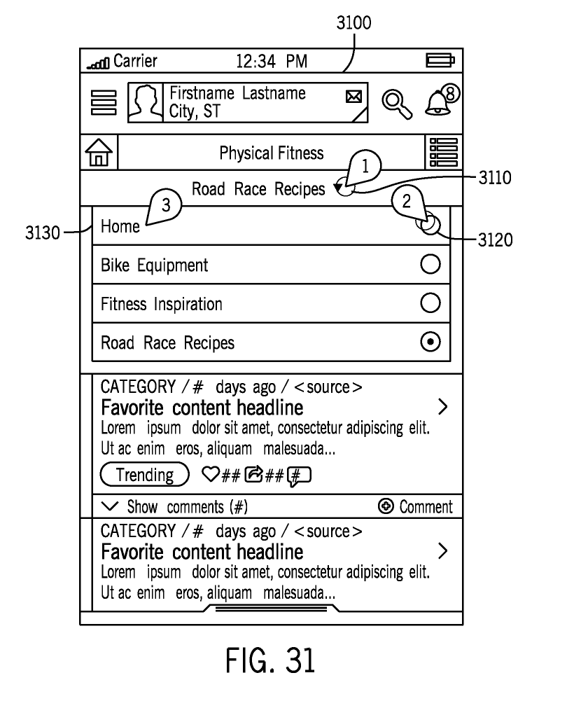

In some other embodiments, the user 150 can switch to a single board view, from which a user 150 can view favorite content items. For example, FIG. 30 shows an example of a single board view of favorite content items display page 3000 according to one embodiment of the invention. In this example, a display window 3010 provides a list of content items in a favorites board (which in some instances, can be the same as content items in a board or category stream). In some embodiments, the lifestyle management system 10 can provide various alternative methods to allow a user 150 to view different boards. For example, FIG. 31 illustrates a switch board menu display page 3100 that illustrates where a user 150 can access a change view icon 3110. A user 150 can select an item in the window menu 3120 to switch board views, while a home option 3130 can allow a user 150 to navigate back to a main favorites board view.

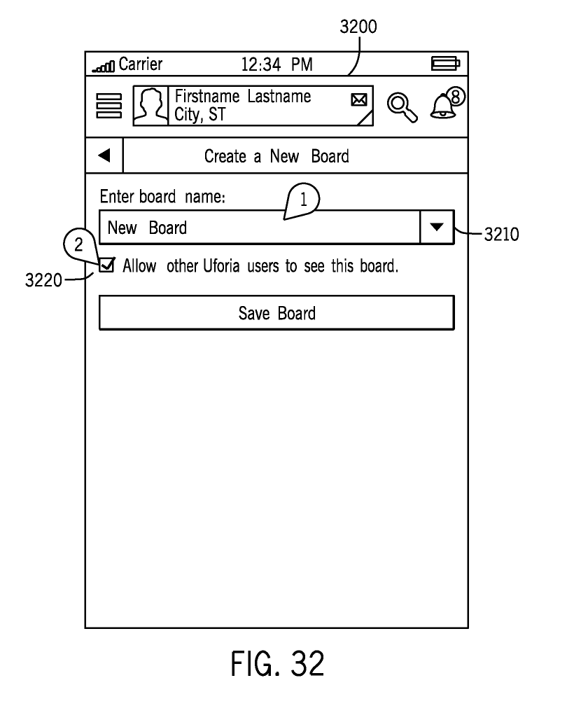

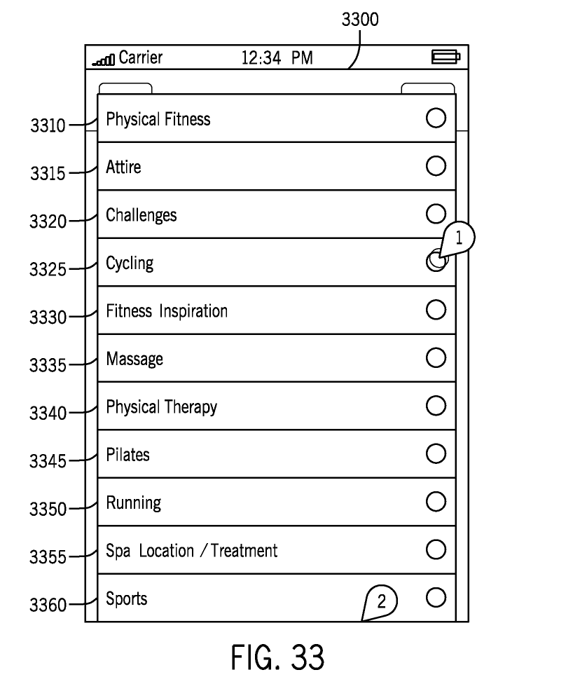

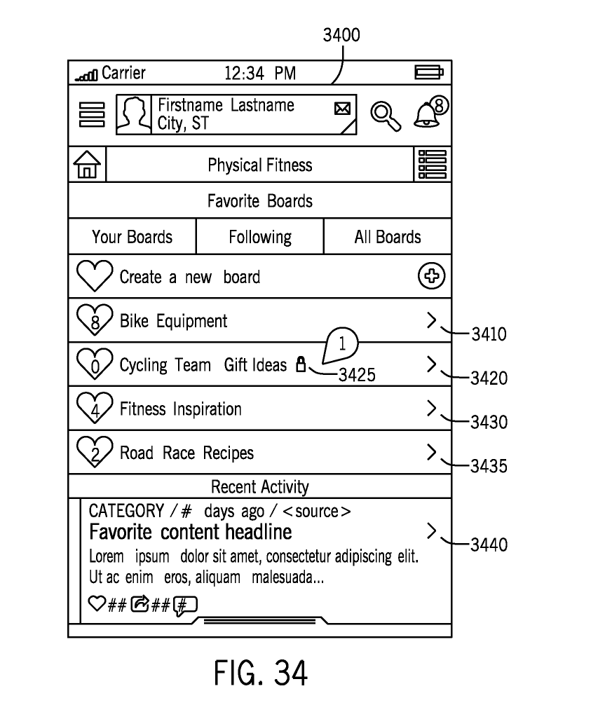

FIG. 32 illustrates a further example of a team creation display page 3200 according to one embodiment of the invention. In this instance, during a new board creation process, a user 150 can be presented with an option of a combination entry field for the board name, where a user 150 can either type any board name or tap a drop-down menu 3210 to show a list of suggested topics. Further, the lifestyle management system 10 can provide an option to assign a privacy level to the board by selecting toggle 3220, instructing the lifestyle management system 10 to hide or show the selected board to other users of the lifestyle management system 10. In some embodiments, if a user 150 selects the drop-down menu 3210, the lifestyle management system 10 can render a suggested topics list display page 3300 (FIG. 33). From this page, a user 150 can select one or more board or category names related to a lifestyle by selecting one or more boards or categories from a menu list comprising physical fitness 3310, attire 3315, challenges 3320, cycling 3325, fitness inspiration 3330, massage 3335, physical therapy 3340, pilates 3345, running 3350, spa location/treatment 3355, and sports 3360. Following the selection, the lifestyle management system 10 can display the one or more selection board names in a favorites view display page 3400 (e.g., see FIG. 34). In this instance, created board names 3410, 3420, 3430, 3435 are displayed, and can include a private icon 3425 when public viewing of the board is prohibited. In some embodiments, the favorites view display page 3400 can also include a recent activity view window 3440 showing one or more articles related to any board or category.

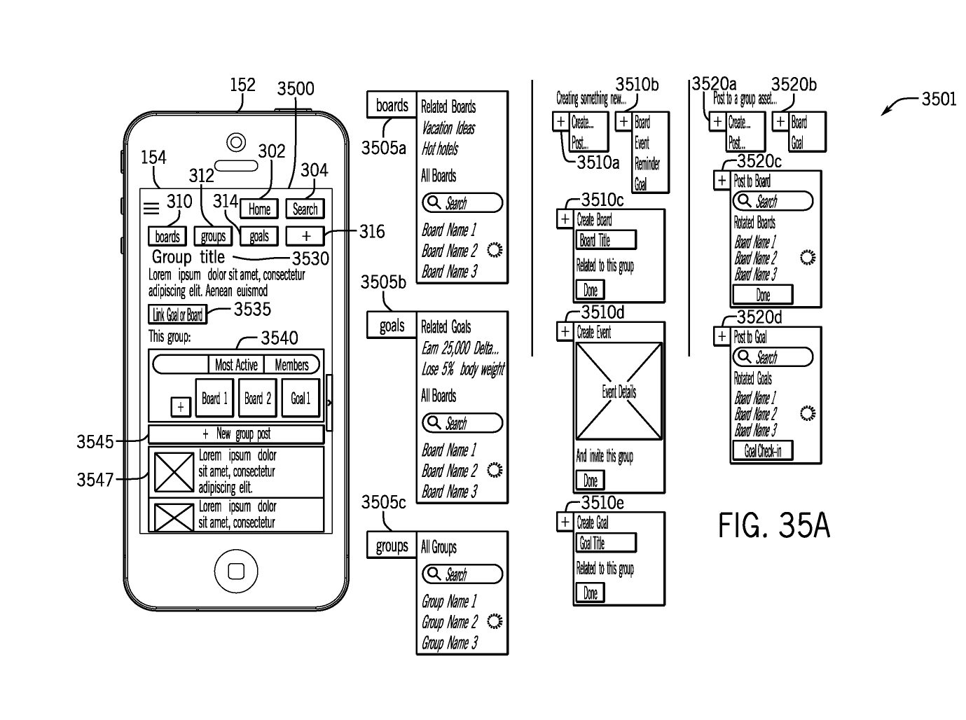

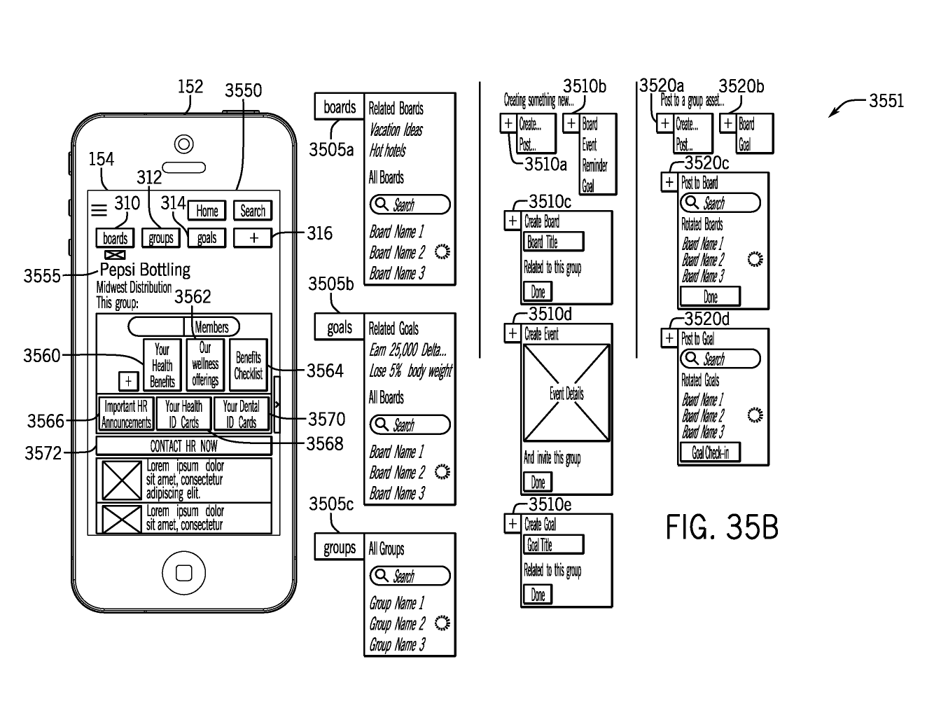

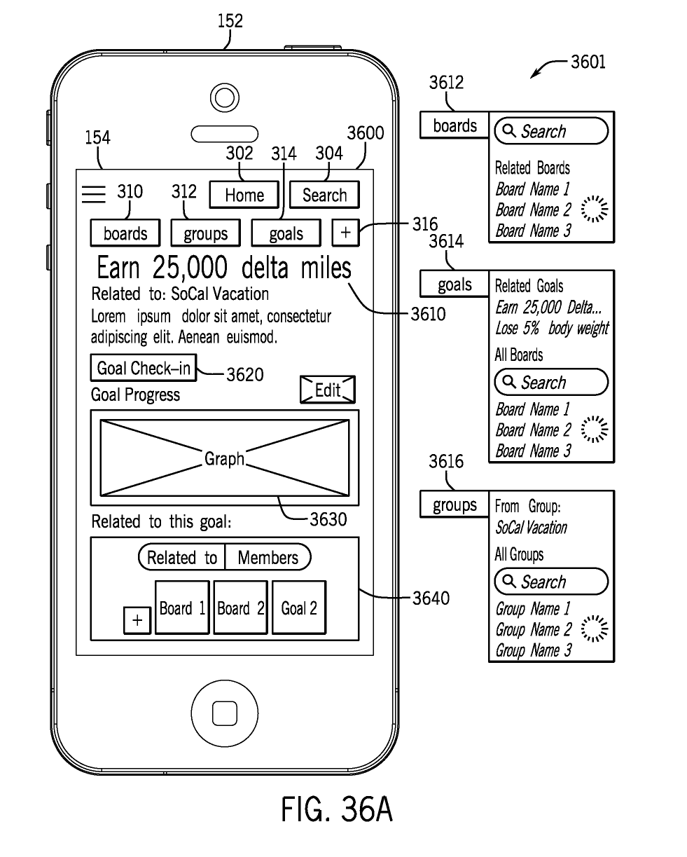

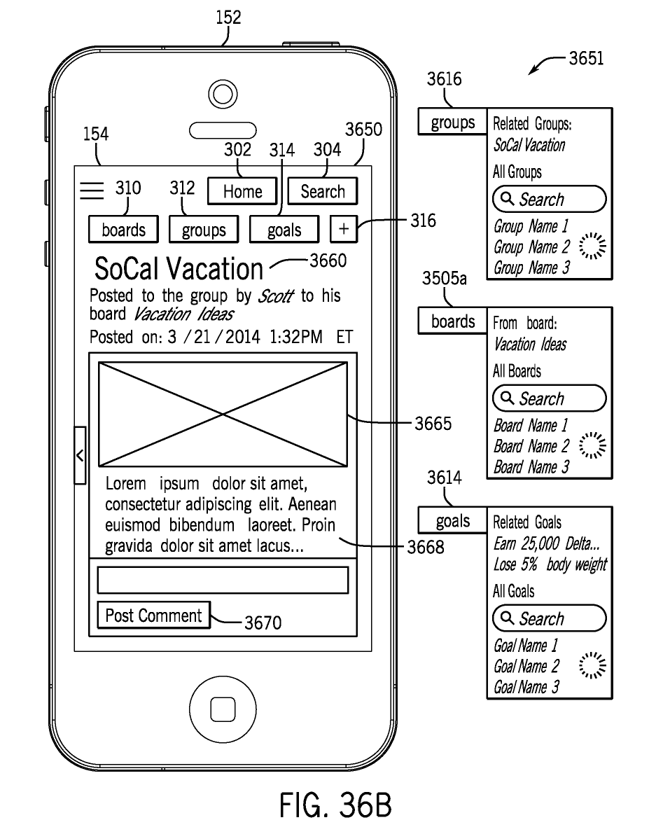

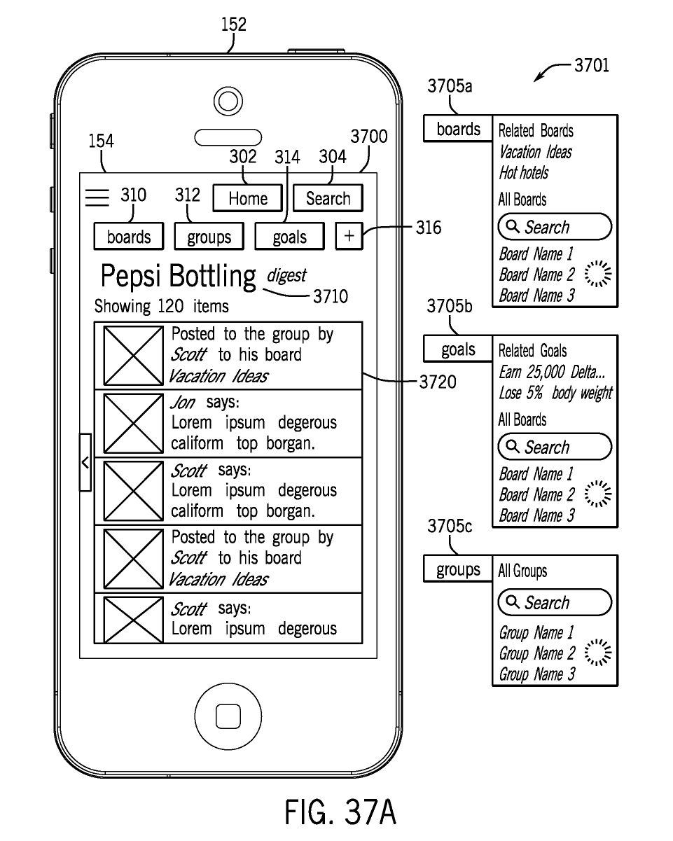

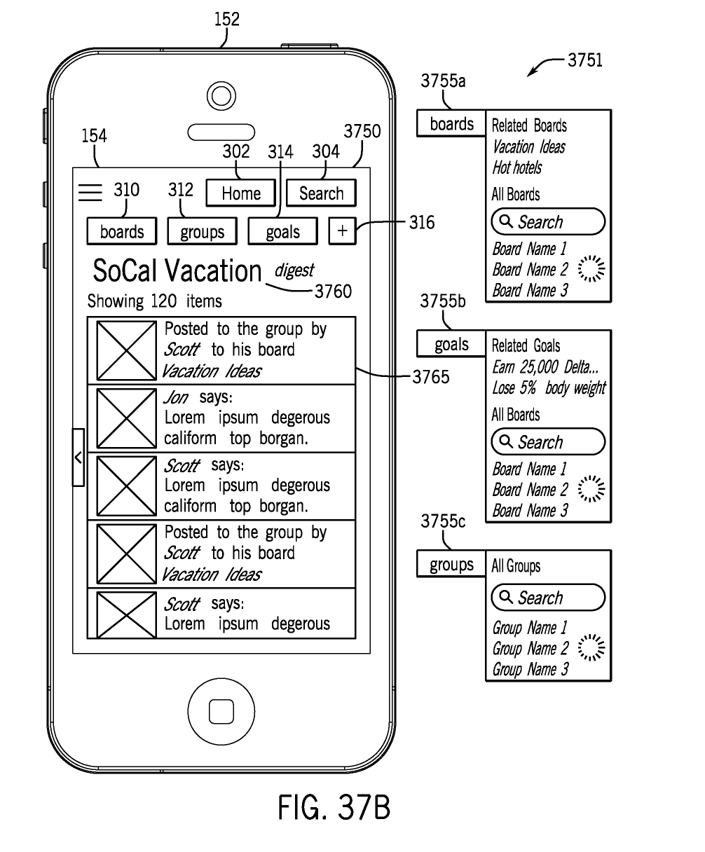

In some embodiments, the lifestyle management system 10 can process and display the dashboard that can comprise one or more functions related to a group or team. For example, FIGS. 35A-35B illustrate group detail view display pages 3500, 3550 including a plurality of potential window displays 3501, 3551 according to one embodiment of the invention. FIG. 36A illustrates a group detail view display page 3600 including a plurality of potential window displays 3601, and FIG. 36B illustrates a group content detail view display page 3650 including a plurality of potential window displays 3651 according to one embodiment of the invention. Further, FIGS. 37A-37B illustrate group digest view display pages 3700, 3750 including a plurality of potential window displays 3701, 3751 according to one embodiment of the invention. In some embodiments, the display pages 3500, 3550, 3600, 3650, 3700, 3750 can include one or more actionable icons including a boards icon 310 to enable a user 150 to access one or more boards, a groups icon 312 to enable a user 150 to access one or more groups, and a goals icon 314 to enable a user 150 to access one or more goals. The display pages 3500, 3550, 3600, 3650, 3700, 3750 can also include one or more control icons include a home icon 302, and at least one search icon 304. Further, the display pages 3500, 3550, 3600, 3650, 3700, 3750 can be updated, modified, or otherwise switched to display alternate windows using the “+” icon 316. For example, in some embodiments, the display page 3500 shown in FIG. 35B can include any one of the windows 3505a, 3505b, 3505c, 3510a, 3510b, 3510c, 3510d, 3510e, 3520a, 3520b, 3520c, and 3520d. In some embodiments, the display page 3550 can include any one of the alternate windows 3505a, 3505b, 3505c, 3510a, 3510b, 3510c, 3510d, 3510e, 3520a, 3520b, 3520c, and 3520d. In some embodiments, the display page 3600 shown in FIG. 36A can include any one of the alternate display windows 3612, 3614 and 3616. In some further embodiments, the display page 3650 shown in FIG. 36B can include any one of the alternate display windows 3616, 3505a, and 3614. In some other embodiments, the display page 3700 can include any one of the alternate display windows 3705a, 3705b, and 3705c. In other embodiments, the display window 3750 shown in FIG. 37B can display any one of the alternate display windows 3755a, 3755b, and 3755c.

Some embodiments of the lifestyle management system 10 can provide a dashboard style view related to any team or group created by the lifestyle management system 10, system administrator, or a user 150. For example, as shown in FIG. 35A, in some embodiments, the dashboard display page 3500 can comprise a group title 3530, and an action link 3535 to enable a user 150 to link any goal or board. A window 3540 can provide a user 150 with information and access to the content of any one board or goal, and a new group post action icon 3545 can be include to post a new group. Further, an information window 3547 can include an information stream related to content detail of any one board or goal. In the example shown in the display page 3550 of FIG. 35B, the aforementioned group title 3530 can comprise a title 3555 related to an employer. Within the aforementioned window 3540, the user 150 can be provided with access to one or more boards 3560, 3562, 3564, which in this example are related to health, personal well-being, and benefits provided by an employer, and other access icons 3568, 3570 to enable a user 150 to access medical and dental identification cards. Further, the display page 3550 can also provide links to other information related to human resources using icon 3566, and can provide a direct communication link 3572 to enable a user 150 to access human resources.

In some other embodiments, the lifestyle management system 10 can include goal related information within a dashboard display. For example, display page 3600 includes a goal 3610, from which a user 150 can check into the goal using an access icon 3620, showing progress towards the goal within a window 3630, and review a display 3640 of boards that are related to the goal 3610. The goal 3610 can be a private user created goal which they can participate in alone or with a vacation related team. As depicted in the display page 3650 in FIG. 36B, in some further embodiments, a user 150 can include details 3668 of a goal 3660 within a window 3665 of any posted goal, and can post a comment using an icon 3670. Further, as shown in FIG. 37A, the lifestyle management system 10 can provide a dashboard display page 3700 that can include a digest of an employer 3710 including a window 3720 showing a communication stream associated with one or more groups, goals or boards. Further, as shown in FIG. 37B, the lifestyle management system 10 can provide a dashboard display page 3750 that can include a digest of an goal 3760 including a window 3765 showing a communication stream associated with one or more groups, goals or boards linked to the goal 3760.

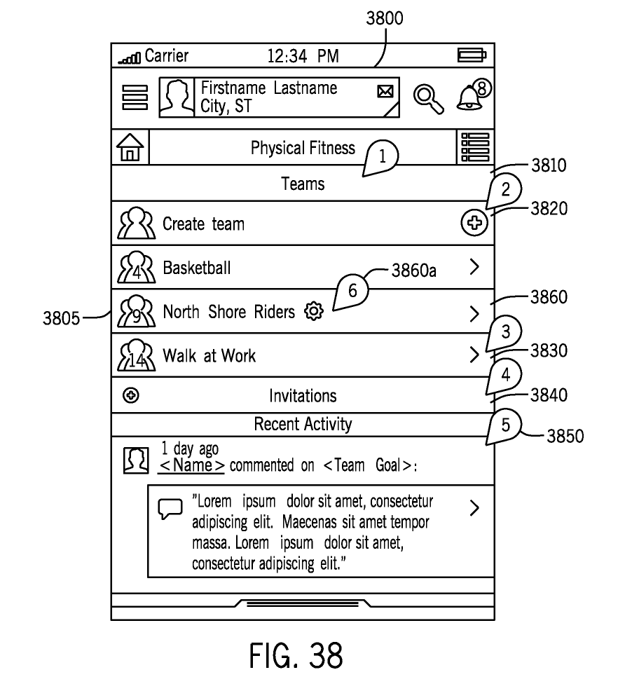

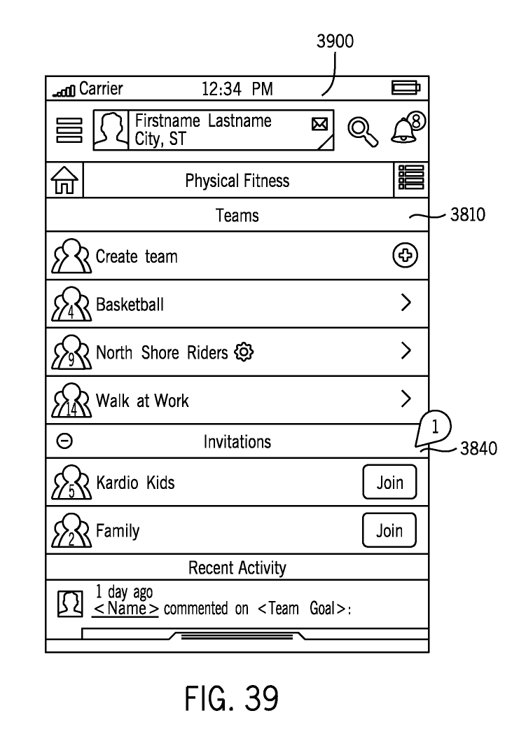

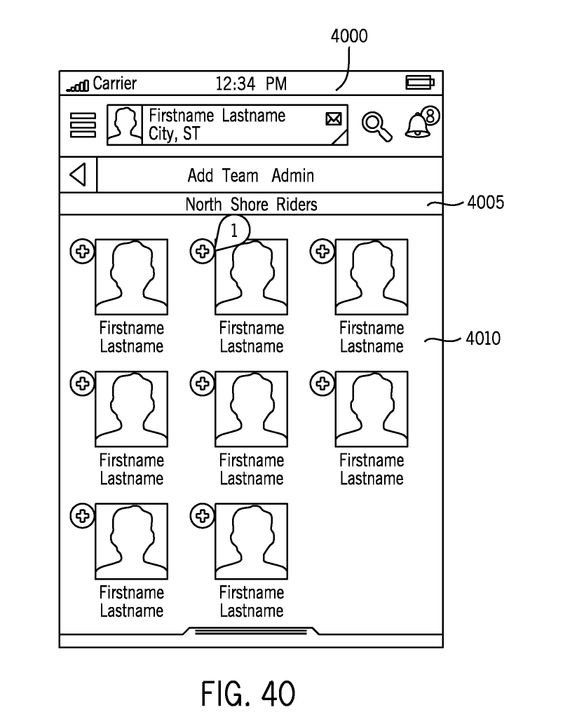

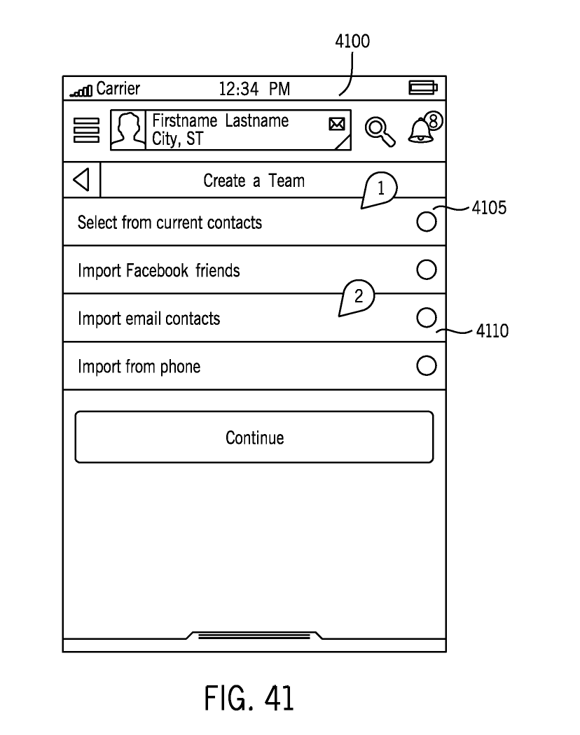

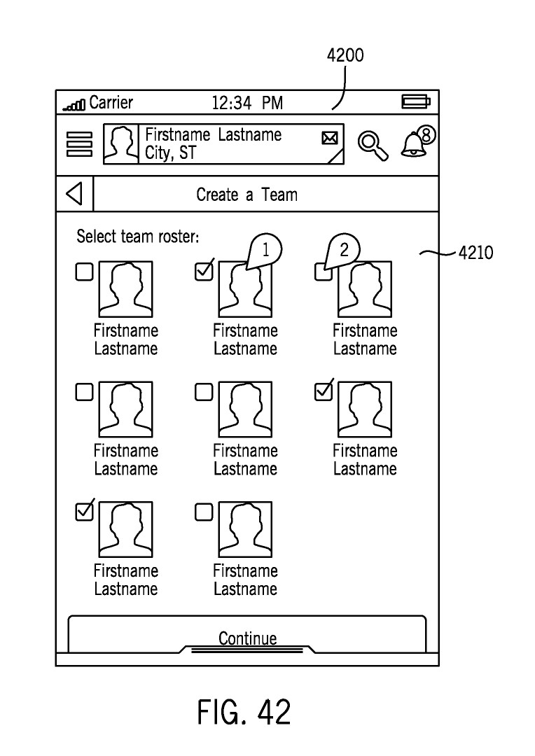

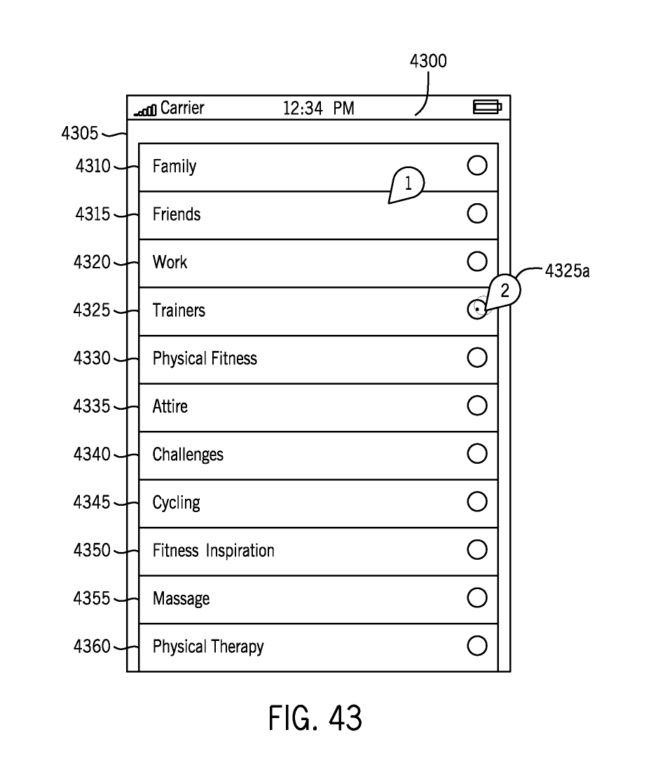

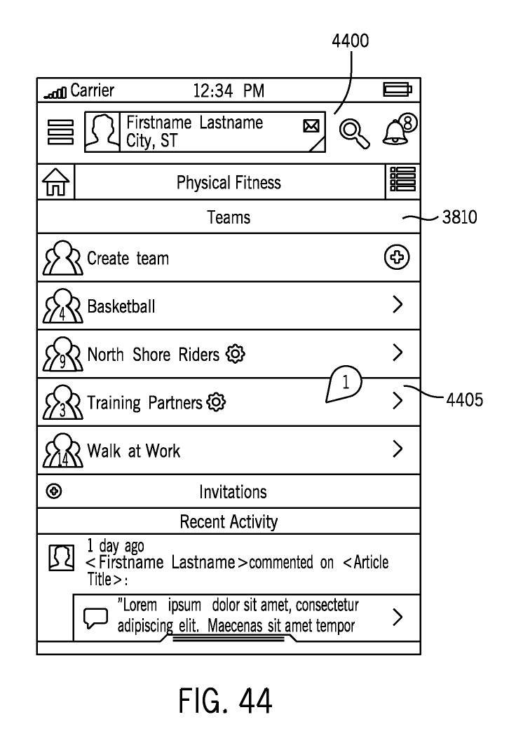

In some embodiments, the lifestyle management system 10 can process and display various team view displays to enable a user 150 to view and modify various information related to one or more teams or groups. For example, FIG. 38 shows one example of a team view display page 3800, FIG. 39 shows an example of a teams view display page 3900, and FIG. 40 shows one example of a teams view display page 4000. Further, FIG. 41 shows one example of a new team contacts creation display page 4100, FIG. 42 shows an example of a generic contact selection display page 4200, FIG. 43 shows a team name selection display page 4300, and FIG. 44 shows an update team list display page 4400 according to one embodiment of the invention. In some embodiments, using one or a combination of the displays 3800, 3900, 4000, 4100, 4200 and 4300, a user 150 can view teams associated with a current board or category, view information related to invitations, create a new team associated with a board or category and/or create a new team of contacts, and browse and assign a team name that can include common groups and board or category topics. Referring to FIG. 38, within the display page 3800, the teams content headline 3810 can change to match a current view within the display page 3800. In some embodiments, an action icon 3820 can be used to create a new team within the current board or category, and one or more action arrows 3830 can enable a user 150 to view the activity stream for any one team. Further, the display page 3800 can also include an invitations section 3840 (where FIG. 39 includes display page 3900 showing the invitation section 3840 revealed following selection), and a recent activity window 3850 where the lifestyle management system 10 can provide a consolidated activity stream for all teams in the selected board or category.

In some embodiments, the activity stream can include an activity feed of recent activity performed by members of a team (e.g., from any of the teams 3805). The feed can comprise a description of activities tagged to the team by one or more team members. Activities can comprise personal status updates, comments on team events and goals, content shares and event invitations, and can include a privacy setting to control distribution outside of the member's team. Further, an activity can include an avatar symbol associated with the user 150 performing the activity and/or a name link that can be used by a user 150 to view a public profile of the user 150 associated with the activity.

In some embodiments, one or more of the teams 3805 listed in the display page 3800 can include an administrator icon 3860a alerting a user 150 that the current user 150 is an administrator to the team 3860. Further, FIG. 40 shows one example of a team admin view display page 4000 according to one embodiment of the invention. For example, as illustrated, in some embodiments, one or more administrators 4010 can be selected for team 4005, providing the selected user 150 with administrative abilities for the team 4005. An administrator icon 3860a can be shown associated with any team when activated by a user 150 comprising an administrator. In some embodiments, the lifestyle management system 10 can enable a user 150 comprising an administrator to view all members of any current team, rename a team, and add and/or remove users 150 (i.e., members) from a team, and delete a team (e.g., such as team 4005).

Some embodiments include creating a new team of contacts. For example, as shown in FIG. 41, some embodiments can include a display page 4100 comprising a selection toggle 4105 for selecting a source of contacts to add to a team. In some embodiments, contacts not already with the lifestyle management system 10 can be added using one or more toggle options 4110 that can comprise one or more social media and networking platforms such as Facebook®. Further, in some embodiments, contacts can be added from the user's email and phone contacts. As shown in FIG. 42, in some embodiments, a display page 4200 can provide a user 150 with one or more contacts 4210 from which to select to include in one or more team rosters. Further, the lifestyle management system 10 can also provide a user 150 with an option to select a team name from a present list. For example, FIG. 43 shows a display page 4300 that comprises a list of preset team names that can be associated with a lifestyle related common groups and board or category topics from the display list 4305. In some embodiments, the groups and board or category topics from the display list 4305 can include family 4310, friends 4315, work 4320, trainers 4325, physical fitness 4330, attire 4335, challenges 4340, cycling 4345, fitness inspiration 4350, massage 4355 and physical therapy 4360. Using the display page 4300, a user 150 can browse the suggested team names, and select at least one to populate the activity name with the topic title. For example, by selecting the action toggle 4325a, the lifestyle management system 10 can provide an updated display page 4400 (shown in FIG. 44) including a teams content headline 3810 that includes an updated team list comprising training partners 4405.

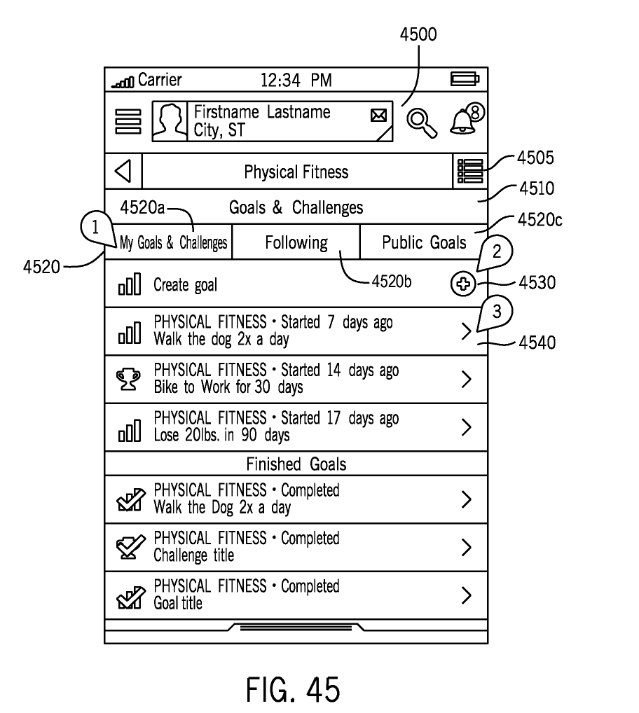

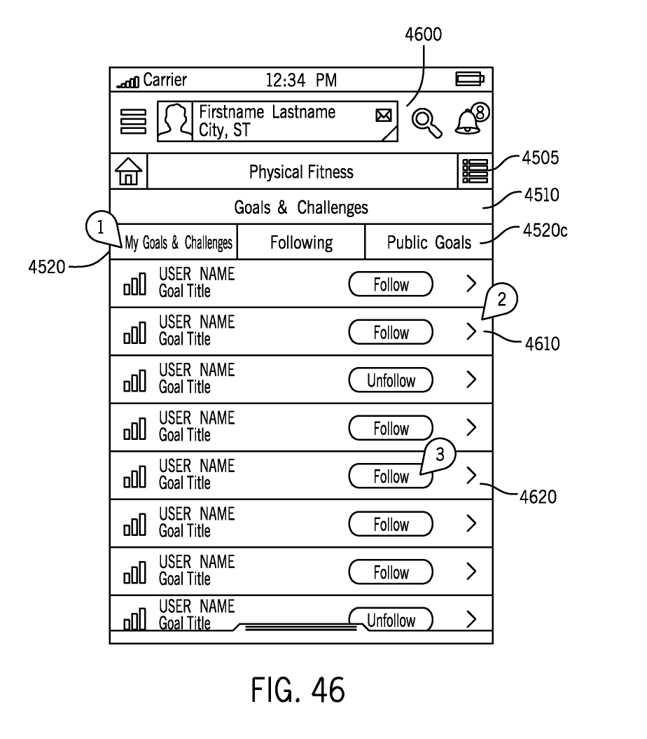

Some embodiments of the lifestyle management system 10 include processing and displaying information to a user 150 related to at least one goal or challenge. In some embodiments, this can include a user's personal goals or challenges related to his or her lifestyle. In some embodiments, the user 150 can create one or more goals and track progress towards one or more goals. For example, some embodiments can enable the user 150 to track goal progress graphically. In some further embodiments, some characteristics of the goal created by a user 150 can be edited to change or update the configuration of the goal. In other embodiments, team based goals can be created and tracked using the lifestyle management system 10. FIG. 45 shows one example of a goals and challenges display page 4500 according to one embodiment of the invention. In this example, the display page 4500 can display information related to goals and challenges for a board or category 4505. As shown, the display window goals and challenges 4510 can include at least one content tab 4520 including a my goals and challenges content 4520a, a following goals content 4520b, and a public goals content 4520c. The content tabs 4520a, 4520b, 4520c can enable a user 150 to view their personal goals and challenges, view examples of goals from other users 150 they may be following, and browse examples from all users 150. Further, the display page 4500 can also include a create goal toggle 4530 that can allow a user 150 to create a new goal, and an update action arrow 4540 that can enable a user 150 to view goal details and/or log an update. As shown in FIG. 46, illustrating an example display page 4600, action arrow 4610 can be used to enable a user 150 to view goal details and/or log an update from examples from all users 150. Further, one or more follow icons 4620 can be associated with one or more goals to enable a user 150 to click to follow or un-follow a goal.

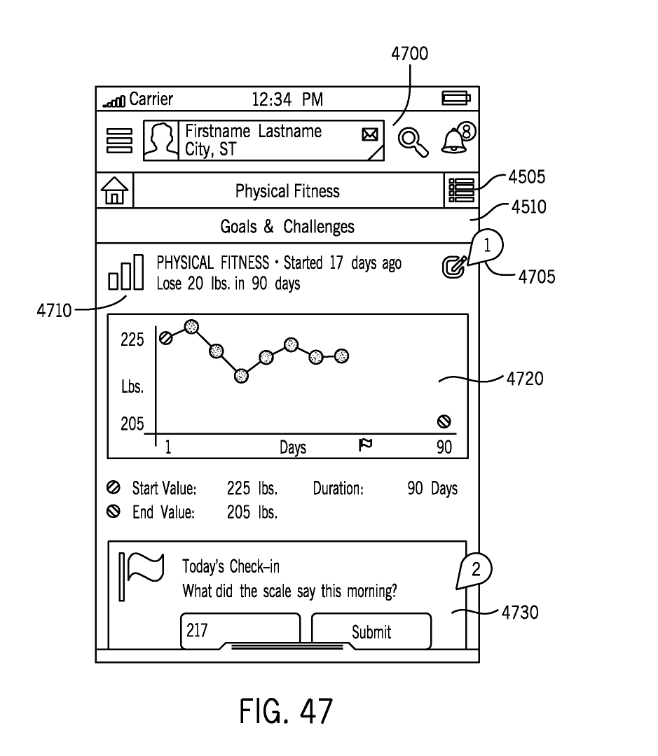

Some embodiments of the invention described herein can enable a user 150 (including an administrator), and/or a system administrator 135 to monitor any one goal or challenge, and the progress of any one or more goals and challenges can be tracked by one or more users 150 in some embodiments of the invention. For example, FIG. 47 shows one example of a goal detail progress display page 4700 according to one embodiment of the invention. In this example, a user's progress of a goal 4710 can be displayed as a progress chart 4720 which shows a user's weight loss over a period of time. The user 150 can edit the configuration of the goal 4710 at any time by accessing an edit icon 4705, and information used to track the progress towards the goal (in this example, the user's weight) using an information window 4730.

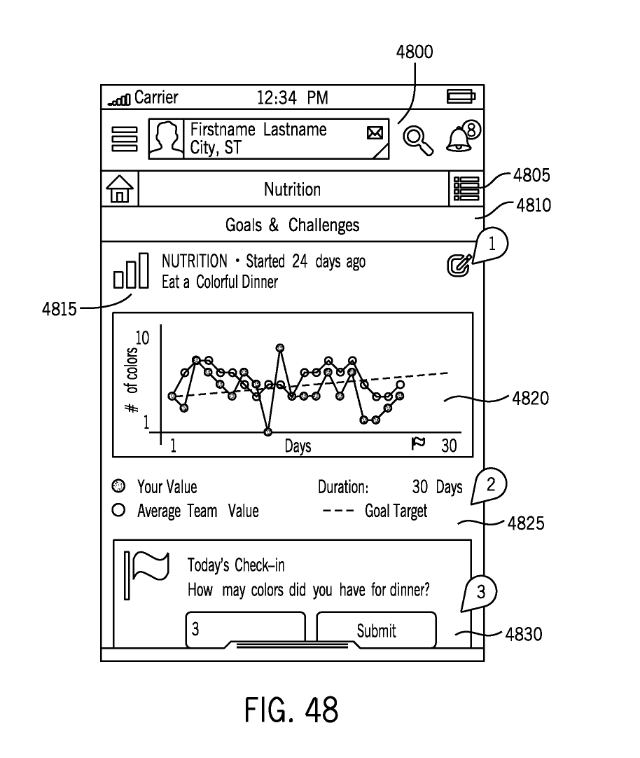

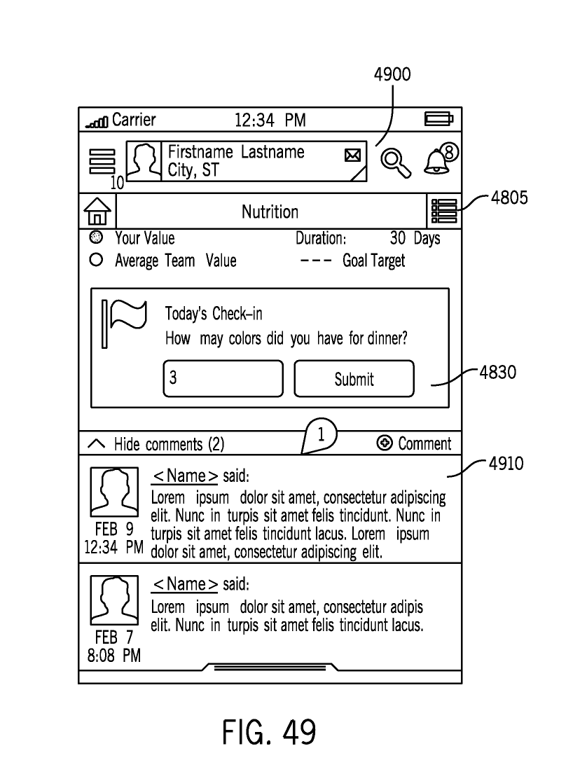

The progress of any one or more goals and challenges can be tracked by one or more other users 150 including those assigned to one or more teams. For example, FIGS. 48-49 illustrate examples of goal detail team share display pages 4800, 4900 according to one embodiment of the invention. In this example, goals and challenges 4810 for board or category 4805 can be displayed, and progress can be shared with the one or more users 150 and/or a team. For example, FIG. 48 shows a progress chart 4820 associated with a goal 4815. In some embodiments, within a region 4825, the display page 4800 can allow a user 150 to view details for other participants within a region 4825, and compare their progress against a goal target, with progress being recorded using the information window 4830. Further, as depicted in FIG. 49, illustrating the display page 4900, in some embodiments, comments and discussion can be added and viewed within the display window 4910.

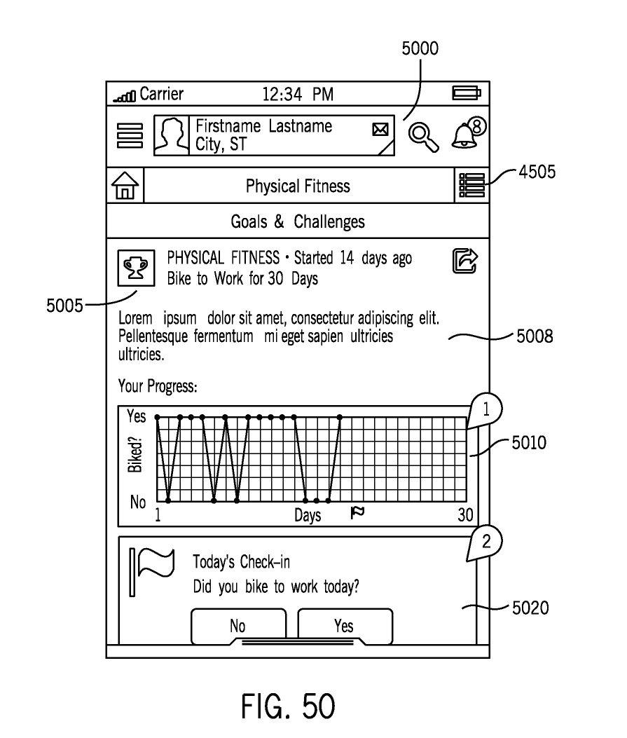

Some embodiments of the lifestyle management system 10 can provide a detailed view of any one goal or challenge. For example, FIG. 50 illustrates an example of a challenge detail view display page 5000 according to one embodiment of the invention. In this example, a goal or challenge detail 5008 is provided for a goal 5005. This information can serve to supplement the displayed progress including in the progress chart 5010, and can be updated by the lifestyle management system 10 utilizing goal progress information provided by the user 150 within the information window 5020.

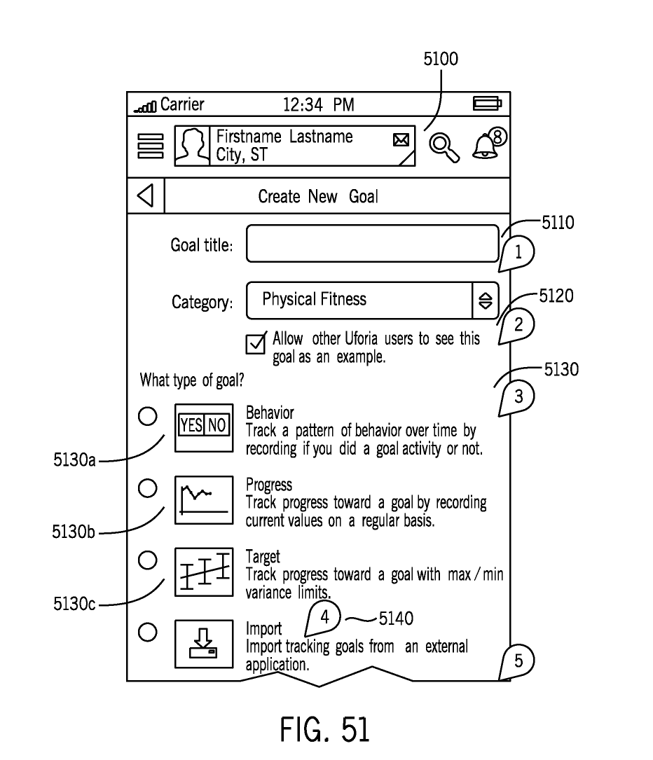

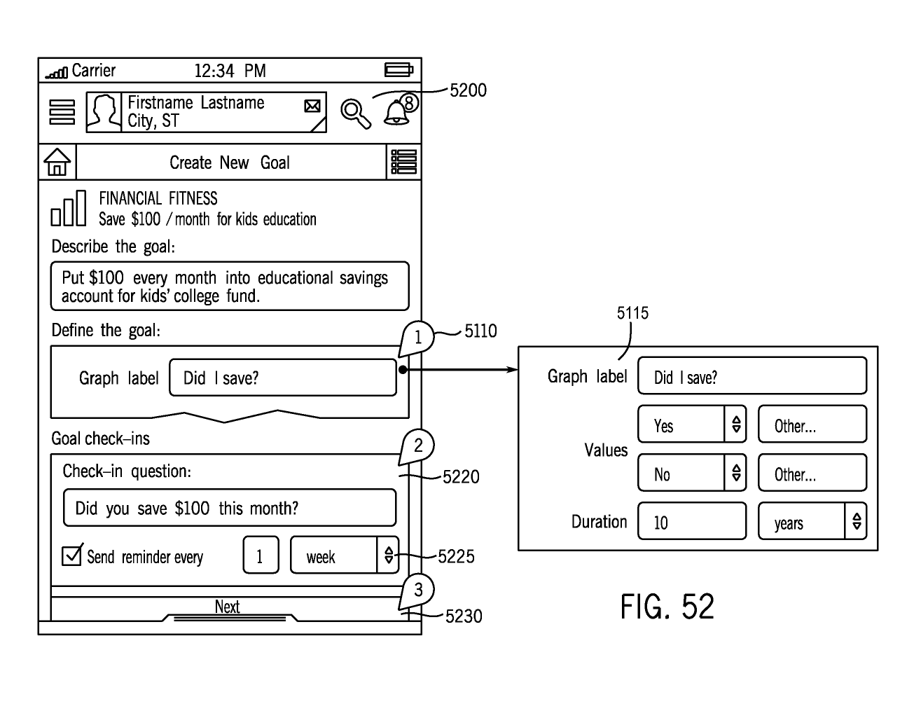

In some embodiments, a goal or challenge creation can be accomplished using a display page 5100 shown in FIG. 51 where a user can select a defined goal. In this example, a user 150 can enter a goal title 5110, and select a board or category from a default board or category list with the data field 5120. From a displayed list 5130, a user 150 can select a goal type, which determines the configuration shown in display page 5200 in FIG. 52. In some embodiments, the goal type can be selected from a behavior type 5130a, a progress type 5130b, and a target type 5130c. Moreover, an import option 5140 can be selected to import tracking goals from an external application. In some embodiments, the behavior type 5130a can track a pattern of behavior over time by recording whether or not a goal activity has been performed. In some further embodiments, the progress type 5130b can track progress towards a goal by recording current values on a regular basis. In some other embodiments, a target type 5130c can track progress towards a goal with maximum and minimum variance limits.

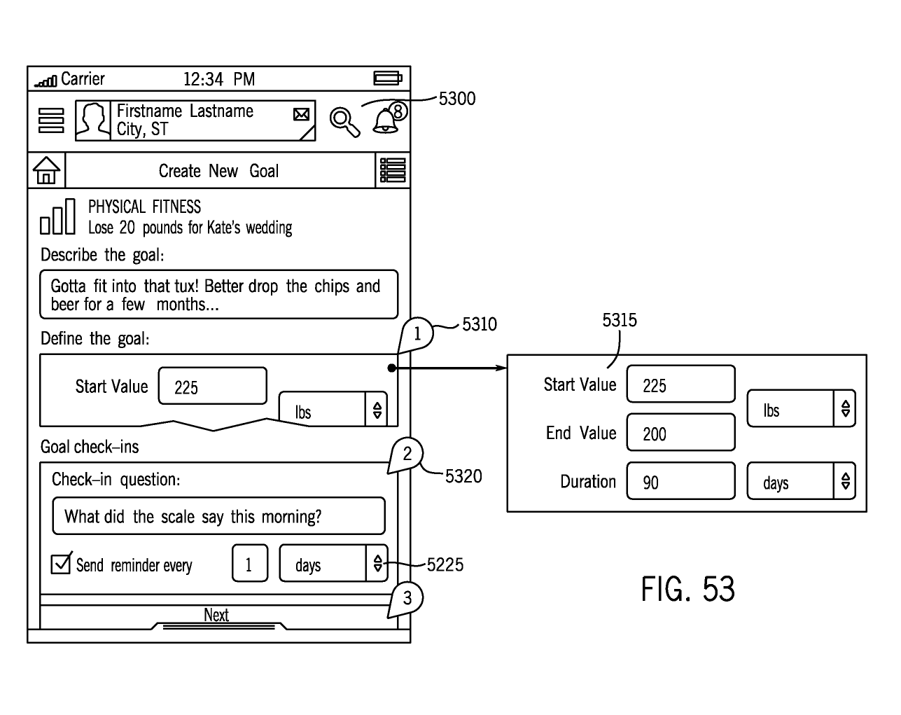

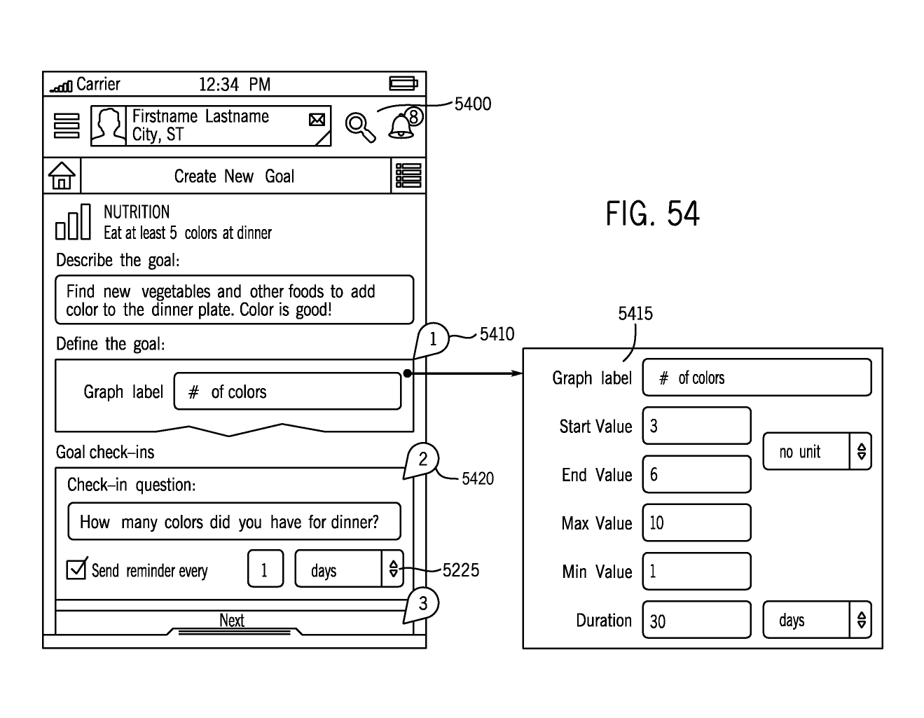

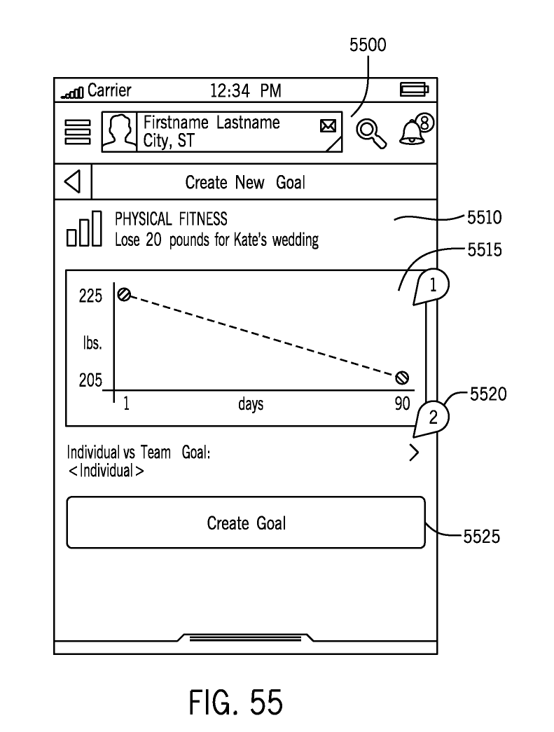

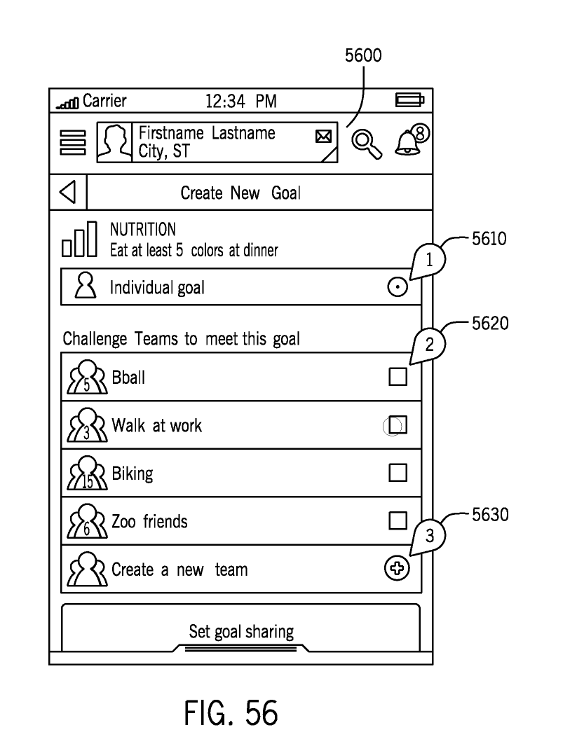

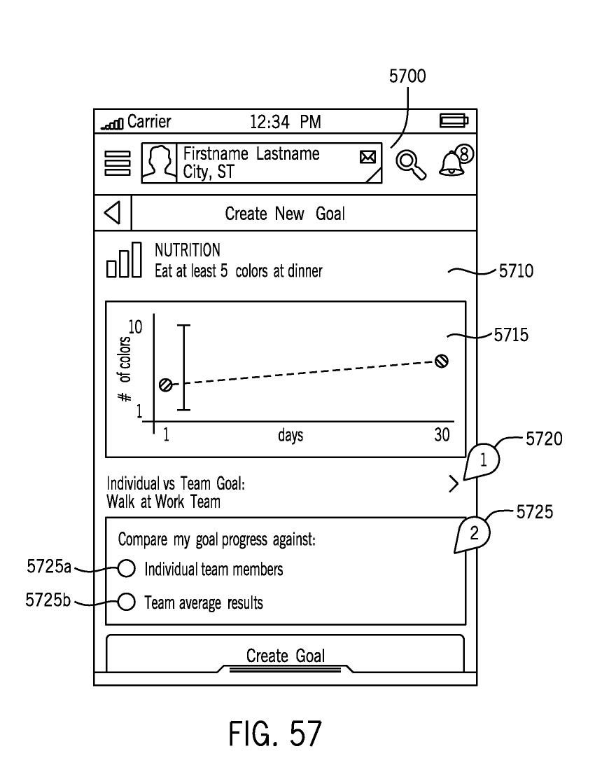

FIGS. 52-57 show examples of goal configuration display pages 5200, 5300, 5400, 5500, 5600, 5700 according to one embodiment of the invention. In some embodiments, depending on a selected goal type, display page 5200 shown in FIG. 52 can allow a user 150 to set configuration options (using data field 5110 and data entry window 5115), and set a progress tracking question. For example, as shown in the display page 5300 in FIG. 53, goal progress settings can be updated in data field 5310 with a selection from data entry window 5315, and the progress tracking question can be updated in the data field 5320 (in this example, relating to a check-in question concerning the user's weight as measured by a scale). FIG. 54 shows one example of a display page 5400 that can enable a user 150 to configure a goal tracking display (such as a goal target) using a data entry field 5410 and data window 5415. In this instance, information related to a target question can be entered into the data field 5420. In some embodiments, any one of the display pages 5200, 5300, 5400 can include an option field 5225 to set a reminder to a user 150 to update goal tracking information within a period set by the user 150. In some embodiments, a display page 5500 can be used by a user 150 to create a new goal (in this example goal 5510) that can include a goal progress tracking chart 5515. Further, a user 150 can use a setting toggle 5520 to switch between a individual goal (default) to a team goal, and/or create a goal using the button 5525. As shown in FIG. 56, in some embodiments, a display page 5600 can facilitate configuration of a team goal from an individual goal using the toggle 5610. In this instance, the display page 5600 can include a list of teams 5620 in which the user 150 is a member, and any one or more can be selected for sharing goal information. In some embodiments, new team toggle 5630 can enable a use to create a new team for the goal that can follow the team creation pattern. Using a display page 5700 (shown in FIG. 57), the lifestyle management system 10 can enable a user 150 to configure a team goal, and how to track progress towards the goal. In this example, a goal progress chart 5715 can be displayed representing progress towards the goal 5710. A user 150 can view individuals on the selected team within the team field 5720, and a goals progress comparison window 5725 can enable a user 150 to compare goal progress against an individual (by selecting toggle 5725a), or against team average results (by using the toggle 5725b).

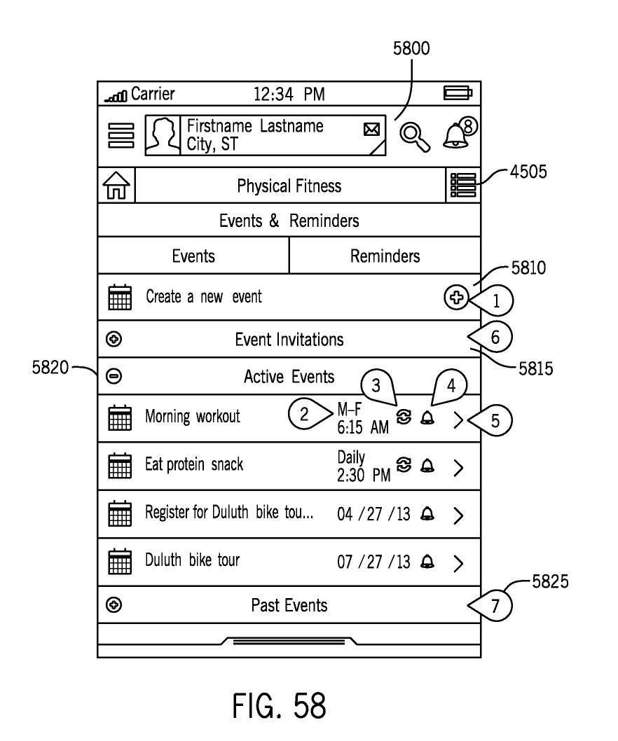

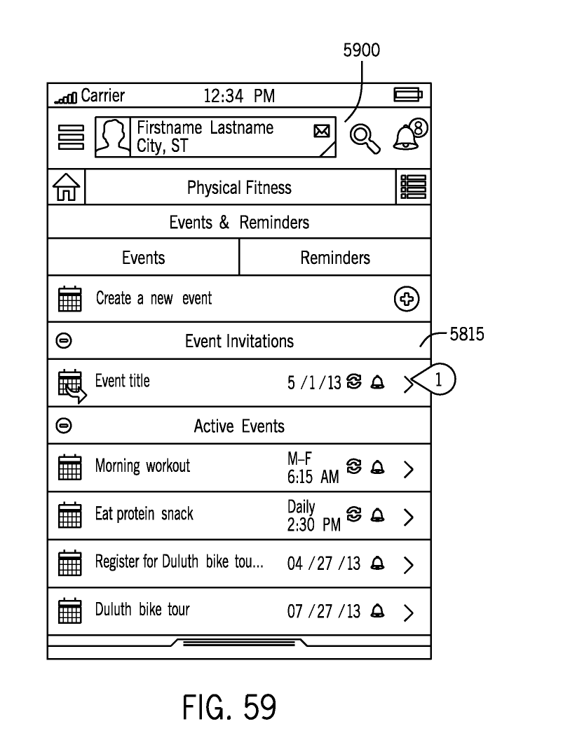

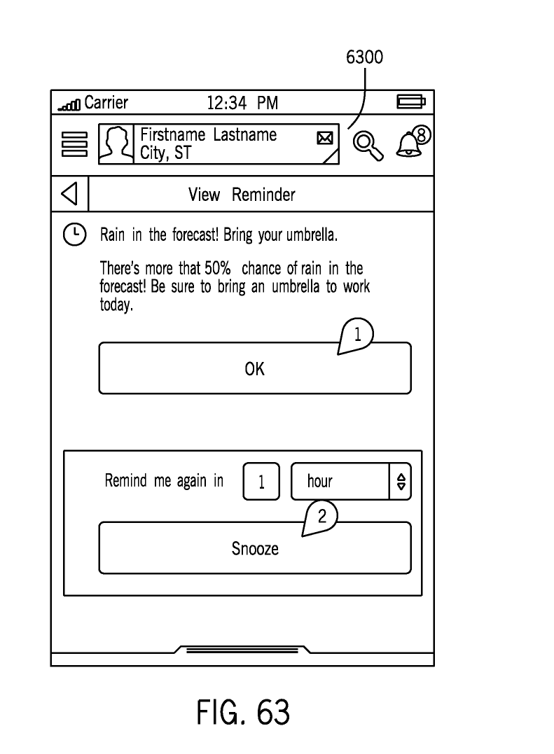

In some embodiments of the invention, the lifestyle management system 10 can display one or more events and reminders to a user 150, one or more of which can be associated with any one lifestyle content associated with one or more users 150. For example, FIG. 58 shows an example of an events view display page 5800 according to one embodiment of the invention. In this example, the display page 5800 can include pending, current and past events associated with a current board or category 4505. Using the action toggle 5810, a user 150 can be directed to another display page dedicated to new event creation. An events invitations field 5815 can enable a user 150 to review events created by other users 150 (show open in the display page 5900 in FIG. 59), and the active events section 5820 can include one or more active events that in some embodiments, can include event time and date, event repeat information, access to event detail, and event active reminder alert status. For example, FIG. 63 shows one example of an individual reminder view display page 6300 according to one embodiment of the invention. Further, a past events field 5825 can enable a user 150 to access a past events section that can include events that have already occurred.

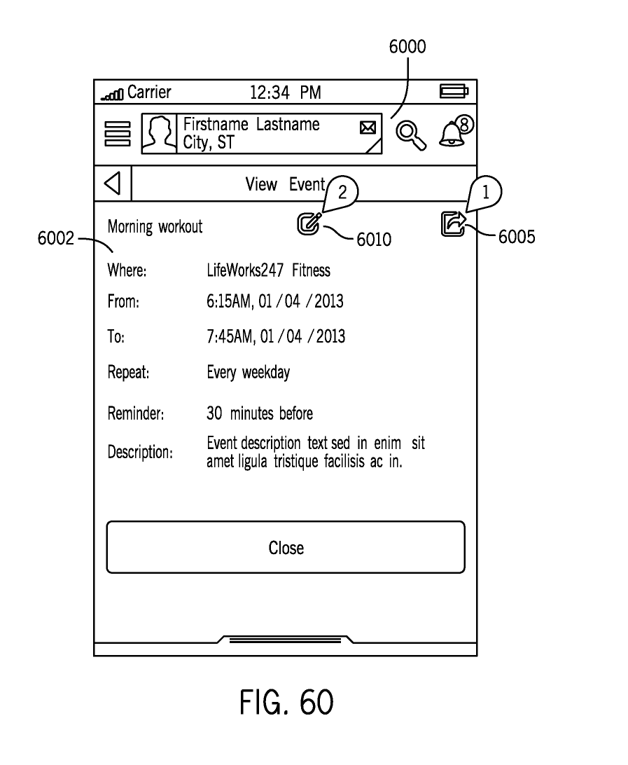

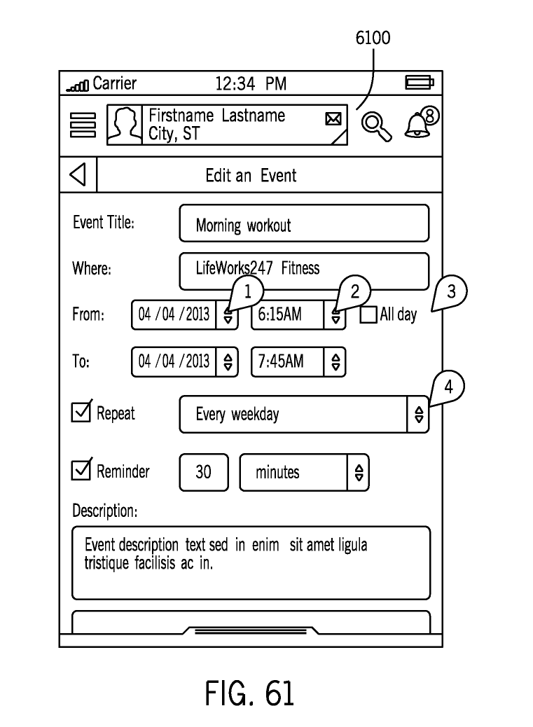

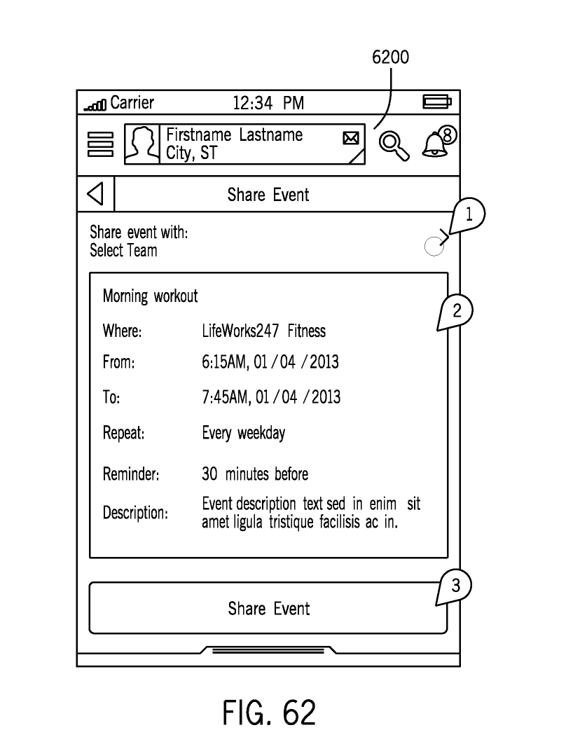

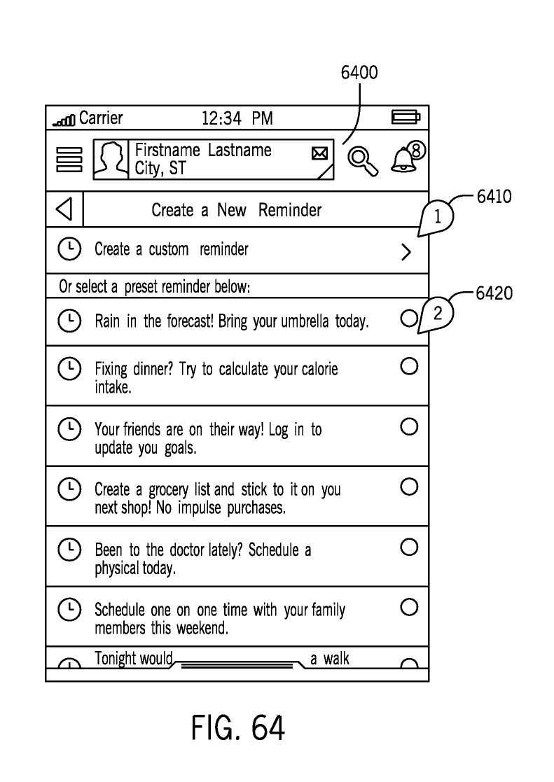

In some embodiments, the lifestyle management system 10 can display details of an event to a user 150. FIG. 60 shows one example of an event detail display page 6000 in which event detail is presented within an event window 6002. In this instance, a user 150 can use a share toggle 6005 to share the event with another user 150. For example, FIG. 62 illustrates an example of a share event view display page 6200 according to one embodiment of the invention. Further, using the edit toggle 6010, a user 150 can edit the event window 6002. For example, FIG. 61 illustrates an example of an edit existing event display page 6100 according to one embodiment of the invention. In this instance, a user 150 can edit one or more parameters associated with an event including the title, location, time and date, repetition, and set a reminder for the event. In some embodiments, new reminders can be created by a user 150, or can be based on predetermined values. For example, FIG. 64 shows one example of a create reminders view display page 6400 according to one embodiment of the invention. In this example, a data field 6410 can enable a user 150 to create a customer reminder, while window 6420 can provide a list of one or more preset reminders. In some other embodiments, the display page 6400 can be updated to enable a user 150 to view and modify an existing reminder. Further, in some embodiments, the lifestyle management system 10 can enable a user 150 to program a conditional reminder. In this instance, a user 150 can select from a predetermined list of causes for a reminder, and a predetermined list of actions triggered by a previous conditional statement.

In some embodiments of the invention, the lifestyle management system 10 can display one or more resource displays to a user 150. In some embodiments, resource displays can include recommendations for various tools and resources related to lifestyle board or category, topic, or content that can be vetted (i.e., reviewed, filtered and/or screened) by a user 150 and/or by the lifestyle management system 10 (using one or more predetermined rules). As described earlier, in some embodiments, lifestyle related information can be curated by a designated editor to provide more focused and relevant content to a user 150. In some embodiments, this can consist of an expert's input in a given life category or topic. This can also include which content is trending highest with users 150, and can include viewable comments on each from users 150. Further, this information resource can be represented in one or more boards, and searched by a user 150 (including a team member) using a keyword lookup function.

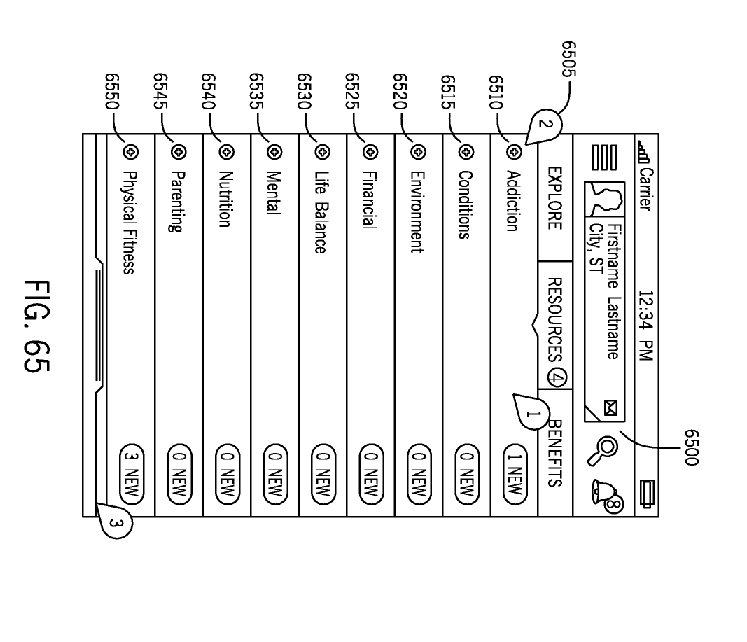

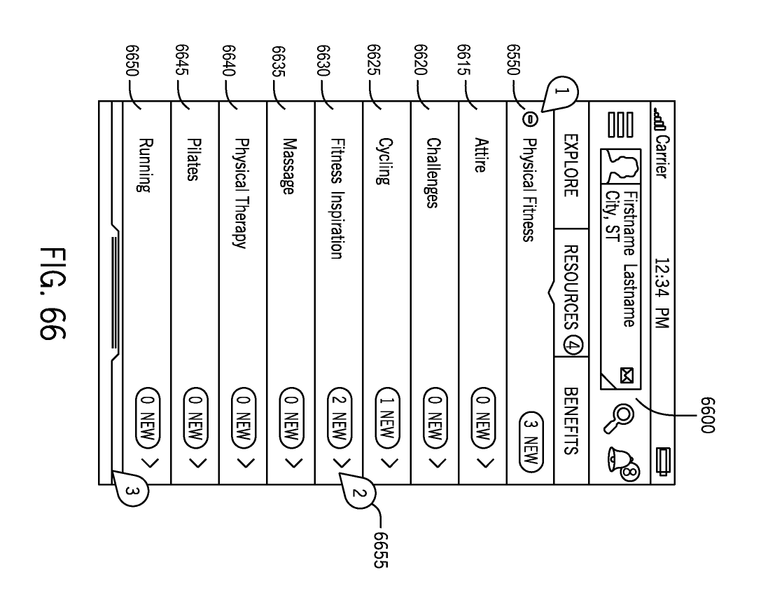

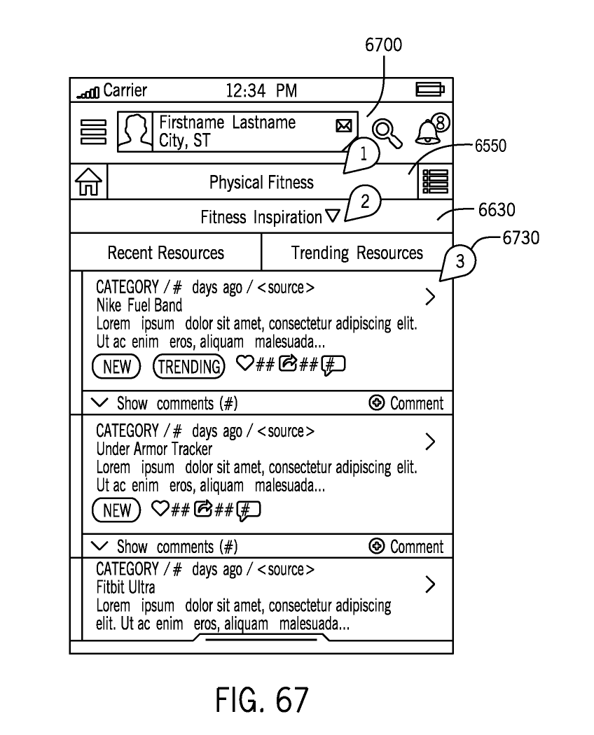

For example, FIG. 65 shows one example of a resources home screen display page 6500 according to one embodiment of the invention. In some embodiments, the display page 6500 can be preceded by the display of one or more information callouts to introduce the user 150 to resource content within the lifestyle management system 10. Subsequently, the lifestyle management system 10 can process the display page 6500 that can display boards or categories regardless of whether the user 150 has enabled the board or category. For example, the display page 6500 can include resource boards or categories comprising addiction 6510, conditions 6515, environment 6520, financial 6525, life balance 6530, mental 6535, nutrition 6540, parenting 6545, and physical fitness 6550. In some embodiments, the user 150 can select a sub-menu toggle 6505 within any board or category to open a list of sub-boards or categories. For example, FIG. 66 depicts a resources section display page 6600, including a list of sub-boards or categories following a user 150 access of the physical fitness 6550 board or category. In this instance, the list of sub-boards or categories can comprise attire 6615, challenges 6620, cycling 6625, fitness inspiration 6630, massage 6635, physical therapy 6640, pilates 6645, and running 6650. Further, by accessing any of the displayed access arrows (e.g., access arrow 6655), the lifestyle management system 10 can display a content list view to the user 150. For example, FIG. 67 shows one example of a single resource topic view display page 6700 showing example of a content list view 6730 displayed by the lifestyle management system 10 after a user 150 taps the access arrow 6655 for the fitness inspiration 6630 sub-board or category.

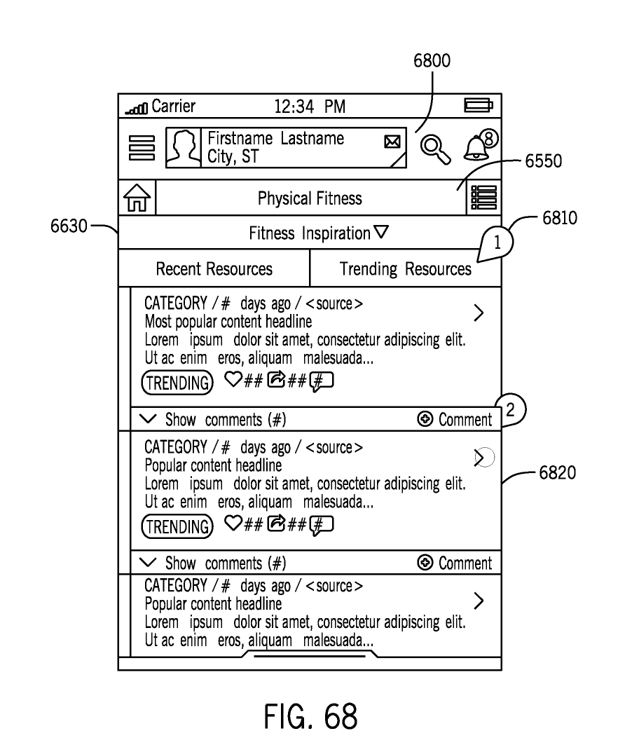

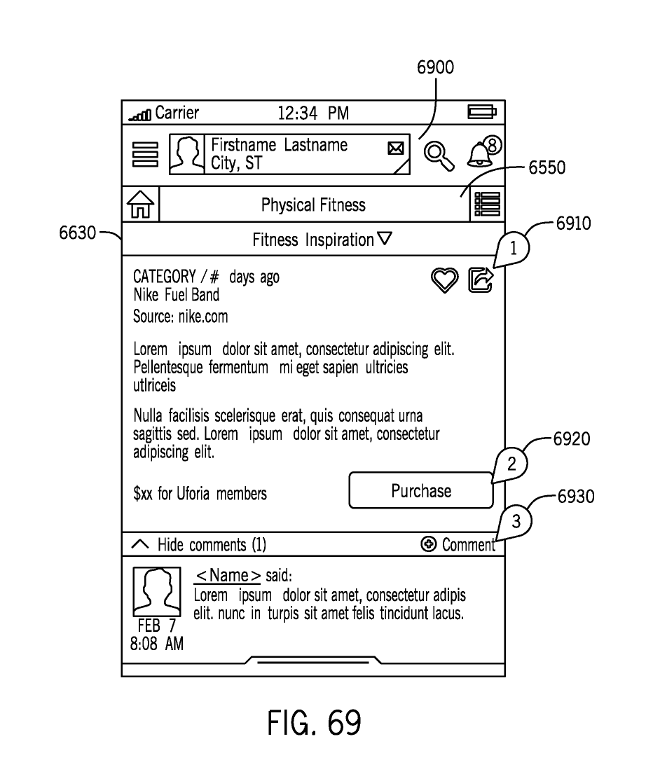

In some embodiments, trending content can be displayed within the content list by accessing the trending resources tab 6810 (see FIG. 68 showing an example of a trending content display page 6800) to allow a user 150 to view the most popular content. Further, in some embodiments, the user 150 can access full content of any one articles within the content display page 6800 by accessing a “more” arrow 6820. In addition, in some embodiments, a user 150 can be presented with an option to review an individual article prior to completing a purchase of the article. For example, FIG. 69 shows one example of a resource content item display page 6900 showing a article review window 6910 (in this example showing an individual article) that includes promotional content and a purchase button 6920, along with a comment functionality 6930 similar to previously described display pages.

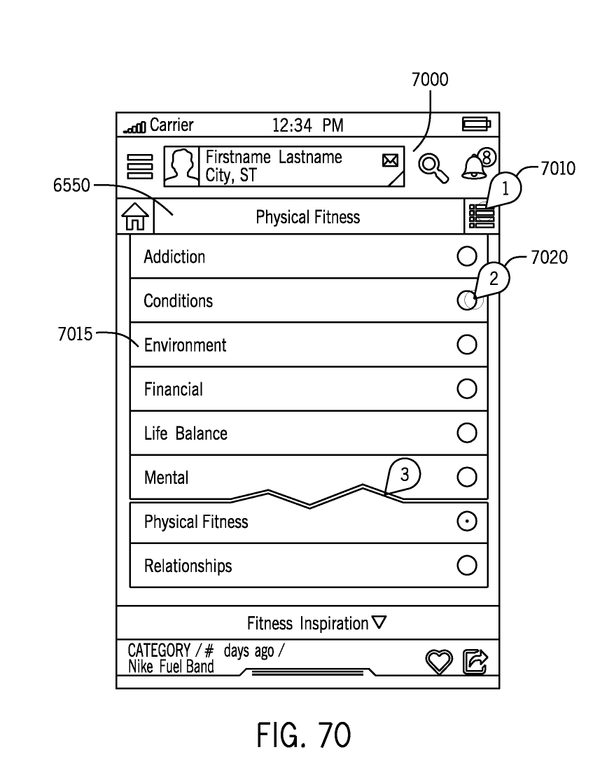

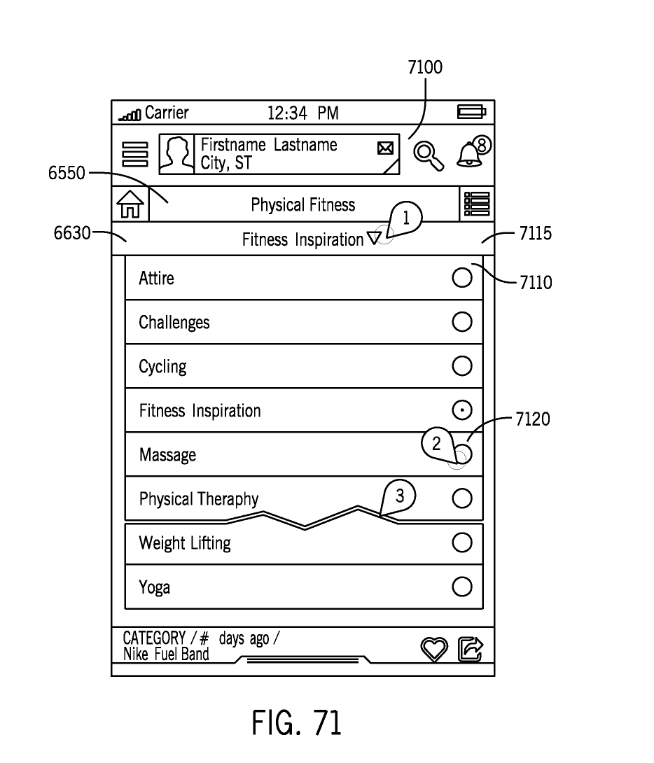

Some embodiments of the invention can enable a user 150 to control the display format and navigation of resource related topics within any one display page. For example, FIG. 70 depicts an example of a board or category change menu display page 7000 according to one embodiment of the invention. In this instance, the display page 7000 can include a change menu icon 7010 to allow a user 150 to open and close menu items. Further, any one of the any board or category option within the list 7015 can include a select and activation toggle 7020 to enable a user 150 to switch views and expand content details of any one board or category. FIG. 71 provides a further example of a display page comprising various action icons to enable a user 150 to change and update a view comprising a single resource topic. For example, as shown, the change topic display page 7100 can include a toggle arrow 7115 that a user 150 can tap to unfold a selection accordion 7110, and provides an option to a user 150 to switch menu views within the display page 7100 using an action toggle 7120.

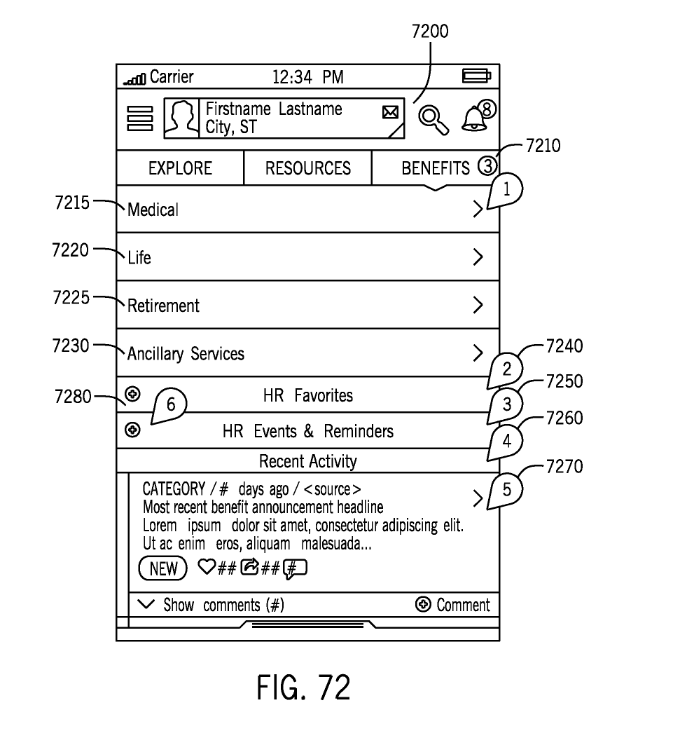

In some embodiments, the lifestyle management system 10 can comprise methods to process and display lifestyle content comprising employee benefits and/or associated human resources information provided by an employer to one or more users 150 comprising at least one employee of at least one employer providing the benefits. As discussed earlier with respect to FIGS. 12A-12B, links to common lifestyle content areas of the lifestyle management system 10 can be provided to enable a user 150 substantially direct access content selections related to personal well-being and financial benefits (including for example benefits 1270b, retirement 1270c, and ancillary services 1270d). In some further embodiments, the lifestyle management system 10 can display one or more display pages substantially dedicated to benefits related lifestyle content. For example, FIGS. 72-77 show examples of benefits view display pages 7200, 7300, 7400, 7500, 7600, 7700 according to one embodiment of the invention. As shown in FIG. 72, the display page 7200 can comprise a benefits home screen that comprises human resources provided benefit information that can include at least one announcement. In some embodiments, a benefits tab 7210 can be populated with one or more benefit related menus comprising at least a medical menu 7215, life menu 7220, retirement menu 7225, and an ancillary services menu 7230. Further, the display page 7200 can also include human resources content that can be accessed and updated by a user 150 comprising an administrator. For example, in some embodiments, the display page 7200 can include a human resources favorites section 7240 that comprises a section of content items where administrators (i.e. users 150 that have administrative privileges) can post favorite announcements or updates. Some embodiments also comprise a human resources events and reminders section 7250 that can provide upcoming calendar items related to benefit activity. The display page 7200 can also include a recent activity section 7260 that can comprise an information window 7270 that can comprise one or more human resources and/or benefits announcements. In some embodiments, a user 150 can open and close information window 7270 by tapping on the recent activity header 7260. Similarly, any one of the medical menu 7215, life menu 7220, retirement menu 7225, and an ancillary services menu 7230 can be expanded by a user 150 to provide updated content and related information.

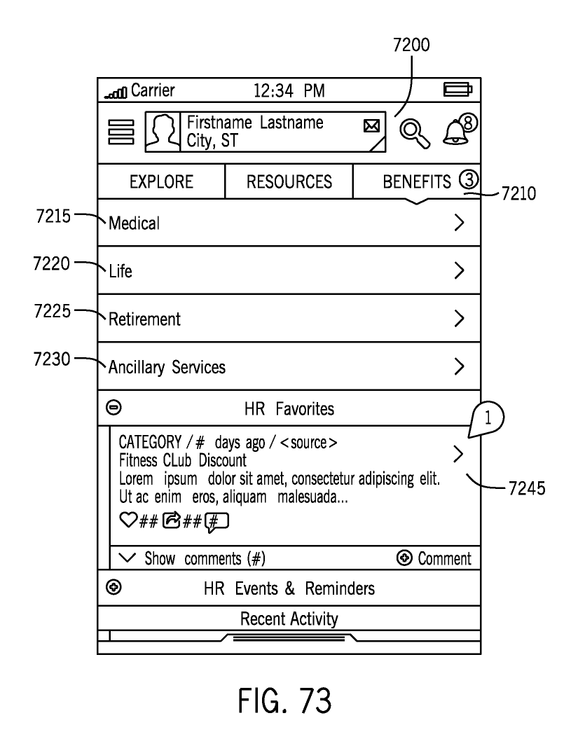

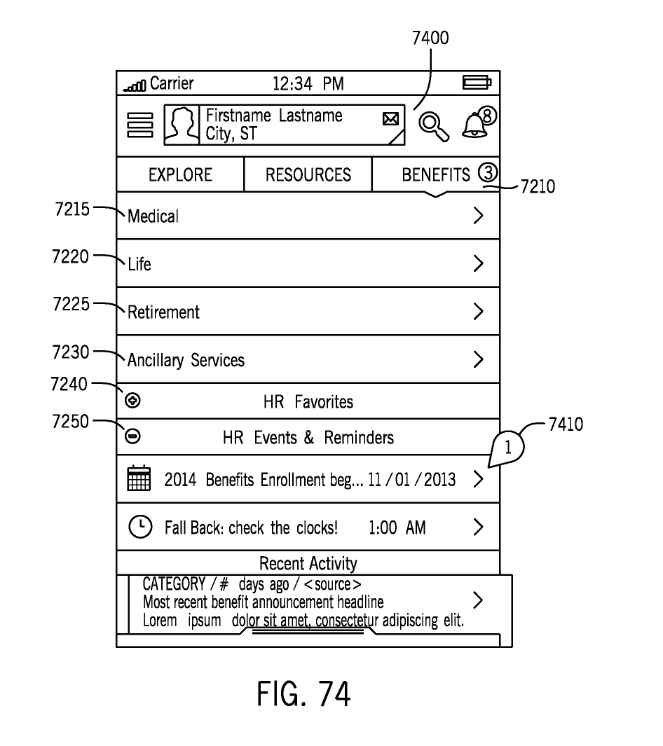

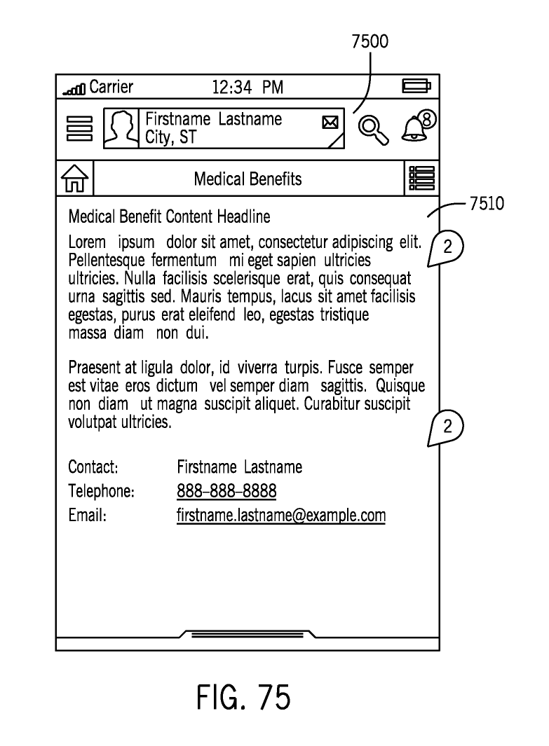

In some embodiments, the lifestyle management system 10 can provide methods and processes for updating, posting, or positioning of information for view by a user 150 by another user 150 comprising an administrator. For example, in some embodiments, information (such as the information within window 7245 in the display page 7300 of FIG. 73) can be “pinned” to a board including a user's favorites board. In some other embodiments, event and reminder events can be created for a user 150 by another user 150 comprising an administrator. For example, FIG. 74 shows a display page 7400 that includes a human resources events and reminders section 7250 that can provide upcoming calendar items related to benefit activity in the form of an event reminder 7410. In some other embodiments, the lifestyle management system 10 can enable a user 150 to access organization-specific benefits information accessible by the user of the application. For example, FIG. 75 illustrates a display page 7500 that includes a medical benefits detail window 7510 that can comprise specific benefits information which can include contact information to enable a user 150 to research additional information from an employer.

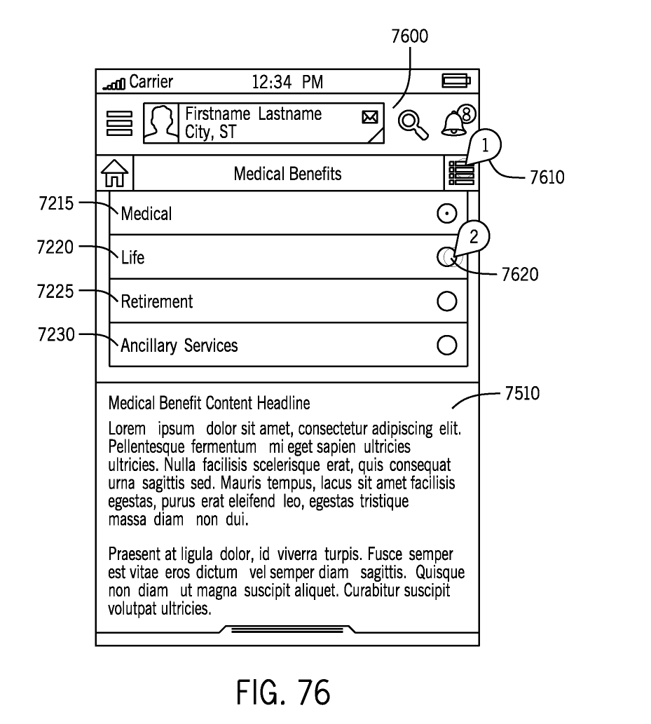

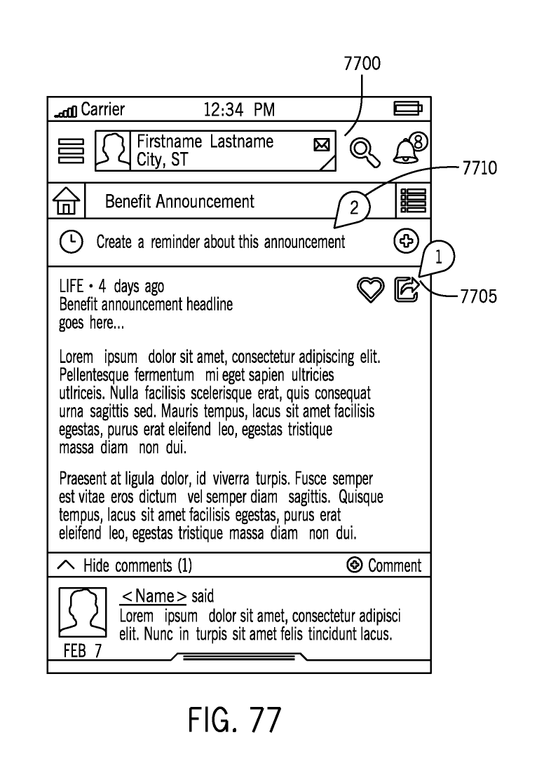

Some embodiments of the invention can include the lifestyle management system 10 processing and displaying benefits related information to a user 150 from another user 150 comprising an administrator with one or more options to access various portions of the benefits related information. For example, FIG. 76 shows a benefits change menu icon 7610 that can allow a user 150 to switch between general benefits information sections without the need to access the home screen (e.g., FIG. 72, the display page 7200 can comprise a benefits home screen). Further, as shown, any one of the medical menu 7215, life menu 7220, retirement menu 7225, and an ancillary services menu 7230 can comprises an action toggle 7620 that a user 150 can tap to switch views (e.g., to expand the content of the menu). In some further embodiments, a user 150 can be provided with options to favorite and share one or more benefits related content with other users 150. For example, as illustrated in the display page 7700 in FIG. 77, a user 150 can activate a create reminder option 7710 to initiate a reminder functionality for an announcement window 7705.

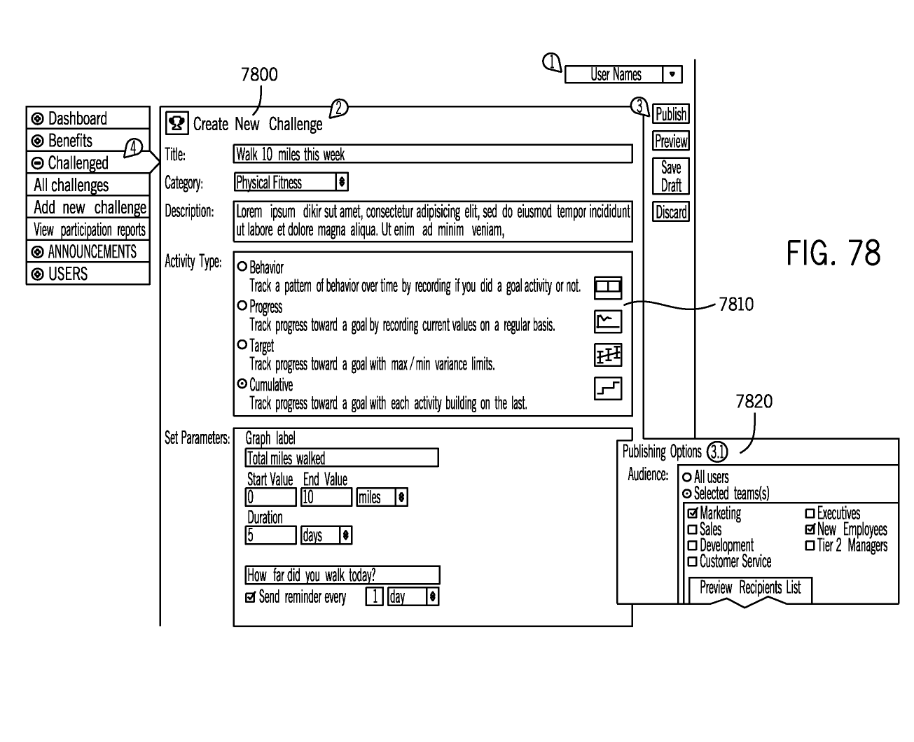

Some embodiments of the invention can enable an administrator (such as an employer benefits administrator) to create and publish content for one or more users 150 of the lifestyle management system 10. For example, in some embodiments, a user 150 comprising an employer administrator (i.e. such as a human resources administrator 40f) can create and publish content for one or more users 150 of the lifestyle management system 10 that can comprise employees of the employer. For example, FIGS. 78-80 illustrate administrator display pages for creating and publishing content according to one embodiment of the invention. In this instance, the user 150 comprising the employer administrator can manage one or more features of the lifestyle management system 10. For example, in some embodiments, the employer administrator can manage login access. In some embodiments, the employer administrator can issue invitations to new employee users, create benefits categories and detailed benefits information, and create human resources events. In other embodiments, the employer administrator can view analytics reports (including any specific to the relevant employer group). For example, in some embodiments, the employer administrator can review and compile an analytics report using the lifestyle management system 10 that can monitor and track visits to the lifestyle management system 10 including for example at least unique visitors, the total hits and visits to various user created content or content received, curated and aggregated by the lifestyle management system 10. The report can also include data comprising visits by day and time, visit duration, top “pages”, top categories, visits by geo-location, visits by demographic slice, and visits by device. In some embodiments, the employer administrator can review and compile an analytics report using the lifestyle management system 10 that can include one or more data comprising user engagement analytics including board updates (including pins) by day and time, demographic slice, category, return visits, and consistent engagement by demographic slice. Further, in some embodiments, the employer administrator can review and compile an analytics report using the lifestyle management system 10 that can include responses to invitations, event creation, and user invitations. Further, in some embodiments, the employer administrator can review and compile an analytics report using the lifestyle management system 10 that can include data related to partner click-through, and vetted resource click-through. In some embodiments, the employer administrator can review and compile an analytics report using the lifestyle management system 10 that can include data related to a user 150 path comprising a record of a user 150 click-stream that can be used to record the order of resources visited by the user 150 within an active session.

The dashboard style display page 7800 (shown in FIG. 78) for example illustrates one example of a display page comprising one or more tools for creating, distributing and/or publishing one or more lifestyle related challenges. The display page 7800 can include an activity type menu 7810 to enable an administrator to select one or more progress tracking and monitoring functions. Further, in some embodiments, any display page processed and displayed by the lifestyle management system 10 can be changed based at least in response to receiving one or more preferences from a user 150 and/or from the administrator and/or from the lifestyle management system 10. Further, by tracking a user's interaction with one or more of the display pages described herein, any display page processed and displayed by the lifestyle management system 10 can be changed by the administrator and/or by the lifestyle management system 10.

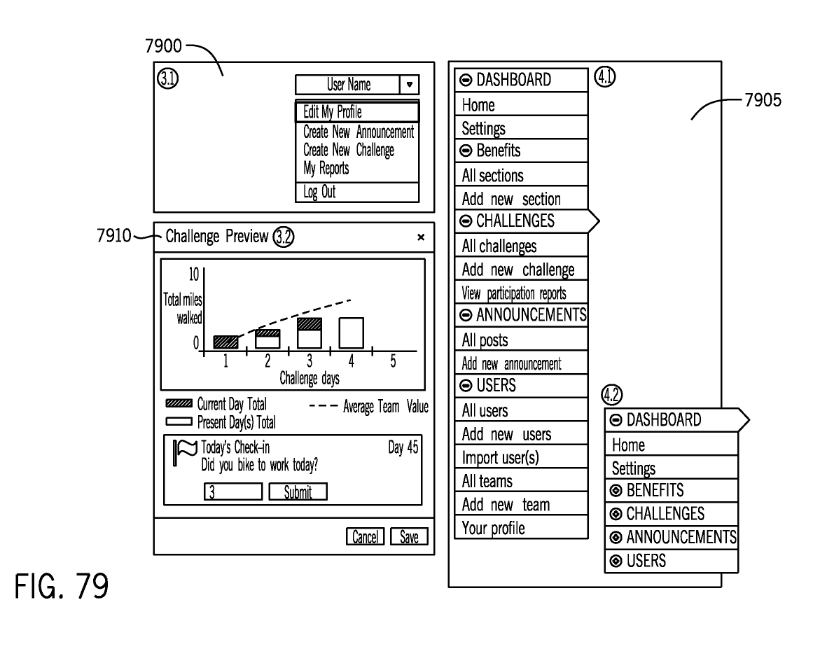

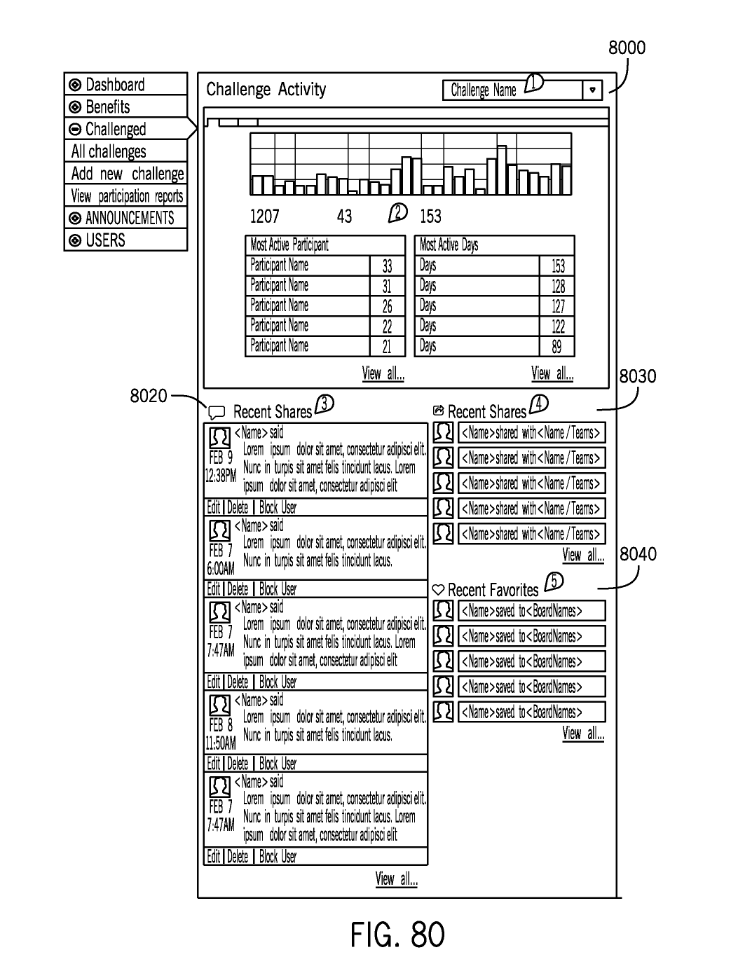

In some embodiments, the display page 7800 can also include a publishing window 7820 that can enable an administrator to set one or more publishing options. The display page 7900 shown in FIG. 79 illustrates one embodiment of a dashboard menu 7905 that can be used by an administrator to navigate various functions of the lifestyle management system 10 to create and publish lifestyle related content. As shown, in some embodiments, the display page 7900 can include a challenge preview 7910 that can include a data chart illustration one or more statistics related one or more current challenges. Further, FIG. 80 shows one example of a display page 8000 that can comprise challenge dashboard providing at a glance analysis of challenge statistics. Further, the display page 8000 can also include access to past and ongoing feedback from users 150 related to any past, current, or future challenge. For example, the display page 8000 can also include a recent comments display window providing a snapshot of recent comments left on the challenge by one or more users 150. In some embodiments, the display page 8000 can include a recent shares window 8030 that can provide a report showing the most recent share activity. Further, in some embodiments, the display page 8000 can include a recent favorites window 8040 that can provide information on the most recent “save” activity for any active challenge.

As described earlier, in some embodiments, a user 150 defined as a system or platform administrator 135 can monitor, add, modify, or update at least one operating feature or function relating to at least one operating feature or function of the lifestyle management system 10. In some embodiments, the user 150 comprising an administrator can be assigned access rights and/or one or more access privileges defined by the system or platform administrator 135. In this instance, the lifestyle management system 10 can display different administrative display pages for the system or platform administrator 135 and any user 150 defined as an administrator. Using these display pages, any user 150 defined as system or platform administrator 135 and any user 150 defined as an administrator can be provided with one or more distinct user features. For example, in some embodiments, a system or platform administrator 135 can create employer organizations within the lifestyle management system 10. In some embodiments, the system or platform administrator 135 can manage system or platform administrator 135 login access, and the login access of any user 150 defined as an administrator. In some embodiments, the system or platform administrator 135 can select items from platform feeds to be used as featured or promoted content within the application. In some embodiments, the system or platform administrator 135 can view analytics reports (including those that are platform level aggregated). In some embodiments, the system or platform administrator 135 can add new content feeds to the platform. In some further embodiments, the system or platform administrator 135 can add editor or third party managed boards.

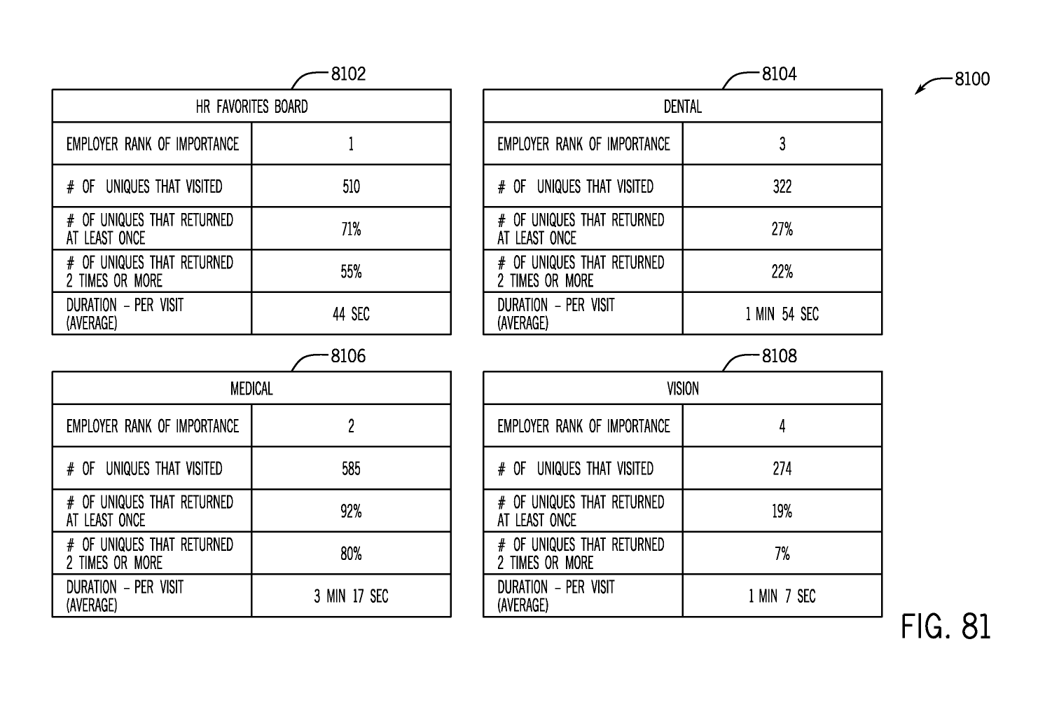

FIGS. 81-83 illustrate administrator display pages including analytics reports 8100, 8200, 8300 respectively according to one embodiment of the invention. In some embodiments, the lifestyle management system 10 can prepare statistical data including rank and usage data for any lifestyle content prepared by the systems and methods described herein and accessed by one or more users. For example, as shown in FIG. 81, in some embodiments, the analytics reports 8100 can comprise a human resources favorites board analytics report 8102 that can include data comprising an employer rank of importance, the number of different users 150 that visited, the number of different users 150 that returned at least once, the number of different users 150 that returned twice or more, and the average duration of each visit. For example, in some embodiments, the analytics reports 8100 can comprise one or more analytics reports related to at least one healthcare related employer benefit such as dental, medical, and/or vision. In some embodiments, the lifestyle management system 10 can provide a dental analytics report 8104 relating to user 150 access to one or more dental programs, dental providers, or information related to dental insurance coverage. In some embodiments, the lifestyle management system 10 can provide a medical analytics report 8106 relating to user 150 access to one or more medical programs, medical providers, or information related to medical insurance coverage. In some further embodiments, the lifestyle management system 10 can provide a vision analytics report 8108 relating to user 150 access to one or more vision programs, vision providers, or information related to vision insurance coverage.

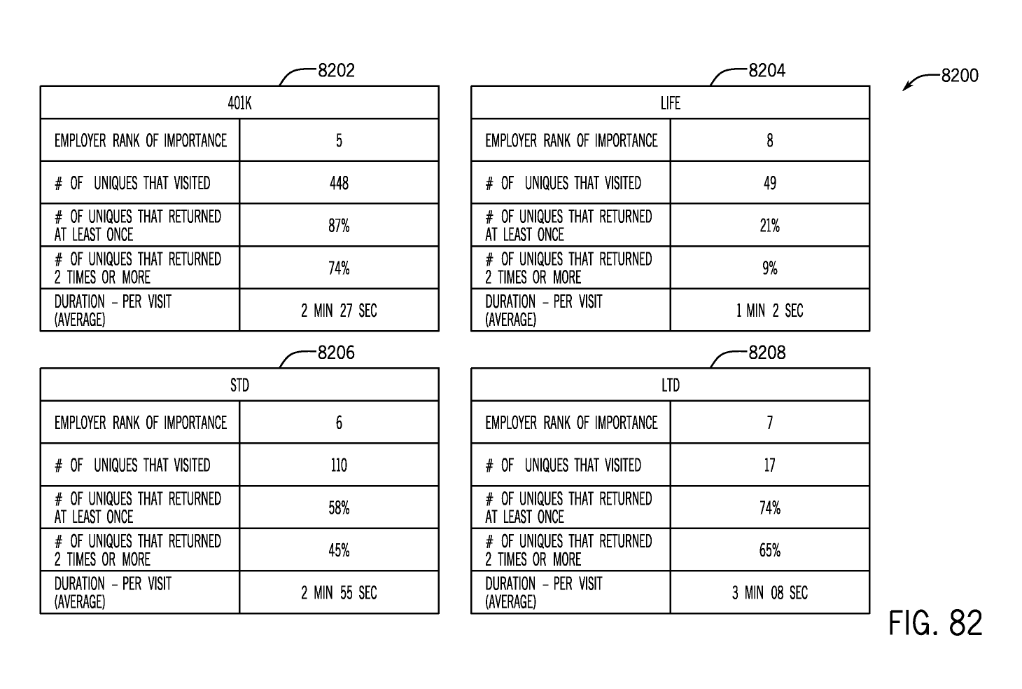

Some embodiments of the invention can provide lifestyle, financial and personal well-being benefits related analytics reports 8200. For example, as shown in FIG. 82, in some embodiments, the analytics reports 8200 can comprise analytics reports 8202, 8204, 8206 that can include data comprising an employer rank of importance, the number of different users 150 that visited, the number of different users 150 that returned at least once, the number of different users 150 that returned twice or more, and the average duration of each visit. The analytics reports can comprise statistics related user 150 visits to retirement plan (401k) information provided by the employer, along with life and disability benefits provided by the employer. For example, the analytics reports 8200 can comprise a 401K analytics report 8202, a life benefits analytics report 8204, a short-term disability benefits analytics report 8206, and a long-term disability benefits analytics report 8208.

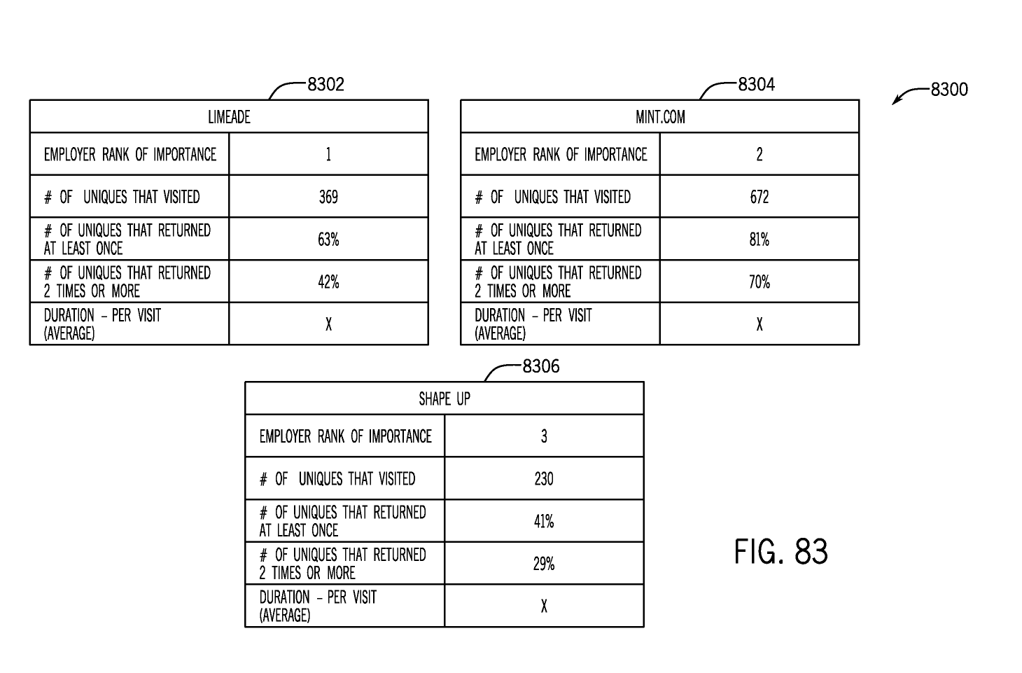

Some embodiments of the invention can provide related analytics reports related to user 150 access to one or more partner and/or vendor provided lifestyle related content. For example, as shown in FIG. 83, in some embodiments, the analytics reports 8300 can comprise analytics reports 8302, 8304, 8306 that can provide a user 150 access to partner and/or vendor provided lifestyle related content. In some embodiments, the representation of partner programs can be pushed through to a user 150. Further, in some embodiments, any partner program or content can be added to one or more user's boards. In this example, the analytics reports 8302, 8304, 8306 can include data comprising an employer rank of importance, the number of different users 150 that visited, the number of different users 150 that returned at least once, the number of different users 150 that returned twice or more, and the average duration of each visit.

Using a combination of the features provided by the systems and methods of the lifestyle management system 10 illustrated and described herein can provide lifestyle related content to a user by aggregating lifestyle information from lifestyle related resource. Using a combination of operations and system features including boards, goals, challenges channeled through a single user interface (e.g., using the dashboard 300 displayed using a user display 154 within a mobile device 152) the lifestyle management system 10 can deliver lifestyle related content to a user 150 that can include lifestyle related data based, at least in part, on at least one preference selected by the user 150. The user interface 154 can include displays and links to at various lifestyle related resources and activities defined by the system 10, and influenced by the user's use of the system 10, including various content that is accessed by the user 150. For example, the operations also can include adjusting the user interface and the information displayed based, at least in part, on at least one of a preference selected by the user and information collected by tracking the user's use of the at least one user interface.

The embodiments of the present invention can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally or in particular formats that enable the construction or depiction of a physical and tangible object. In some embodiments, the manipulation can be performed by a processor. In such an example, the processor thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations can be described in a specific order, it should be understood that other housekeeping operations can be performed in between operations, or operations can be adjusted so that they occur at slightly different times, or can be distributed in a system which allows the occurrence of the processing operations at various intervals associated with the processing, as long as the processing of the overlay operations are performed in the desired way.

Embodiments of the present disclosure include various steps, which are described in this specification. The steps can be performed by hardware components or can be embodied in machine-executable instructions, which can be used to cause a general-purpose or special-purpose processor programmed with the instructions to perform the steps. Alternatively, the steps can be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof

What is claimed:

1. A system for managing one or more lifestyle resources, comprising:
at least one processor configured to couple to at least one server and at least one non-transitory computer-readable storage medium for tangibly storing information related to a user account, the non-transitory computer-readable storage medium including program logic for building and accessing at least one user profile accessible by the user through a single access point which when executed by the processor, can cause a lifestyle management system to:
electronically couple to an internet service interface comprising a plurality of user accounts;
using the at least one processor, calculate and display at least one user interface on a computer device of a user that is coupled to the internet service interface;
provide an option to a user to create at least one board, the board configured and arranged for storing, accessing, posting and linking of at least one lifestyle related data selected by the user, the posting and linking configured to enable private posting to the user and public posting to at least one viewing user;
receive from at least one user one or more preferences or characteristics related to a lifestyle resource content of the lifestyle related data;
receive lifestyle related data from at least one third party content source;
use the at least one processor to aggregate and curate the at least one lifestyle related data;
use the at least one processor to apply criteria to the aggregated and curated lifestyle related data based at least in part on one or more preferences or characteristics provided by the user to select and determine eligibility for viewing by a viewing user at least one lifestyle related content item from the aggregated and curated lifestyle related data;
use the at least one processor to display the eligible at least one lifestyle content item to the viewing user;
use the at least one processor to display at least one sharing link on the user interface;
provide an option to the viewing user to post the at least one lifestyle related content item to the at least one board, wherein the post can include at least one of a private posting to at least one of the user's boards or a public posting to at least one other user holding one of the plurality of user accounts; and
provide an option to the viewing user to share the at least one lifestyle related content item to at least one other viewer; and
wherein the at least one lifestyle related content item comprises a lifestyle related feed derived from the at least one third party content source.

2. The system of claim 1, wherein the at least one lifestyle related resource includes at least one of an internet resource, a healthcare resource, a personal resource, an employer resource and a healthcare related account associated with the user.

3. The system of claim 1, wherein the at least one user interface is coupled to a mobile communication device.

4. The system of claim 3, wherein the mobile communication device comprises at least one of a cellular phone, a smart phone, a computer tablet, a smartwatch, a user-wearable computing device, and a personal digital assistant.

5. The system of claim 3, wherein the mobile communication device is configured as the single access point configured to enable a user to select and view personalized lifestyle related content comprising at least one of employee benefit information, employee healthcare information, personal wellness information and employer human resources information.

6. The system of claim 1, wherein the lifestyle related content delivered to the user is selected based at least in part on an input from a user.

7. The system of claim 1, wherein the lifestyle related content delivered to the user is selected based at least in part on an input from the system.

8. The system of claim 1, wherein the program logic is configured to cause the at least one processor to perform the operation of preparing and delivering to an administrator at least one analytics report based at least in part on the user's use of the lifestyle related content and the at least one user interface.

9. The system of claim 8, wherein the at least one analytics report includes a report relating to at least one of the user's board updating activity, user visits by day and time, user visits by visit duration, most accessed content, top categories, user visits by geo-location, user visits by demographic slice, and user visits by device type.

10. The system of claim 8, wherein the program logic is configured to enable the administrator to control access and content provided to other administrators and the user.

11. A computer-implemented method of managing and displaying lifestyle resources to a user with the use of a lifestyle management system including at least one processor coupled to at least one non-transitory computer readable storage medium, which is configured to read and store lifestyle related data from at least one of a plurality of lifestyle related resources, the method comprising the steps of:
coupling the lifestyle management system to an internet service interface comprising a plurality of user accounts;
calculating and displaying at least one user interface on a computer device forming a single access point for a user that is coupled to the internet service interface;
providing an option to a user to create at least one board, the board configured and arranged for storing, accessing, posting and linking of at least one lifestyle related data selected by the user, the posting and linking configured to enable private posting to the user and public posting to at least one viewing user;
receiving from at least one user one or more preferences or characteristics related to a lifestyle resource content of the lifestyle related data;
receiving, aggregate and curating at least one lifestyle related data from at least one third party content source;
applying criteria to the aggregated and curated lifestyle related data based at least in part on one or more preferences or characteristics provided by the user;
selecting and determining eligibility for viewing by a viewing user at least one lifestyle related content item from the aggregated and curated lifestyle related data;
displaying the at least one lifestyle related content item to the viewing user;
displaying at least one sharing link on the user interface;
providing an option to the viewing user to post the at least one lifestyle related content item to the at least one board, wherein the post can include at least one of a private posting to at least one of the user's boards or a public posting to at least one other user holding one of the plurality of user accounts; and
providing an option to the viewing user to share the at least one lifestyle related content item to at least one other viewer; and
wherein the at least one lifestyle related content item comprises a lifestyle related feed derived from the at least one third party content source.

12. The method of claim 11, wherein the at least one lifestyle related resource comprises at least one of an internet resource, a healthcare resource, a personal resource, an employer resource and a healthcare related account associated with the user.

13. The method of claim 11, wherein the computer device comprises a mobile communication device.

14. The method of claim 13, wherein the mobile communication device comprises at least one of a cellular phone, a smart phone, a computer tablet, a smartwatch, a user-wearable computing device, and a personal digital assistant.

15. The method of claim 13, wherein the mobile communication device is configured to enable a user to select and view through the single access point personalized lifestyle related content comprising at least one of employee benefit information, employee healthcare information, personal wellness information and employer human resources information.

16. The method of claim 11, wherein the lifestyle related content delivered to the user is selected based at least in part on an input from a user.

17. The method of claim 11, wherein the lifestyle related content delivered to the user is selected based at least in part on an input from the lifestyle management system.

18. The method of claim 11, wherein the program logic is configured to cause the at least one processor to perform the operation of preparing and delivering to an administrator at least one analytics report based at least in part on the user's use of the lifestyle related content and the at least one user interface.

19. The method of claim 18, wherein the at least one analytics report includes a report relating to at least one of the user's board updating activity, user visits by day and time, user visits by visit duration, most accessed content, top categories, user visits by geo-location, user visits by demographic slice, and user visits by device type.

20. The method of claim 18, wherein the program logic is configured to enable the administrator to control access and content provided to other administrators and the user.
